(19) United States
(12) Patent Application Publication
(10) Pub. No.: US 2018/0153644 A1
(43) Pub. Date: Jun. 7, 2018

(54) APPARATUSES FOR EVACUATION OF A ROOT CANAL AND METHODS OF USING SAME

(71) Applicant: Ormco Corporation, Orange, CA (US)

(72) Inventors: Matteo Bosisio, Noranco, Lugano (CH); M. Reza Mehrabi, Tujunga, CA (US); Emanuele Maretto, Orange, CA (US); Gopikrishnan Soundararajan, Santa Clara, CA (US); Carl Gordon Hewett, Milton Keynes (GB); Matthew Daniel Chandler, Cambridgeshire (GB); Brian Glicker, Corona, CA (US)

(21) Appl. No.: 15/577,583

(22) PCT Filed: Jul. 13, 2016
(86) PCT No.: PCT/US2016/042002

§ 371 Date: Nov. 28, 2017

Related U.S. Application Data
(60) Provisional application No. 62/191,845, filed on Jul. 13, 2015.
(60) Provisional application No. 62/220,534, filed on Sep. 18, 2015.

(51) Int. Cl. A61C 5/40; A61C 17/02; A61C 17/20

(52) U.S. Cl. CPC A61C 5/40; A61C 17/20; A61C 17/0208

(57) ABSTRACT

The present invention relates to apparatuses and methods of endodontic treatment. The endodontic treatment system includes an endodontic device for use in endodontic procedures. The endodontic device is coupled to a fluid delivery system and includes an end effector, a first cannula (70), and a second cannula (72). The first cannula (70) and the second cannula (72) are movable relative to one another to an extended position in which the second cannula (72) extends from the first cannula (70). A method for endodontic treatment of a root canal of a tooth includes moving a first cannula (70) and the second cannula (72) relative to one another from a first position to a second position in which the second cannula (72) extends from the first cannula (70) into the root canal and evacuating the irrigant from the root canal with the second cannula (72).

### CROSS REFERENCE

This application claims priority to U.S. Provisional Patent Application Ser. No. 62/191,845 filed Jul. 13, 2015 and to U.S. Provisional Patent Application Ser. No. 62/220,534 filed Sep. 18, 2015, the disclosures of which are expressly incorporated by reference herein in their entireties.

### TECHNICAL FIELD

The invention relates generally to methods and apparatuses used during endodontic therapy or root canal therapy and, more particularly, to apparatuses and methods for dispensing fluids and evacuating those fluids from a root canal.

### BACKGROUND

To preserve a tooth that has developed an infected pulp or abscess, it is necessary to remove the diseased tissue from the tooth. Removing the diseased tissue prevents further bacterial proliferation within the tooth and can save the tooth. To that end, endodontic therapy or root canal therapy of the identified tooth may be necessary.

To begin a root canal, the clinician cuts an opening through the crown of the tooth to gain access to the pulp. The clinician then removes the pulp from the pulp chamber and from the root canal through the opening. Endodontic files, bores, reamers or other instrumentation are used to clean tissue from the root canal. The clinician may also shape the root canal to receive a filling material.

Following mechanical removal of tissue, the clinician flushes the pulp chamber and the enlarged root canal with one or more irrigants to disinfect them. This minimizes the presence of bacteria and cleans the surfaces of calcific debris created during mechanical debridement. Irrigants are preferably capable of dissolving tissue remnants to permit their removal. These include hydrogen peroxide and sodium hypochlorite but may be any suitable liquid, such as, water or various alcohols that simply carry debris out of the root canal.

It is desirable to remove as much of the debris and necrotic tissue as possible. To do so, the irrigant may be typically applied under pressure using a syringe and a needle inserted into the canal. To clean the root canal near the apex of the tooth, the syringe must be placed very close to the apical foramen and must fit loosely enough in the root canal to allow the irrigant to flow from near the apical foramen toward the crown. The used irrigant and debris is then siphoned off through the opening in the crown. This technique may, however, be problematic, particularly for certain types of irrigants.

Even the tip of the smallest needles that deliver irrigants under pressure must be kept a safe distance (typically 4-6 mm) away from the apex to avoid accidentally forcing the irrigant through the apical foramen and into the periapical tissue. Irrigant that escapes into the periapical tissue can be a source of significant post treatment endodontic pain or morbid clinical complication, including excruciating pain, immediate swelling of the tissue, and profuse bleeding.

To avoid forcing irrigant into the periapical tissue, the clinician may not insert the syringe deeply enough into the root canal and so an area or zone adjacent the apical foramen may not be properly disinfected. Occasionally, even proper placement of the syringe does not guarantee that the irrigant has flushed the canal all the way to the apex. Furthermore, irrigating the regions near the apical foramen is very time consuming.

As a result, other techniques have been developed. One includes evacuating the irrigant from a region near the apex instead of at the crown. In this technique, irrigant is introduced at the crown and flows from the crown toward the apex where it is suctioned away through a cannula. While very successful, this technique has unique problems. Because the cannula must be very small to fit to within a few millimeters of the apical foramen, any residual debris tends to clog the cannula. Once clogged, the evacuation of the irrigant ceases and the technique becomes ineffective until the debris is cleared. As a consequence, extreme care must be taken to clean out the root canal before final cleaning of the region near the apical foramen.

Furthermore, due to the numerous components and the extremely small size of the cannulas necessary to effectuate proper evacuation of a root canal, current techniques may be difficult to physically manipulate within the patient's mouth. By virtue of this difficulty, there is a significant amount of wasted time to effectively complete treatment.

Following flushing with the irrigants, the clinician fills or obturates the root canal with a material such as gutta-percha and a sealer to seal the root canal. Once sealed, the clinician may place a crown or other restoration on the tooth to protect it and restore it to its full function.

A need therefore exists for apparatuses and methods which enable a clinician to disinfect and remove debris near the apex of a tooth without concern that irrigant is forced through the apical foramen and into the periapical tissue.

### SUMMARY

An endodontic device for use in endodontic procedures and other procedures addresses these and other shortcomings and in one embodiment may include a canal evacuation system for evacuating a root canal of a tooth. The canal evacuation system includes a first cannula and a second cannula. The first cannula and the second cannula are movable relative to one another to an extended position in which the second cannula extends from the first cannula.

In one embodiment, the first cannula and the second cannula are movable from a retracted position in which the first cannula evacuates the root canal to the extended position in which the second cannula evacuates the root canal.

In one embodiment, when the second cannula is in the retracted position, the second cannula does not evacuate the root canal. In one embodiment, when in the extended position, the second cannula is concentric with the first cannula.

In one embodiment, the canal evacuation system includes an extension control system that is operatively coupled to at least one of the first cannula and the second cannula and by which a clinician can move at least one of the first cannula and the second cannula relative to one another between the retracted position and the extended position.

In one embodiment, the endodontic device includes a locking system that is operatively coupled to the extension control system and that secures the extension control system at one of a plurality of predetermined locations selected by the clinician.

In one embodiment, the endodontic device further includes an end effector that has a body defining a through bore in fluid communication with the first cannula and with the second cannula when the second cannula is in the extended position. The end effector defines a first axis and the first cannula defines a second axis that intersects the first axis. In one embodiment, an angle formed between the first axis and the second axis is greater than 90° up to about 145°.

In one embodiment, the endodontic device further includes a handpiece to which the end effector is releasably coupled at a joint. In one embodiment, the endodontic device further comprises an irrigant system including a fluid delivery tube that is configured to dispense fluid into the tooth. The handpiece may house at least one button mechanism that is operable to select the rate at which one fluid flows through the fluid delivery tube.

In one embodiment, an endodontic treatment system comprises the endodontic device and a fluid delivery system that is fluidly coupled to the endodontic device by a plurality of tubes.

In another aspect, an end effector for use with a handpiece through which fluid and vacuum are supplied during endodontic therapy addresses these and other shortcomings and in one embodiment, the end effector comprises at least one body that defines a through bore and through which vacuum is supplied. The end effector forms a joint with the handpiece at one end. A first cannula extends from the body proximate another end and is capable of evacuating at least a portion of a root canal. A fluid delivery tube is supported by the body for dispensing a fluid proximate the other end of the body into a tooth at a crown of the tooth. The end effector may be a disposable component.

In one embodiment, the end effector further includes a vacuum port proximate the fluid delivery tube for evacuating fluid at or near the crown of the tooth.

In one embodiment, the end effector includes a second cannula that has a smaller diameter than the first cannula. The first cannula and the second cannula are movable relative to one another to an extended position in which the second cannula extends from the first cannula similar to that described above with respect to the endodontic device.

In one embodiment, an endodontic device for use during endodontic therapy may be coupled to a fluid delivery system that includes a reservoir of fluid and a source of vacuum. The endodontic device includes a handpiece that includes a housing, at least one tube that is fluidly coupled to the reservoir, and a vacuum tube that is coupled to the source of vacuum. Each tube extends at least part way through the housing.

In one embodiment, the handpiece includes at least one control mechanism and a cable that extends at least part way through the housing and electrically couples the at least one control mechanism on the handpiece with the fluid delivery system.

In one embodiment, the endodontic device includes a canal evacuation system extending from the handpiece for evacuating a root canal of a tooth. The canal evacuation system includes a first cannula and a second cannula. The first cannula and the second cannula are fluidly coupled to the vacuum tube and are movable relative to one another to an extended position in which the second cannula extends from the first cannula.

In one aspect, a cannula for use during endodontic therapy addresses these and other shortcomings and in one embodiment comprises a sidewall that defines a bore and is closed at one end. The sidewall is sized to fit within a root canal with the closed end at or near an apical foramen and includes a plurality of openings proximate the closed end and a mid-exit hole remote from the closed end. The cannula includes a seal at an end opposite the closed end. In one embodiment, the sidewall is at least one of stainless steel, plastic, or a combination thereof. In one embodiment, the mid-exit hole has a greater open area than any single one of the openings.

In one aspect, a method for endodontic treatment of a root canal of a tooth addresses these and other shortcomings and includes moving a first cannula and a second cannula relative to one another from a first position to a second position in which the second cannula extends from the first cannula into the root canal and the method includes evacuating the irrigant from the root canal with the second cannula.

In one embodiment, prior to evacuating the irrigant with the second cannula, the method includes heating or cooling the irrigant.

In one embodiment, prior to evacuating the irrigant with the second cannula, the method includes supplying the tooth with the irrigant and evacuating the irrigant from the root canal with the first cannula.

In one embodiment, evacuating the irrigant with the first cannula includes cutting an end portion from the first cannula to restore evacuation through the first cannula.

In one embodiment, while evacuating the irrigant with the first cannula, the method includes flowing the irrigant into an opening in a crown of the tooth. In one embodiment, following evacuating with the first cannula, the method includes reducing a flow rate of the irrigant into the tooth.

In one embodiment, the method includes moving the second cannula to the second position to seal the first cannula so that the first cannula does not evacuate the root canal.

In one embodiment, during evacuating the irrigant with the second cannula, the method includes retracting the second cannula to a position within the first cannula to remove debris from openings in the second cannula and restore evacuation of the irrigant and then extending the second cannula back into the root canal.

In one embodiment, prior to evacuating with the second cannula, the method includes measuring a location of an apical foramen with the second cannula.

In one embodiment, while evacuating with the second cannula, the method includes flowing irrigant into an opening in a crown of the tooth.

In one aspect, a method for endodontic treatment of a root canal of a tooth addresses these and other shortcomings and includes irrigating the tooth with an irrigant, and following irrigating, drying the root canal with the cannula, including evacuating residual moisture through the cannula.

### BRIEF DESCRIPTION OF THE DRAWINGS

The accompanying drawings, which are incorporated in and constitute a part of this specification, illustrate embodiments of the invention and, together with the detailed description given below, serve to explain the invention.

FIG. 1 is a perspective view of an endodontic device according to one embodiment of the invention;

FIG. 2 is an enlarged perspective view of the endodontic device shown in FIG. 1;

FIG. 3 is a cross-sectional view of the endodontic device shown in FIG. 1 taken along section line 3-3;

FIGS. 4A and 4B are cross-sectional views of a portion of the endodontic device of FIG. 1 with a cannula shown in a retracted position and an extended position, respectively;

FIGS. 4C-4E are perspective views of a cannula according to one embodiment of the invention;

FIG. 5A is a cross-sectional schematic representation of the endodontic device of FIG. 1 during endodontic therapy;

FIG. 5B is an enlarged view of the encircled area 5A of FIG. 5A;

FIG. 6A is a cross-sectional schematic representation of the endodontic device of FIG. 1 during endodontic therapy;

FIGS. 6B, 6C, and 6D are enlarged views of the encircled area 6A of FIG. 6A;

FIGS. 7A and 7B are schematic representations of one embodiment of the invention;

FIG. 8A is a perspective view of an endodontic device according to one embodiment of the invention;

FIG. 8B is an enlarged perspective view of the endodontic device shown in FIG. 8A;

FIG. 9 is a cross-sectional view of the endodontic device shown in FIG. 8A taken along section line 9-9;

FIG. 9A is an enlarged cross-sectional view of FIG. 9 with a cannula in a retracted position;

FIG. 9B is an enlarged cross-sectional view of FIG. 9 with a cannula in an extended position;

FIG. 10A is a perspective view of an endodontic device according to one embodiment of the invention;

FIG. 10B is a cross-sectional view of the endodontic device of FIG. 10A;

FIG. 11A is a bottom plan view of one embodiment of the endodontic device;

FIG. 11B is a disassembled cross-sectional view of one embodiment of the invention;

FIG. 11C is one embodiment of a multi-lumen cannula according to one embodiment of the invention;

FIG. 11D illustrates the multi-lumen cannula relative to a tooth;

FIG. 12A is a perspective view of an endodontic device according to one embodiment of the invention;

FIG. 12B is a cross-sectional view of a vacuum hood and a cannula of the endodontic device of FIG. 12A;

FIG. 12C is a cross-sectional view of a handpiece of the endodontic device shown in FIG. 12A;

FIG. 13 is a perspective view of the endodontic device according to one embodiment of the invention;

FIG. 14A is a cross-sectional view of the endodontic device of FIG. 13;

FIG. 14B is a cross-sectional view of the endodontic device of FIG. 13 with a portion of the endodontic device shown separated from a handpiece;

FIG. 15 is a perspective view of an endodontic device according to one embodiment of the invention;

FIG. 16 is a cross-sectional view of the endodontic device of FIG. 15;

FIGS. 17A-17D illustrate one embodiment of a multi-lumen delivery tube according to an embodiment of the invention;

FIG. 18 is a perspective view of a fluid delivery system and an endodontic device according to embodiments of the invention;

FIG. 19 is a cross-sectional view of the fluid delivery system and endodontic device of FIG. 18;

FIG. 20 is a cross-sectional perspective view of the fluid delivery system of FIG. 18;

FIG. 21 is a perspective view of a fluid delivery system according to one embodiment of the invention;

FIG. 22 is a cross-sectional view of the fluid delivery system of FIG. 21 taken along section line 22-22;

FIG. 23 is a cross-sectional view of the fluid delivery system of FIG. 21 taken along section line 23-23;

FIG. 24 is a perspective view of an endodontic device according to one embodiment of the invention;

FIG. 25 is a disassembled perspective view of the endodontic device shown in FIG. 24;

FIG. 26A is a cross-sectional view of the endodontic device shown in FIG. 25 taken along section line 26A-26A;

FIG. 26B is a cross-sectional view of the endodontic device shown in FIG. 24 according to one embodiment of the invention;

FIG. 26C is a cross-sectional view of the endodontic device shown in FIG. 24 according to one embodiment of the invention;

FIG. 27 is an enlarged view of the cross-section shown in FIG. 26B;

FIG. 28 is a perspective view of a fluid delivery system according to one embodiment of the invention;

FIG. 29 is another perspective view of the fluid delivery system of FIG. 28;

FIG. 30 is a cross-sectional view of the fluid delivery system of FIG. 29 taken along section line 30-30; and

FIG. 31 is a perspective view of one embodiment of a control system;

FIG. 32 is a schematic view of an endodontic treatment system according to one embodiment of the invention;

FIG. 33 is a perspective view of an endodontic treatment system according to one embodiment of the invention;

FIG. 34 is a perspective view of an endodontic device according to one embodiment of the invention;

FIG. 35A is a disassembled perspective view of the endodontic device shown in FIG. 33, according to one embodiment of the invention;

FIG. 35B is a rear perspective view of a portion of the endodontic device shown in FIG. 33, according to one embodiment of the invention;

FIG. 36 is a cross-sectional view of the disassembled view of the endodontic device shown in FIG. 35A;

FIG. 37A is a cross-sectional view of the endodontic device shown in FIG. 34 illustrating evacuation through a macrocannula;

FIG. 37B is an enlarged cross-sectional view of the endodontic device shown in FIG. 37A in relation to a tooth according to one embodiment of the invention;

FIG. 37C is a cross-sectional view of the endodontic device shown in FIG. 34 illustrating evacuation through a microcannula;

FIG. 37D is an enlarged cross-sectional view of the endodontic device shown in FIG. 37C in relation to a tooth according to one embodiment of the invention;

FIG. 38A is a disassembled perspective view of a portion of the endodontic device shown in FIG. 34;

FIG. 38B is a rear disassembled perspective view of the portion of the endodontic device shown in FIG. 38A;

FIG. 39 is a disassembled perspective view of a fluid delivery system according to one embodiment of the invention;

FIG. 40 is a cross-sectional view of the fluid delivery system shown in FIG. 39;

FIG. 41 is a rear view of the fluid system shown in FIG. 39 according to one embodiment of the invention;

FIG. 42 is a perspective view of a cannula according to one embodiment of the invention in an expanded state; and

FIG. 43 is a perspective view of a cannula according to one embodiment of the invention in a contracted state.

### DETAILED DESCRIPTION

With reference generally to the figures, embodiments of the present invention include an endodontic treatment system for irrigating and disinfecting a root canal. Further in this regard, embodiments of the present invention are intended to assist clinicians with improving the effectiveness of endodontic therapy while reducing the cost of that therapy. Embodiments of the invention also improve ergonomics for the clinician.

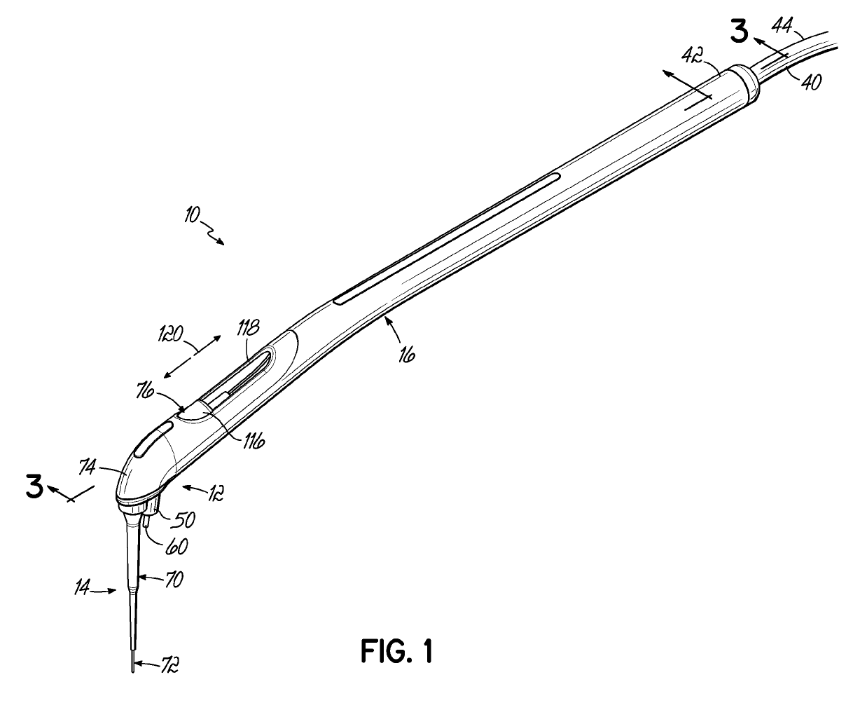

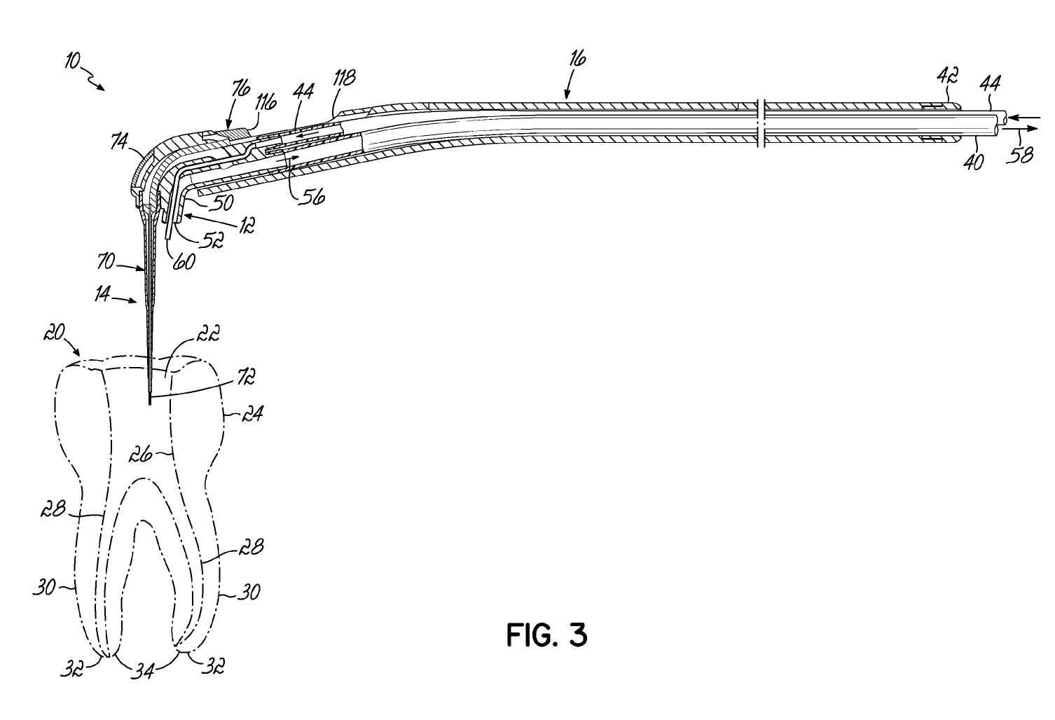

To these and other ends, in one embodiment and with reference to FIGS. 1-3, an endodontic device 10 may include an irrigant system 12 and a canal evacuation system 14 each of which may be housed within a handpiece 16 and a portion of which may extend from the handpiece 16. The handpiece 16 is an elongated member configured to be held by hand and at least a portion of which is positioned within the patient's mouth. As is described in more detail below, the endodontic device 10 may be utilized during endodontic therapy in which diseased tissue is removed from a tooth 20 and the tooth 20 is ultimately restored with a crown (not shown) for protection. A tooth prepared for irrigation is shown in FIG. 3. As shown, the tooth 20 includes an opening 22 in a crown 24 of the tooth 20. After creating an opening, the clinician removes pulp from a pulp chamber 26 in the crown 24 and from the root canals 28 in each root 30. Tissue may be removed to each apex 32 adjacent the corresponding apical foramen 34.

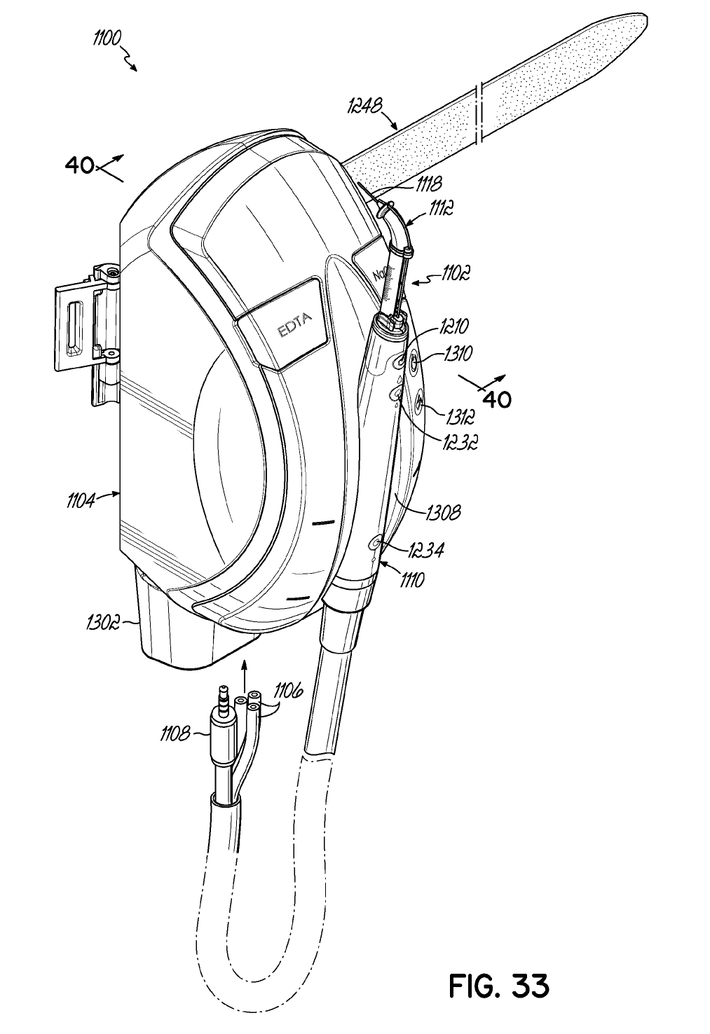

A clinician may then manipulate the endodontic device 10 to a position in which each of the irrigant system 12 and the canal evacuation system 14 are proximate the opening 22. The clinician may then control irrigant flow from or through the endodontic device 10 into the opening 22 of the tooth 20 while evacuating irrigant from the tooth 20 at possibly two locations within or proximate the tooth 20 to efficiently remove debris and thoroughly disinfect the pulp chamber 26 and root canals 28. Although not shown in the embodiment shown in FIG. 1, the device 10 may include a button or other user selectable switch by which the clinician may control the flow of the irrigant from a fluid delivery system described below through the irrigant system 12 (see, e.g., FIGS. 33-41). The push button may be push-on-release-off control in which irrigant flows from the system 12 while the clinician depresses the button or push-on-push-off control in which irrigant flows when the button is depressed and then released and does not stop flowing until the button is depressed and released a second time.

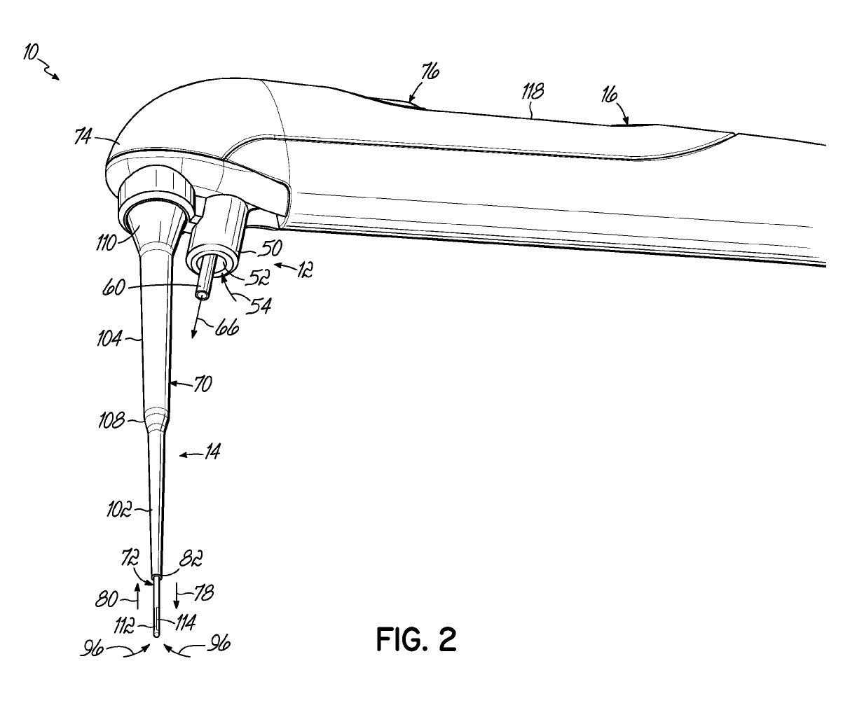

With continued reference to FIGS. 1 and 2, the endodontic device 10 may be coupled to a vacuum system (not shown) within the clinician's office via a tube 40 coupled to or entering the handpiece 16 at one end 42. A fluid delivery line 44 (shown in FIG. 3) for delivering irrigant from an external source (not shown) may also be coupled to the end 42 of the handpiece 16. Vacuum is supplied to each of the irrigant system 12 and the canal evacuation system 14 so that in the embodiment shown the endodontic device 10 includes two locations at which vacuum is provided. The clinician can then control each of the vacuum and irrigant flow through the irrigant system 12 and the canal evacuation system 14 to clean and disinfect the pulp chamber 26 and each of the root canals 28 prior to filling them.

In that regard, and with reference to FIGS. 1, 2, 3, and 4A, the irrigant system 12 includes a vacuum tube 50 that may project from the handpiece 16. The vacuum tube 50 defines an opening 52 and may be coupled to the tube 40 within the handpiece 16 such that a vacuum is formed at the opening 52 during endodontic therapy. Vacuum is indicated by arrow 54 in FIG. 2. As is shown in FIGS. 2, 3, and 4A, vacuum at the opening 52 pulls irrigant and debris through the handpiece 16 as is indicated by arrow 56 and out of the handpiece through the tube 40 as indicated by arrow 58 (FIG. 3). In this way, the irrigant system 12 may then be used to evacuate irrigant and other materials, such as, debris, from proximate the opening 22 of the tooth 20.

With continued reference to FIGS. 1, 2, 3, and 4A, in one embodiment, the irrigant system 12 includes a fluid delivery tube 60 that extends from the handpiece 16. The fluid delivery tube 60 defines an opening 62 from which irrigant is dispensed from the endodontic device 10 into the opening 22 of the tooth 20 during endodontic therapy. The fluid delivery tube 60 may be coupled to the fluid delivery line 44 within the handpiece 16. As is shown in FIGS. 2, 3, and 4A, irrigant flows (as indicated by arrows 66) through the fluid delivery line 44, through the fluid delivery tube 60, and is dispensed from the opening 62 into the pulp chamber 26 of the tooth 20 (FIG. 3). In the exemplary embodiment shown, the fluid delivery tube 60 passes through the opening 52 of the vacuum tube 50 and may extend a few millimeters beyond the opening 52. The vacuum at the opening 52 may surround the fluid delivery tube 60. The irrigant system 12 may be capable of delivering fluid with variation in velocity and pressure.

In addition or alternatively, the irrigant system 12 may include a valve or other controllable restriction by which the vacuum and/or irrigant flow may be pulsed. This may be referred to as flow modulation. The oscillation in the vacuum and/or the irrigant flow may enhance the efficacy of cleaning and debris removal.

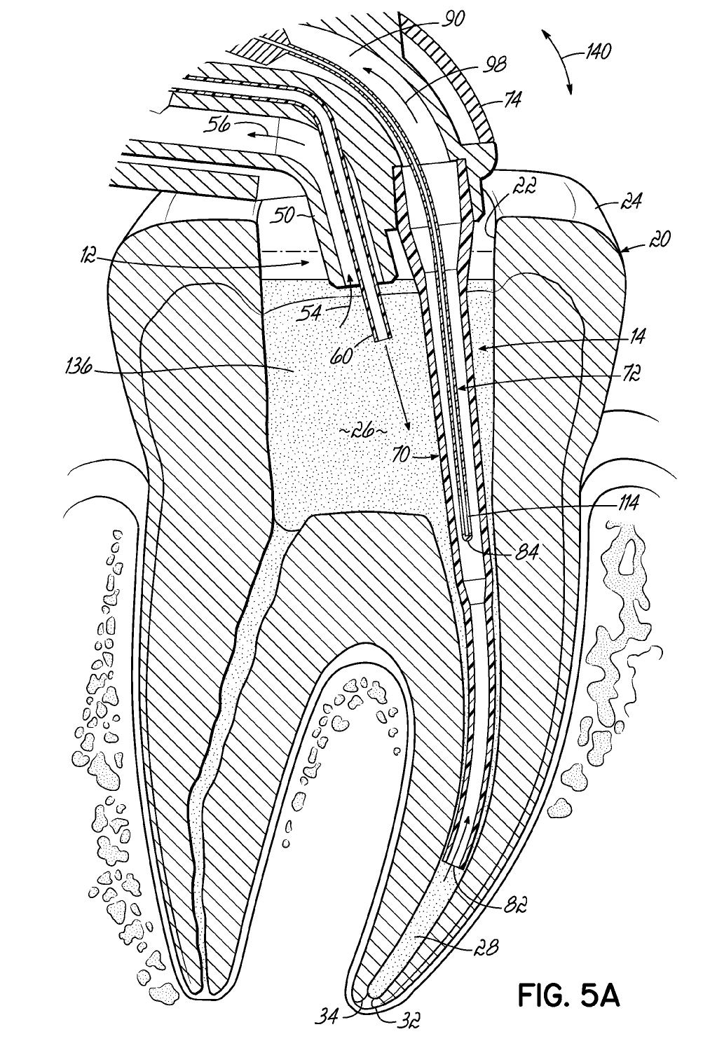

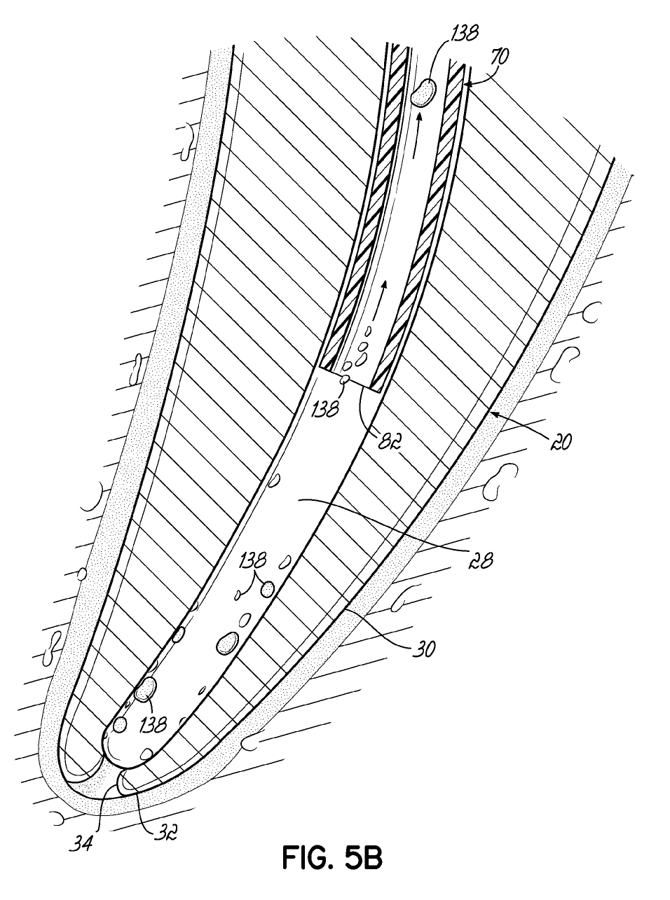

With continued reference to FIGS. 1, 2, 3, and 4A, in one embodiment, the canal evacuation system 14 extends from the handpiece 16 and so may be inserted into the root canal 28 (shown in FIG. 5B) during endodontic therapy. The canal evacuation system 14 may include a cannula 70 and a cannula 72 that generally extend from another end 74 opposite end 42 of the handpiece 16. As shown, the cannula 72 is smaller in one or more dimensions so as to fit at least partially within the cannula 70.

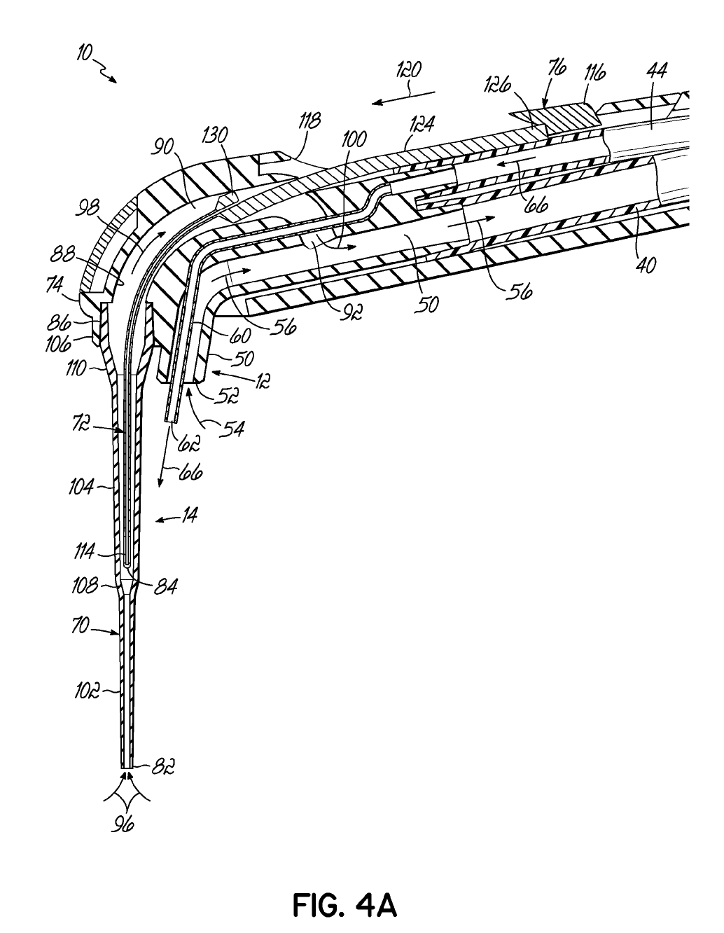

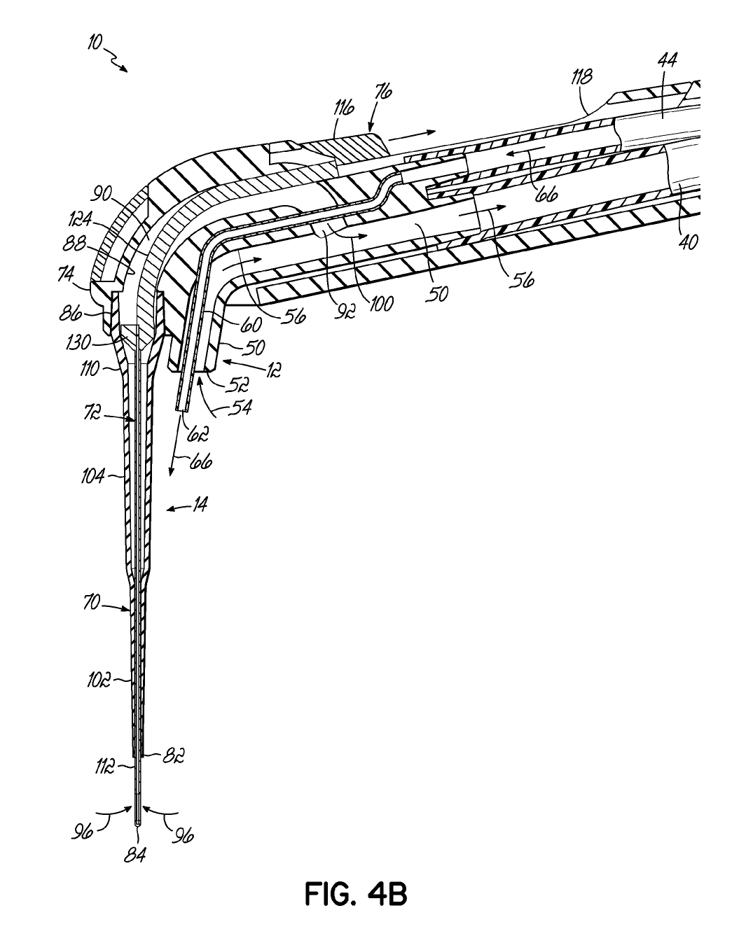

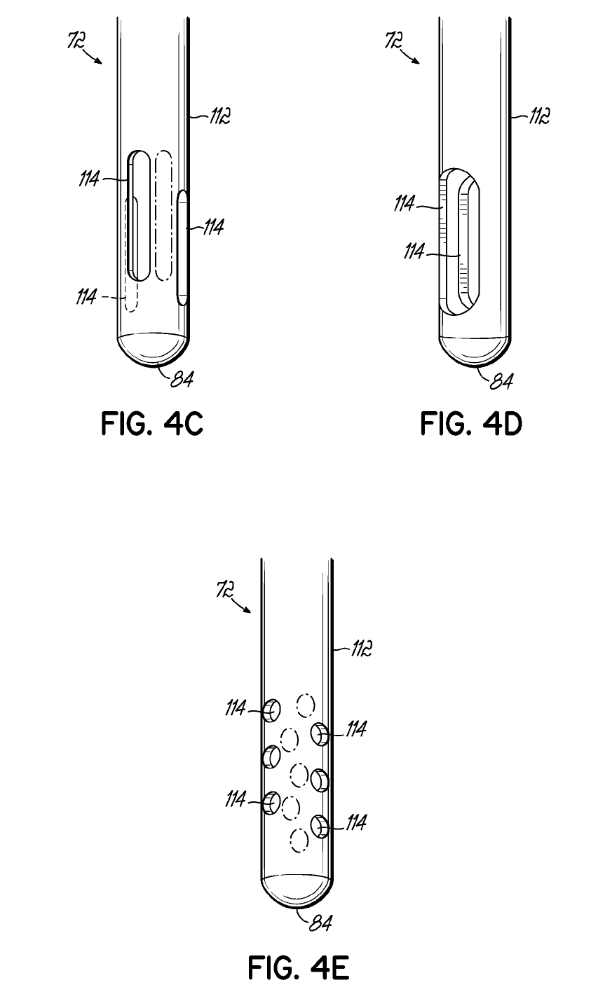

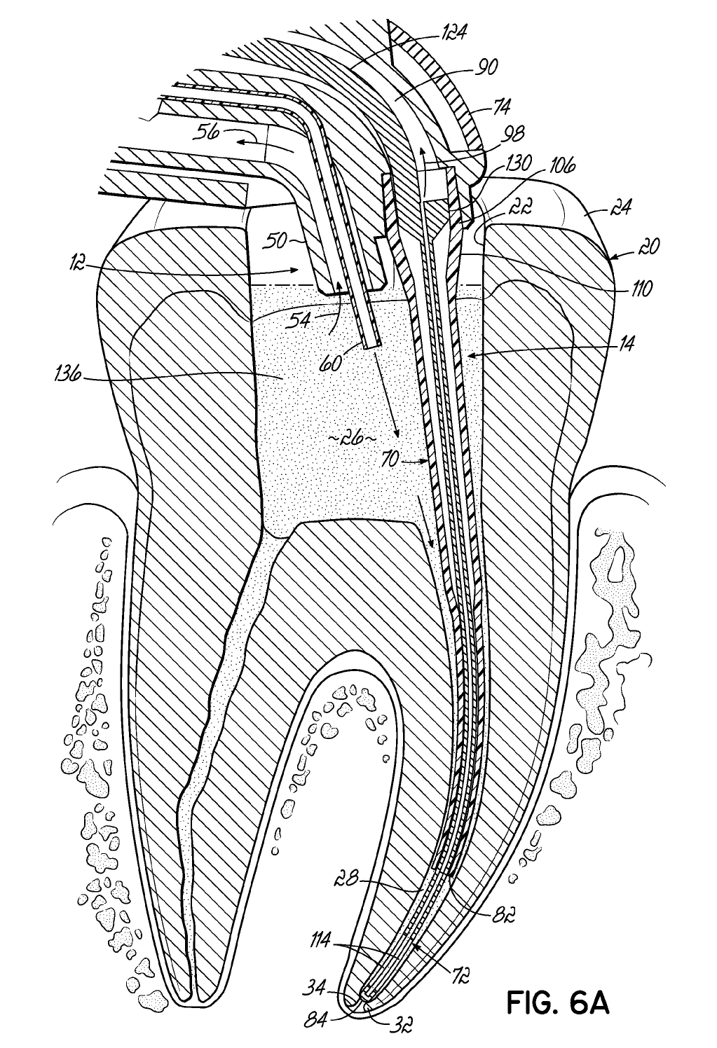

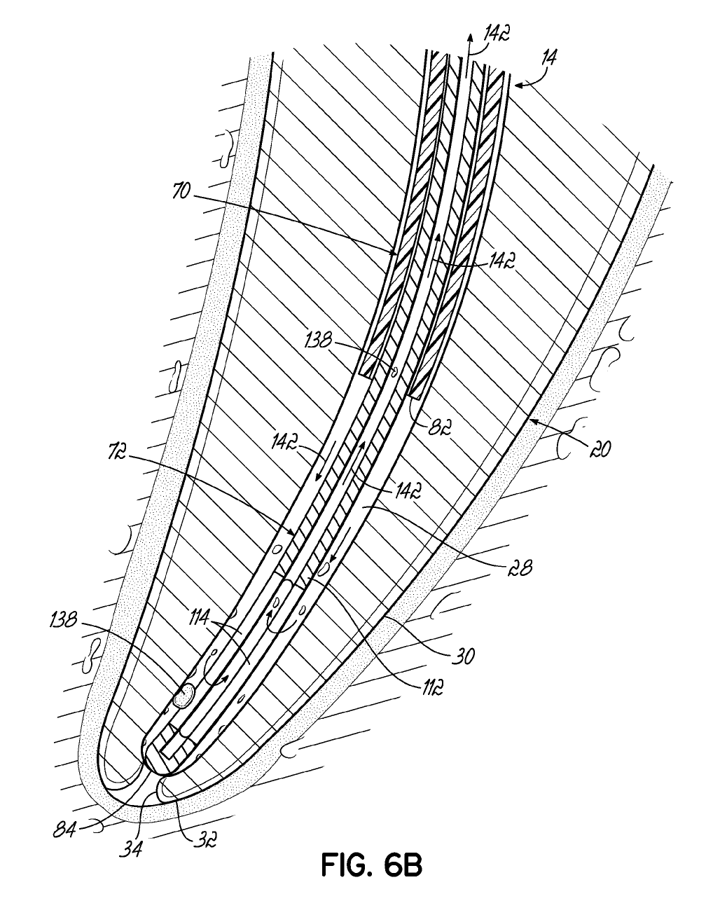

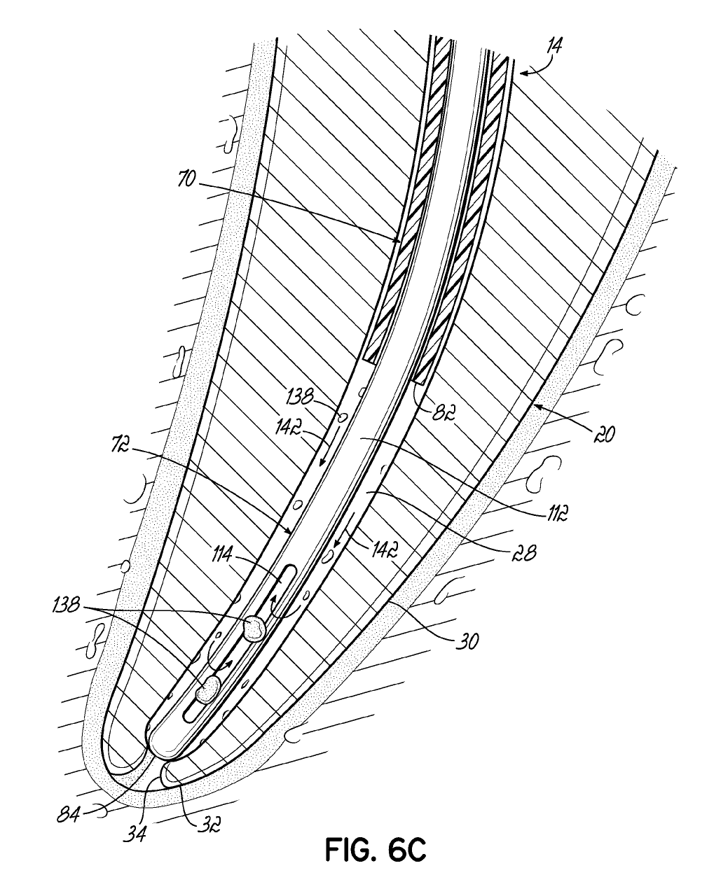

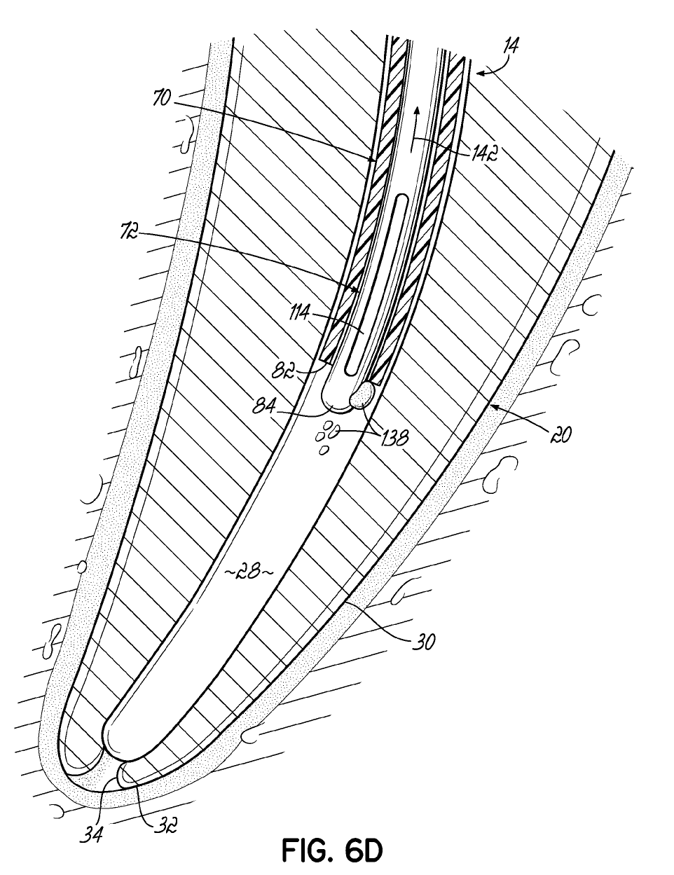

As is described below, the cannulas 70, 72 are movable with respect to one another. In one embodiment, the cannula 70 is mounted in a fixed relation to the handpiece 16, and the cannula 72 may be movable relative to the cannula 70. While each of the cannula 70 and cannula 72 are described in more detail below, the cannula 70 has an end or rim 82 that is insertable into the root canal 28 (shown in FIG. 5A). The cannula 72 is smaller than the cannula 70 and so may fit within the cannula 70. The cannula 72 has an end 84 and because of the relatively small size of the cannula 72, it is capable of being extended further into the root canal 28 than the cannula 70. The cannula 72 may be moved so as to extend the end 84 from the cannula 70 beyond the rim 82. The clinician may control the relative position of the cannula 72 with an extension control system 76 and so may extend (according to arrow 78 in FIG. 2) the cannula 72 to a predetermined distance during endodontic therapy. The clinician may then use the extension control system 76 to retract (according to arrow 80 in FIG. 2) the cannula 72 relative to the cannula 70. The cannula 72 is shown in a retracted position relative to cannula 70 in FIG. 4A and in an extended position in FIG. 4B. Each of these positions may be utilized in endodontic therapy, as is described below with reference to FIGS. 5A-6D.

In one embodiment, each of the cannulas 70, 72 is fluidly coupled to a vacuum source, such as, the same vacuum source in the clinician's office as is coupled to the irrigant system 12. The canal evacuation system 14 may also be coupled to the vacuum source via the tube 40. In that regard, the end 86 of the cannula 70 is secured to the handpiece 16 at an opening 88 of passageway 90. As shown best in FIG. 4A, the passageway 90 intersects the tube 50 at junction 92. The vacuum source is thus divided between the irrigant system 12 and the canal evacuation system 14 at the junction 92. More particularly, the passageway 90 and tube 50 may have a roughly Y-shaped configuration and divide vacuum from the vacuum source between the two systems 12, 14.

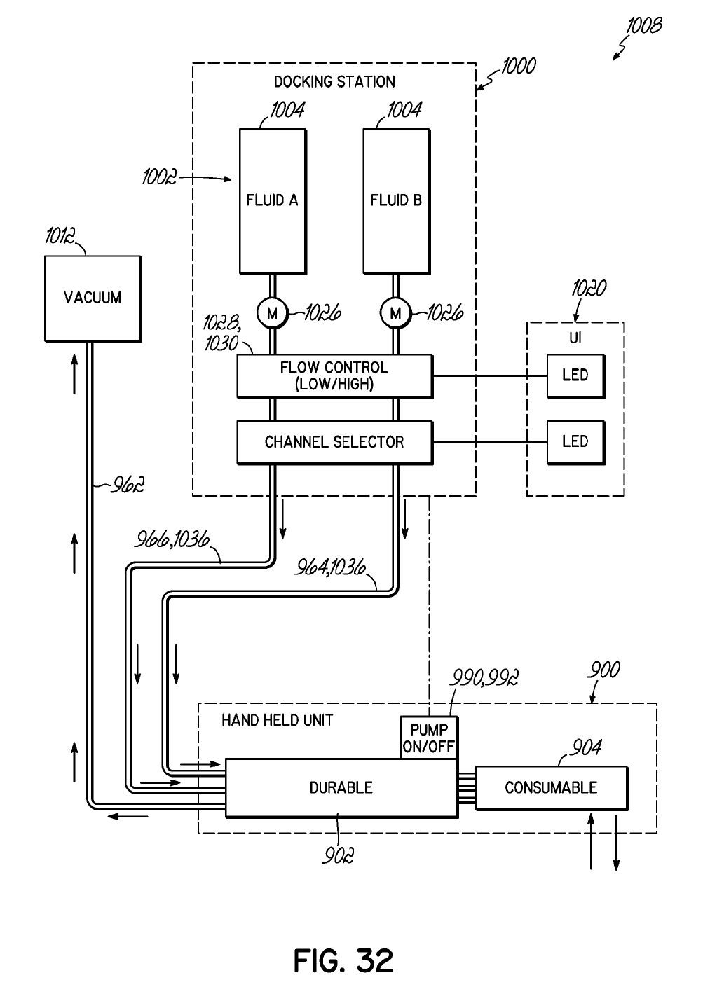

A source of vacuum may be provided in the canal evacuation system 14 at rim 82 of the cannula 70 when the cannula 72 is in its retracted position (shown in FIG. 4A). This is shown schematically by arrows 96 at the rim 82. While vacuum may be supplied via tube 40 (FIG. 1), in one embodiment, the device 10 is not coupled to a vacuum system in the clinician's office (e.g., shown in FIG. 32). Instead, the device 10 may generate a vacuum internally, for example, within the handpiece 16. That vacuum may then be coupled to each of the irrigant system 12 and the canal evacuation system 14, as described herein. By way of example, vacuum generation may be by way of a venturi device (not shown) fluidly coupled to the irrigant system 12. The venturi device may be contained within the handpiece 16. The flow of irrigant through the irrigant system 12 and the venturi may generate vacuum at the opening 52 and thus eliminate the need for a separate vacuum line extending from the handpiece 16 and eliminate the need for a vacuum system accessible to the clinician.

With either source of vacuum, fluid and debris are removed from the tooth. In the embodiment shown in FIGS. 4A, 5A, and 5B, fluid and debris are evacuated through the rim 82 passes through passageway 90 according to arrow 98 and through the junction 92 and may merge according to arrow 100 with debris and fluid, if any, evacuated through the opening 52 of the tube 50 of the irrigant system 12. By way of example, and with regard to improving the efficacy, one or both of the cannulas 70, 72 may include protrusions and/or recesses that create turbulence in the vacuum or irrigant flow.

Other features may be used alone or in conjunction with those described herein to vibrate the irrigant within the root canal, wherein vibration may include sonic and ultrasonic vibration. By way of example, one or both of the cannulas 70, 72 may include an orifice (not shown) in a respective side wall. The orifice may be at a location exposed to atmospheric pressure. When vacuum is pulled on the cannula 70, 72, air at atmospheric pressure adjacent the cannula 70, 72 may be sucked into the interior of the cannula 70, 72. The rush of air through the orifice may produce a “whistle” accompanied by vibration of the cannula 70, 72. This may be similar to a dog whistle though operating on vacuum. That is, instead of blowing pressurized air through an orifice, acoustic vibration is created by vacuum which pulls air through an orifice. When the cannula 70, 72 is submerged in fluid, the vibration of the cannula 70, 72 may vibrate the fluid with a similar frequency. This vibration may be in the sonic or ultrasonic ranges and may enhance the efficacy of the cleaning process. As an added benefit, the sonic or ultrasonic vibration may mitigate clogging of the cannulas described herein by dislodging or breaking up any debris that may be lodged in the cannula openings during fluid evacuation.

When the cannula 72 is in its extended position, as is shown in FIG. 4B, vacuum is provided at the end 84 of the cannula 72. This is shown schematically by arrows 96 adjacent the end 84 of the cannula 72 in FIG. 4B. Fluid and debris evacuated by the cannula 72 passes through the passageway 90 and merges with debris and fluid, if any, evacuated through the opening 52 of the tube 50 according to arrow 100.

In the exemplary embodiment shown with reference to FIGS. 4A and 5A, the cannula 70 has a multi-tiered funnel-like configuration in which one or more dimensions of the cannula 70 change from the rim 82 to the end 86. By way of example only, the cannula 70 includes a first portion 102, a second portion 104, and a third portion 106. The first, second, and third portions 102, 104, 106 are separated by tapered regions 108 and 110, respectively. Each of the portions 102, 104, 106 defines a different outside dimension of the cannula 70. By way of example only, the first portion 102 defines the rim 82 and defines the smallest outside dimension of the cannula 70. In this regard, the rim 82 is sized to fit within the root canal 28 but may be too large to fit to all the way to the apex 32 of the root 30. Each of the second and third portions 104 and 106 may be larger in dimension than the first portion 102, particularly the outside dimension of the rim 82. Because the cannula 70 is larger in diameter than the cannula 72, it may be referred to herein as a macrocannula and the cannula 72 as a microcannula.

In an exemplary embodiment shown and with reference to FIGS. 4B and 5B, the cannula 72 may be sized to fit within the cannula 70. That is, the cannula 72 may reside inside the cannula 70, as shown. Accordingly, the outside diameter of the cannula 72 may be slightly smaller than the inside diameter of the cannula 70 at the rim 82. In one embodiment, the relative size difference allows the cannula 72 to slide relative to the cannula 72 but a vacuum seal may be formed between the cannula 70 and the cannula 72 when a vacuum is applied to the canal evacuation system 14. In this regard, when the microcannula 72 is at its extended position (FIG. 4B), a vacuum seal may be formed between the macrocannula 70 and the microcannula 72 in the region of overlap proximate the rim 82. This may be referred to as “analog switching.” In an exemplary embodiment, the cannula 72 may function similarly to a needle valve with respect to the cannula 70. As the cannula 72 is extended through the cannula 70, flow through the cannula 70 is decreased and is eventually shut off.

As shown, the outside diameter of the cannula 72 may be substantially smaller than the inside diameter of each of the second portion 104 and the third portion 106 of the cannula 70. When the cannula 72 is in its retracted position (FIG. 4A), the cannula 72 is spaced apart from the inside surface of the cannula 70 of the second portion 104. As is described below, the space between the cannula 72 and the second portion 104 of the cannula 70 permits the passage of irrigant and debris between the cannula 70 in the cannula 72 during evacuation of a root canal with the cannula 70.

As is shown in FIGS. 4C-4E, 6B and 6C, rather than having an opening at the end 84, the cannula 72 includes a sidewall 112 that forms a tubular member and one or more openings 114 in the sidewall 112. The openings 114 evacuate irrigant and debris from the root canal 28 in a lateral direction. The end 84 is thus closed and may be rounded or have a spherical configuration. The rounded end 84 may be formed by swaging, laser welding, or placing a weld ball on an open ended tube to form the end 84. The openings 114 may be cut or otherwise formed in the sidewall 112. The outside diameter of the cannula 72 may be sized to fit within the root canal 28 to a location at or near the apical foramen 34 and, by way of example, may be from about 0.25 millimeters to about 0.5 millimeters in dimension. With the microcannula, as described herein, at this location, evacuation through the microcannula may produce a negative apical pressure sufficient to clean debris and fluid from the root canal to the apical foramen 34.

As is shown in FIGS. 6A, 6B, and 6C, the outside diameter of the cannula 72 is sufficiently small to fit within the root canal 28 to the apex 32 of the root 30 and still allow irrigant and debris to flow between the outside diameter of the cannula 72 and the root canal 28. The end 84 may be extended all the way to the apical foramen 34. As shown, the end 84 may block the apical foramen 34.

In FIGS. 4C-4E, the openings 114 are not limited to any particular configuration or number. By way of example only, the openings 114 may be staggered quad slots of about 0.10 mm (about 0.004 inch) in width by about 0.41 mm (about 0.016 inch) in length (FIG. 4C), staggered circular holes of about 0.10 mm (about 0.004 inch) in diameter (FIG. 4D), or dual slots of about 0.20 mm (about 0.008 inch) in width by about 0.41 mm (about 0.016 inch) in length (FIG. 4E). The end 84 including the openings 114 may be treated to remove any burs that may be formed during formation of the openings 114. Treatment may include a pickling process, double shooting, and/or electro polishing to remove any burs from the cannula 72. The cannula 72 may be clamped and rotated to ensure alignment.

As described above, the cannula 72 is movable relative to the cannula 70 from a retracted position within the cannula 70 (shown in FIG. 4A) to an extended position (shown in FIG. 4B). In the exemplary embodiment shown, the cannula 72 is concentric with the cannula 70. In that regard, the cannulas 70, 72 may share a common center, and the cannula 72 may translate relative to the cannula 70 along an axis defining the common center shared by the cannulas 70, 72. Embodiments of the present invention are not limited to concentric cannulas 70, 72 as the relative movement between the cannula 70 and the cannula 72 may occur along an axis that is not aligned with a longitudinal axis of either of the cannula 70 or the cannula 72, depending upon which cannula translates. It may be sufficient that the outside dimension of the cannula 72 may be sized to slidably fit within the inside dimension of the cannula 70. This arrangement of a cannula-within-a-cannula allows a telescope type of relative movement between the cannula 72 and the cannula 70.

The telescoping movement of the cannula 72 relative to the cannula 70 may be controlled by the clinician. In that regard and with reference to FIG. 1, the clinician may selectively operate the extension control system 76 to position the cannula 72 relative to the cannula 70. In one embodiment, the extension control system 76 includes a thumb slide 116. As shown, the handpiece 16 includes a channel 118 in which the thumb slide 116 is exposed so as to be selectively movable. The thumb slide 116 is movable relative to the handpiece 16 along a longitudinal axis of the handpiece 16 as indicated by arrow 120. Advantageously, the clinician may selectively operate the thumb slide 116 to extend the cannula 72 to a predetermined distance within a range of distances within the range of movement of the cannula 72. For example, the handpiece 16 may be marked with measurement indicia (not shown), which may be in the form of a ruler, along the housing of the handpiece 16 adjacent the thumb slide 116. The clinician may then position the thumb slide 116 adjacent the indicia and be assured that the cannula 72 is at a predetermined extended position relative to the cannula 70.

With reference now to FIGS. 4A and 4B, the thumb slide 116 is coupled to a push rod 124 at one end 126. In one embodiment, the push rod 124 is coupled to the cannula 72 at an opposite end 130. The clinician may therefore selectively move the thumb slide 116 with a thumb or forefinger and thereby move the cannula 72 relative to the cannula 70. The stroke or range of movement of the cannula 72 may be approximately the same as the distance the thumb slide 116 is movable within the channel 118. In this regard, the stroke distance of the thumb slide 116 may be at least the same length as or slightly longer than the first portion 102 of the cannula 70. By way of example only, the thumb slide 116 may be moved by a distance of about 20% more than the length of the first portion 102 of the cannula 70. In this way, the clinician may move the cannula 72 from within the second portion 104 through the first portion 102 of the cannula 70 so that the end 84 of the cannula 72 is positioned beyond the rim 82. It will be appreciated that the stroke of the thumb slide 116 may position the end 84 of the cannula 72 proximate the apical foramen 34 of the root canal 28 (shown in FIG. 6A).

With continued reference to FIGS. 4A and 4B, the end 130 of push rod 124 may be tapered so as to have a stopper-like configuration with the cannula 72 being centrally located on the end 130. The end 130 may cooperate with the tapered region 110 between the second portion 104 and the third portion 106 of the cannula 70. As shown in FIG. 4B, extension of the cannula 72 from the cannula 70 by pushing the thumb slide 116 toward the end 74 of the handpiece 16 pushes the end 130 of the push rod 124 into the tapered region 110. The interference fit between the end 130 and the tapered region 110 or another portion of the cannula 70 seals the passageway 90 from the cannula 70 at that location. As a consequence, vacuum within the passageway 90 is routed through the microcannula 72. This produces vacuum at the openings 114 proximate the end 84 of the microcannula 72.

With reference now to FIGS. 5A and 5B, the endodontic device 10 is described in conjunction with endodontic therapy. As shown, once the opening 22 is formed in the tooth 20, the tissue within the pulp chamber 26 and root canal 28 is removed, and the root canal 28 is shaped, the clinician may insert the irrigant system 12 and the canal evacuation system 14 proximate or through the opening 22.

As an initial stage of cleaning and disinfecting the pulp chamber 26 and the root canal 28, the clinician may fill the pulp chamber 26 and root canal 28 with irrigant 136. One or more irrigants may be utilized during endodontic therapy. Irrigants may include sodium hypochlorite (NaOCl) and ethylenediaminetetraacetic acid (EDTA), though other fluids may alternatively or additionally be utilized. The irrigant 136 is dispensed from the irrigant system 12, particularly from the fluid delivery tube 60. It will be appreciated that overfilling the pulp chamber 26 may be prevented by evacuation of excess irrigant through the vacuum tube 50 as is indicated by arrows 54 and 56. In this manner, it is then possible to provide a continuous stream of irrigant 136 from the fluid delivery tube 60 into the pulp chamber 26 without concern that the irrigant 136 overflows the opening 22. Advantageously, a continuous stream of irrigant 136 provides a more thorough cleaning and disinfecting of the pulp chamber 26.

At the same time or subsequent to filling the pulp chamber 26 with irrigant 136, the clinician may evacuate the upper portion of the root canal 28 with the cannula 70. Although not shown, the clinician may cycle the endodontic device 10 in an occlusal-gingival direction (as is generally indicated by arrow 140) to pull the macrocannula 70 in and out of the root canal 28. The irrigant 136 and debris 138 residing in the upper portion of the root canal 28 may be evacuated through the cannula 70. This cyclic motion, when combined with evacuation, may remove the irrigant 136 in the root canal 28 through the passageway 90 as indicated by arrow 98 and may also remove a substantial portion of any debris 138 in the root canal 28. In this manner, a region of negative pressure is produced in the upper portion of the root canal 28 which may draw irrigant from the pulp chamber 26 into the root canal 28. It will be appreciated that the endodontic device 10 produces two sources of vacuum simultaneously in the tooth. One source of vacuum is at the crown of the tooth (i.e., at vacuum tube 50) and the other source of vacuum is in the root canal (i.e., at the rim 82). The apical third of the root canal 28 however may still require cleaning and disinfecting.

With reference now to FIGS. 6A and 6B, in one embodiment, once the upper portion of the root canal 28 is sufficiently cleaned of debris and irrigant, the clinician may extend the cannula 72 to clean the remaining apical third of the root canal 28. As described above this may include operating the extension control system 76 by pushing the thumb slide 116 toward the end 74 of the endodontic device 10. Although not shown in FIG. 1, the handpiece 16 may include numerical indicia positioned proximate the thumb slide 116. The clinician may then move the thumb slide 116 to a predetermined location as indicated by the indicia. Doing so extends the cannula 72 a known distance beyond the rim 82 of the cannula 70. Advantageously, the endodontic device 10 may eliminate the need to measure the depth of the root canal and mark that measured depth on a microcannula for insertion into the root canal. By way of example, in conjunction with an impedance measurement as may be found in an apex locator, it may be possible for the clinician to extend the cannula 72 into the root canal and measure the location of cannula relative to the apex 32.

Moving the thumb slide 116 also slides the push rod 124 so that the end 130 engages the third portion 106 and/or the tapered region 110 of the cannula 70. Once the end 130 seals against the macrocannula 70, the macrocannula 70 is isolated from vacuum. Vacuum is instead now routed through the microcannula 72 to the openings 114 at end 84. Advantageously, there is no need to exchange a large cannula for a smaller cannula as is shown and described in U.S. Pat. No. 8,827,705, which is incorporated by reference herein in its entirety.

As is shown in FIGS. 6B and 6C, the cannula 72 may be extended to the apex 32 and into contact with the apical foramen 34. Although not shown, the clinician may force the end 84 through the apical foramen 34 with little or no consequence. Because a vacuum is present at the openings 114, if the end 84 penetrates the apical foramen 34 it is unlikely that any irrigant 136 will escape into the surrounding tissue. While the cannula 72 may clog do to other issues, one possible reason that the cannula 72 may stop evacuating fluid from the root canal is that the cannula 72 is proximate the apical foramen 34 within the root canal 28. In one embodiment, the end 84 may seal the apical foramen 34 and prevent irrigant from passing through the apical foramen 34 during irrigant flow.

Once the clinician is satisfied with the position of the cannula 72, evacuation of the apical third of the root canal 28 proceeds. Similar to evacuation with the cannula 70, the endodontic device 10 may produce two sources of vacuum simultaneously in the tooth. One source of vacuum is at the crown of the tooth (i.e., at vacuum tube 50) and the other source of vacuum is in the root canal (i.e., at the openings 114). Because the cannula 72 provides apical negative pressure, irrigant travels from the pulp chamber 26 toward the apex 32 and so cleans and disinfects the apical third of the root canal 28. Irrigant flow, as indicated by arrows 142, is toward the openings 114 and then into the cannula 72. By way of example only, the irrigant may initially be NaOCl. Once irrigation with NaOCl is complete, the clinician may switch to EDTA.

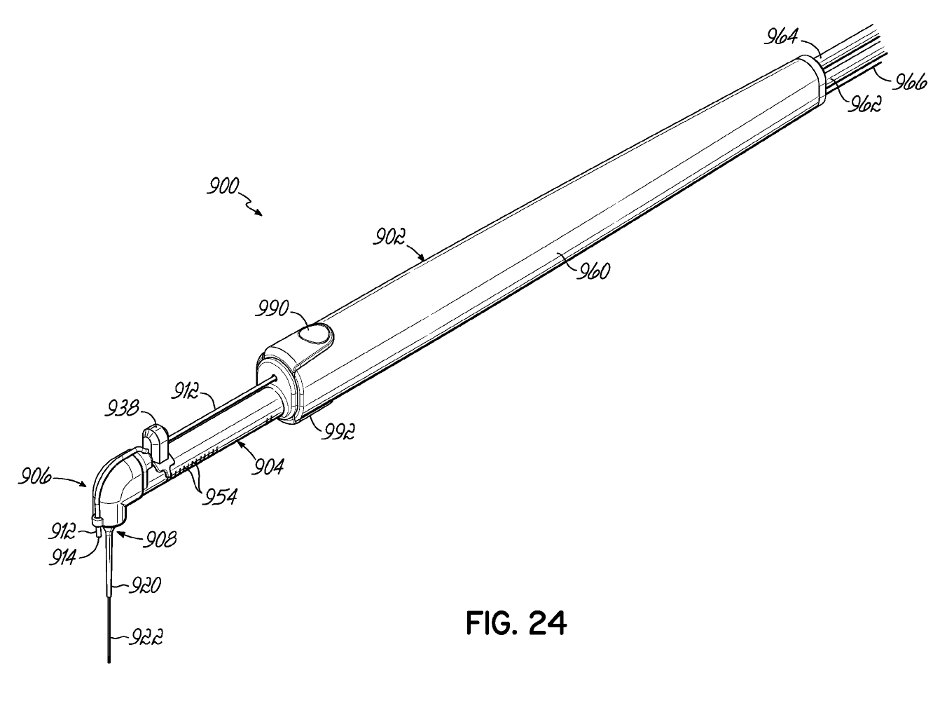

As described below, the clinician may select the desired irrigant by simply selecting one irrigant source from a multitude of irrigant sources. See, e.g., irrigant reservoirs in FIGS. 24-41. Advantageously, there is no need to replace one irrigant with another by swapping syringes with the microcannula. Other irrigants may include enzymes, such as, pepsin and serine protease. These irrigants may produce a “non-instrumental debridement.” According to embodiments of the present invention, the clinician may iterate between two or more irrigants without swapping syringes of different irrigants. The efficacy of any irrigant may be improved by increasing the temperature of the irrigant or by perturbation of the irrigant while in contact with the tissue. In this regard, the device 10 may be capable of heating the irrigant to increase the temperature of the irrigant by up to 40° F. from standard temperature or above room temperature, for example, to about 110° F. or so. Likewise, or as an alternative, the device 10 may be capable of cooling the irrigant to a temperature below room temperature, for example, to temperatures of about 5° F. or 10° F. before dispensing the irrigant into the root canal. The device 10 may be capable of sonic or ultrasonic vibration of the irrigant to improve perturbation within the root canal. Further, a combination of irrigants and mechanical debridement and heating may thus produce a chemical-mechanical endodontic process.

With the irrigant flow shown in FIG. 6C, for example, debris 138 is also drawn toward the openings 114. Debris 138 smaller than the dimension of the opening 114 may pass into the cannula 72 with the irrigant 136 and be removed from the tooth 20. In this regard, the dimension of the opening 114 may be smaller than the inside dimension of the cannula 72. This relative size difference may prevent debris 138 from being lodged within the cannula 72 and blocking irrigant flow.

As is shown in FIG. 6C, it is anticipated that debris 138 larger than the openings 114 may become lodged against the opening 114 due to the presence of vacuum at this location. If a sufficient amount of debris 138 becomes lodged on the opening 114, the clinician may notice a drop in evacuation efficiency. The endodontic device 10 may provide quantitative information about clogging of the opening 114, as is described in more detail below. If the clinician notices a drop in cleaning efficiency of the cannula 72, the clinician may withdraw the cannula 72 by selectively moving the thumb slide 116 in a direction that retracts the cannula 72. Any debris 138 adhered to the openings 114 may be wiped off the exterior surface of the cannula 72 by virtue of the close fit between the outside diameter of the cannula 72 and the rim 82 of the cannula 70. By this movement, the clinician may restore the evacuation efficiency of the cannula 72 and extend the cannula 72 to a position similar to that shown in FIG. 6C to resume cleaning. Thus, the entire length of the root canal, including the apical third, is treated. It will be appreciated that treatment is achieved without injecting the irrigant anywhere in the root canal near the apical foramen.

Once the pulp chamber 26 and root canals 28 are sufficiently clean, the clinician may dry the root canals 28 and the pulp chamber 26 with the cannula 72 in preparation for filling and sealing the tooth 20. In that regard, air may be blown through the microcannula and/or macrocannula. Alternatively, the microcannula may be used to evacuate residual moisture while air is blown through the opening 22 of the tooth (FIG. 5A). Evacuation through the microcannula simultaneously with blowing air through the opening 22 may circulate air in the apical third of the root canal 28 to more rapidly and thoroughly dry the root canal 28. The moisture within the root canal may be monitored via a capacitance or microwave sensor or similar device to provide real-time feedback on the moisture level within the root canal. In one embodiment, a moisture absorbent material, for example, a synthetic cotton fiber, may be added to the microcannula to absorb any moisture that evades evacuation.

Once the root canals 28 are clean and sufficiently dry, the clinician may dispense a sealant and then an obturation material into the prepared canals. Any of the orthodontic devices described herein may be used to fill the root canal 28 with the obturation material. In that regard, the obturation material may be injected directly into the root canal 28 through the macrocannula 70. The microcannula 72 may be inserted to near the apical foramen 34. Evacuation through the microcannula 72 may draw the obturation material to or near the apical foramen 34 without injecting the obturation material through the apical foramen. The clinician may then be assured that the material fills the apical third of the root canal 28. In one embodiment, the microcannula 72 is left in the root canal 28 once filling is complete. The microcannula 72 may be plastic that is compatible with the obturation material. By way of example only, the microcannula 72 may be a polysulfone.

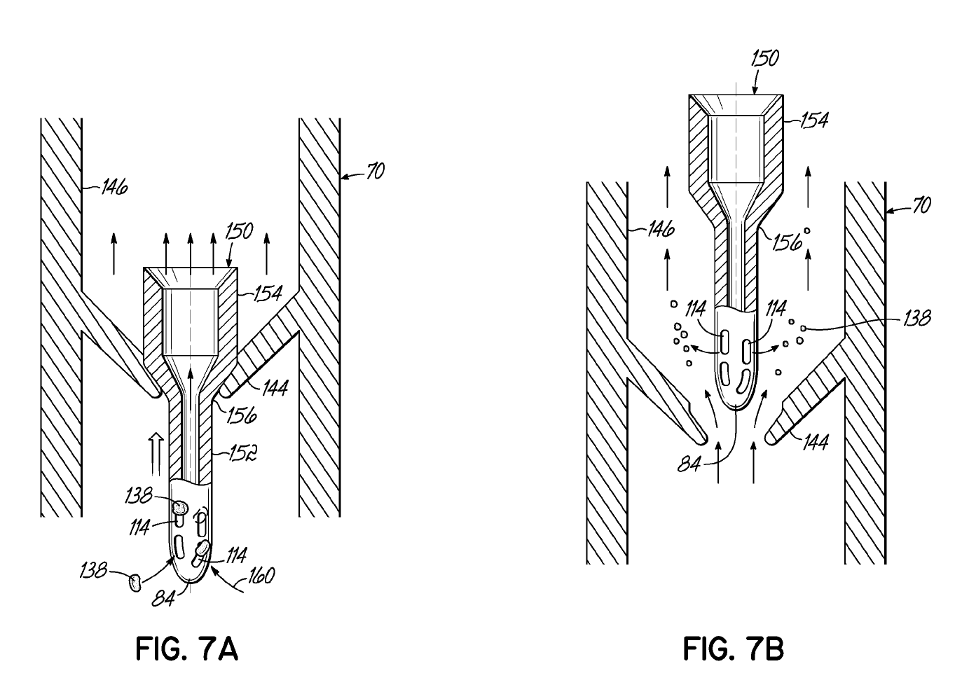

With reference now to FIGS. 7A and 7B, in one embodiment an alternative method for cleaning the debris 138 from the openings 114 is shown. In that regard, the cannula 70 includes a fin 144 that may extend from an interior surface 146. In FIG. 7A, a cannula 150, similar to the cannula 72 described above, may have different outside dimensions and, by way of example, include a first portion 152 and a second portion 154 having different outside dimensions. A tapered region may produce a shoulder 156 that transitions from the smaller outside dimension of the first portion 152 to the larger outside dimension of the second portion 154.

In an extended position shown in FIG. 7A (which may correspond to the extended position of the cannula 72 shown in FIGS. 6A-6C, described above), the shoulder 156 may engage the fin 144. This may produce vacuum at the openings 114 to pull irrigant and debris 138 toward the openings 114 as is generally indicated by arrows 160. As shown, debris 138 larger than the openings 114 may become lodged against the outside surface of the cannula 150 and thus reduce the cleaning efficiency of the cannula 150.

With reference to FIG. 7B, the clinician may move the cannula 150 relative to the cannula 70 and fins 144. The fins 144 may wipe the debris 138 from the openings 114. A combination of the wiping and turbulence created by the fins 144 and the change from evacuating through the cannula 150 to evacuating through the cannula 70 may free the cannula 150 of debris 138.

It will be appreciated that the fins 144 may be silicone or another material. Alternatively, rather than fins 144, the cannula 70 may have brushes, velvet-like material, or sponge in a similar configuration. Embodiments of the present invention are not limited to the fins 144 shown and described in FIGS. 7A and 7B. The fins 144 may be used alone to mechanically unclog the cannulas 70, 72 or in combination with the configuration of the cannula 70 and cannula 72 shown and described in FIGS. 1-6D above.

Other methods of clearing debris from the openings 114 are contemplated. By way of example only and not limitation, ultrasonic or sonic energy may be used to dislodge debris from the cannula 72, 150. An ultrasonic transducer (not shown) or other element may be coupled to the cannula 72, 150 to vibrate the debris from the cannula 72. In addition or alternatively, a sonic element may be utilized to generate turbulent flow or pulsed negative pressure flow within the stream of fluid evacuated from the root canal. The pulsing stream may disrupt the force holding the debris to the cannula and may facilitate dislodging debris and restoring evacuation efficiency.

In one embodiment, the endodontic device 10 is capable of providing the clinician with quantitative or qualitative information regarding the flow status of the cannulas 70 and/or 72. That is, the device 10 may provide information that indicates whether the cannula 70 and/or the cannula 72 is clogged or is not evacuating the root canal 28 as intended. The clinician may then clean any debris from the openings in the respective cannula 70, 72. In one embodiment, the endodontic device 10 may be capable of measuring capacitance or impedance levels, such as impedance spectroscopy. The electrical properties of the cannula 70, 72 may change. This change may be detected and that information may then be displayed and considered by the clinician in making a determination of the effectiveness of the irrigation of the root canal 28 with the corresponding cannula 70, 72. Other means for sensing a change in the flow through the cannula 70, 72 may include a flow meter or a pressure sensor sensitive to a pressure drop.

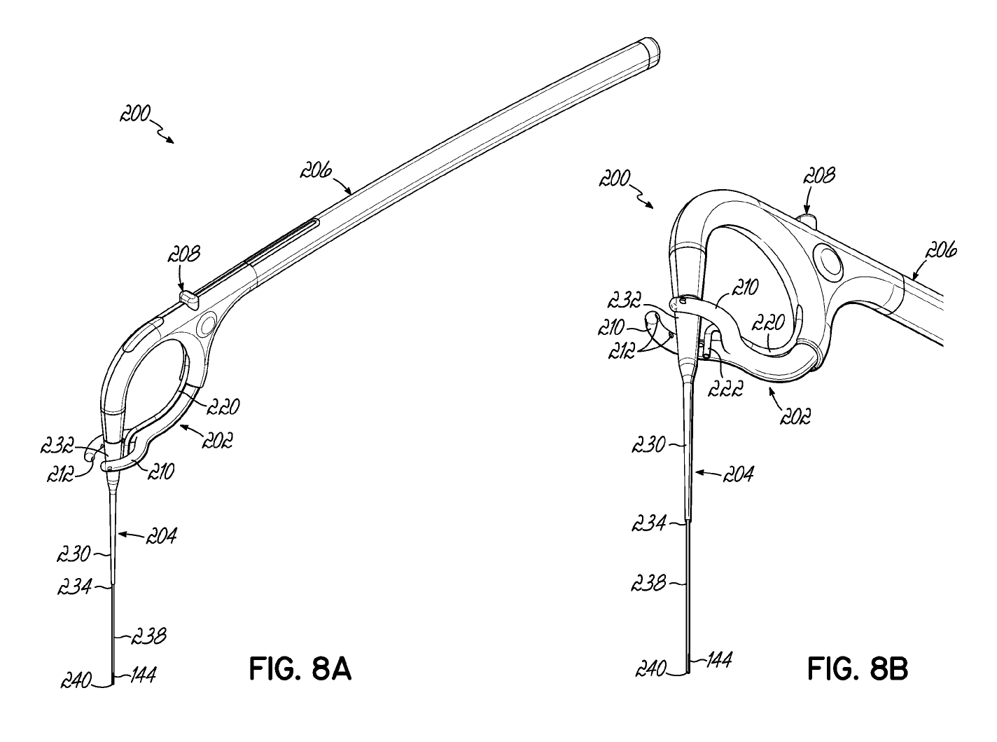

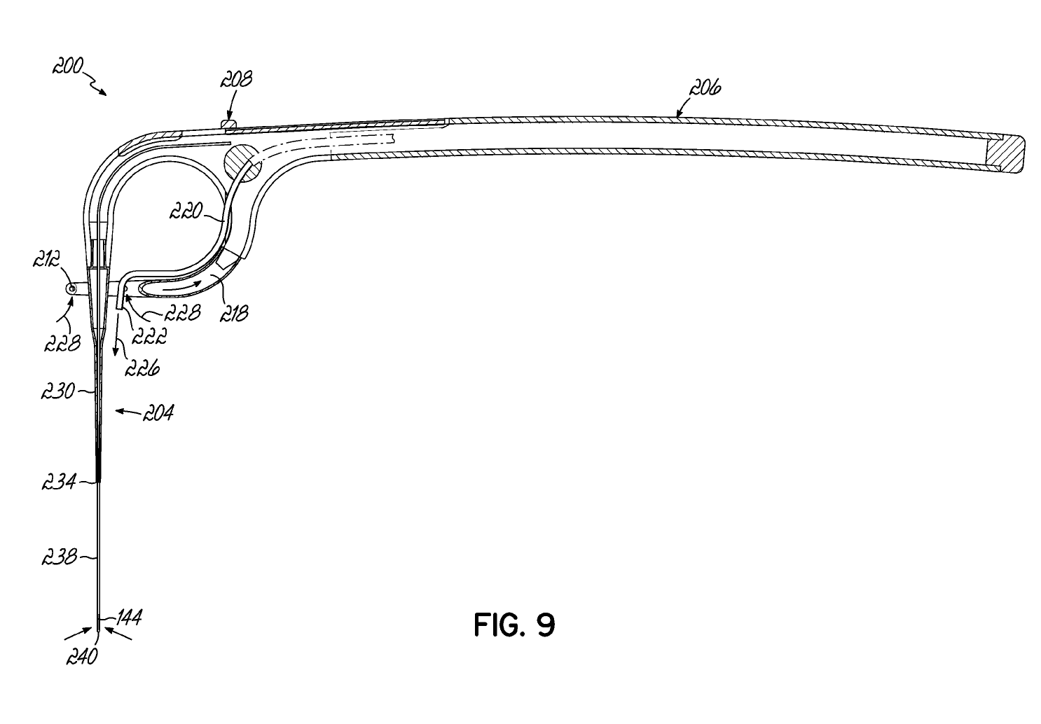

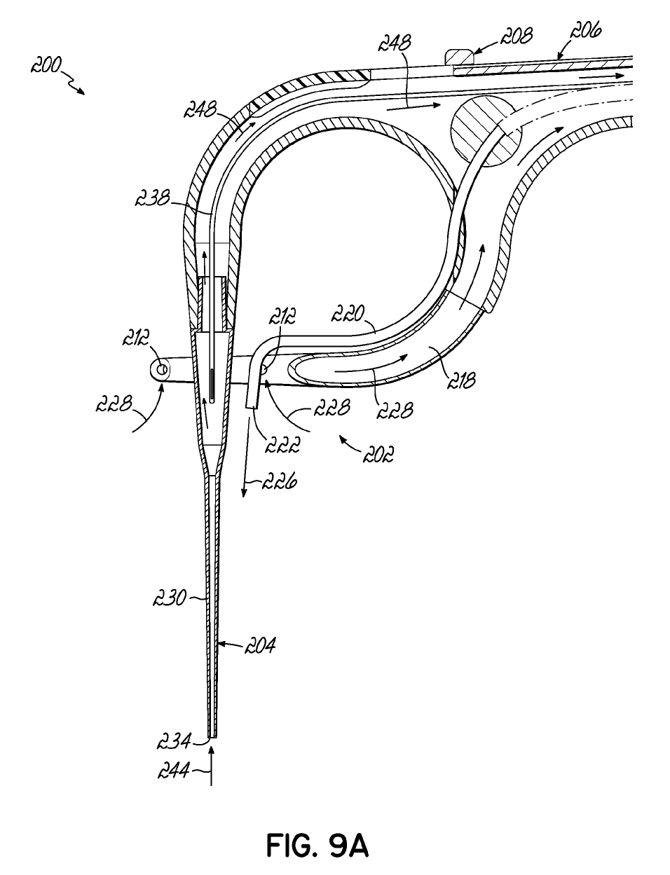

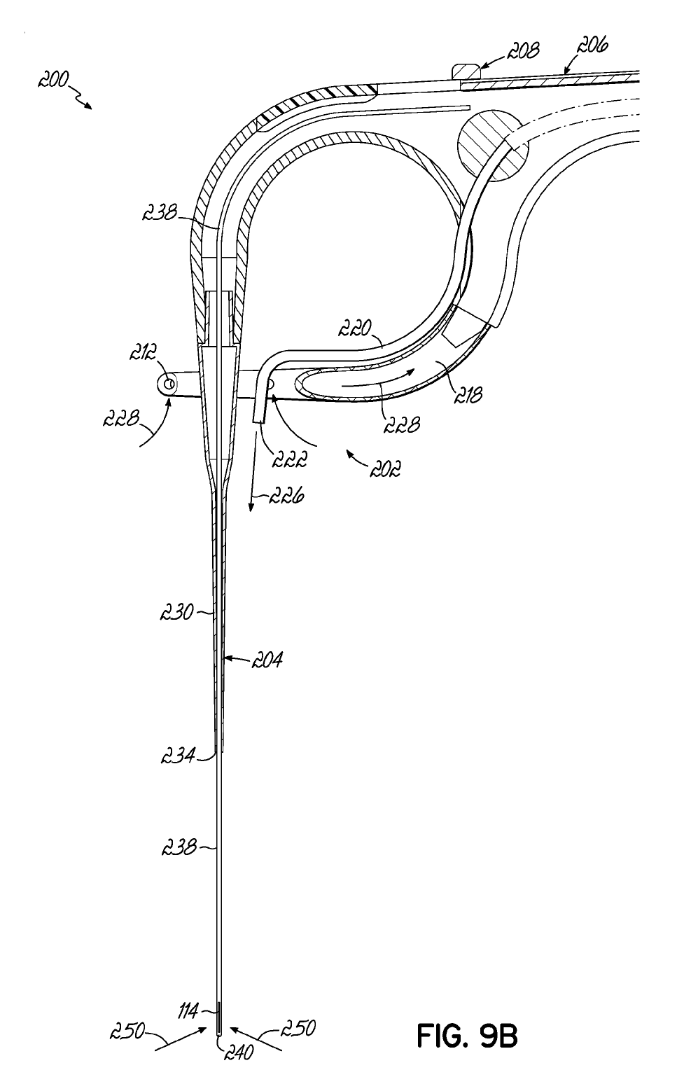

In another embodiment and with reference now to FIGS. 8A-9B, an endodontic device 200 performs substantially the same as the endodontic device 10, described above. The endodontic device 200 may be utilized in endodontic therapy for cleaning and disinfecting a diseased tooth. To that end, the endodontic device 200 includes an irrigant system 202, a canal evacuation system 204, and a handpiece 206. Each of the irrigant system 202 and the canal evacuation system 204 may be at least partially contained within the handpiece 206 and extend therefrom for cooperative placement relative to a tooth (not shown). Each of the irrigant system 202 and the canal evacuation system 204 may perform substantially the same as the irrigant system 12 and the canal evacuation system 14 described above with reference to FIGS. 1-7B. As shown, the endodontic device 200 further includes an extension control system 208 housed within the handpiece 206. The extension control system 208 may be coupled to the canal evacuation system 204 so that the clinician may selectively move a portion of the canal evacuation system 204, as described below.

With reference now to FIGS. 8A and 8B, in one embodiment the irrigant system 202 includes a vacuum ring 210 that may at least partially surround a portion of the canal evacuation system 204. In the exemplary embodiment shown, the vacuum ring 210 may have a roughly horseshoe shaped configuration in which a plurality of vacuum ports 212 are formed therein and surround the canal evacuation system 204. By way of example only, the ports 212 may be oriented to face radially inwardly towards a longitudinal axis of the irrigant system 202. The vacuum ring 210 may be hollow so as to define a passage 218 (FIG. 9) that may be fluidly coupled by way of tubing (not shown) in the handpiece 206 to a source of vacuum in the clinician's office. In this way, a region of vacuum is located at each of the ports 212. During use, the clinician may position the vacuum ring 210 around the crown of the tooth and may even rest the vacuum ring 210 on the tooth to evacuate any fluids that would otherwise escape into the patient's mouth during endodontic therapy.

The irrigant system 202 may further include an on/off button 216 and a fluid delivery tube 220 having an opening 222 generally directed in the same direction as the longitudinal axis of the canal evacuation system 204. Similar to the fluid delivery tube 60 described above with respect to FIGS. 1-4B, the fluid delivery tube 220 may be fluidly coupled to an irrigant source (not shown) external to the endodontic device 200. The clinician may then selectively flow an irrigant from the irrigant source by activating a pump, described below, via the on/off button 216. Activating the pump, flows irrigant through the fluid delivery tube 220 and out of the opening 222 into a cavity within a tooth according to arrow 226 in FIG. 9. It will be appreciated that any overflow of the irrigant from the cavity may be captured by the vacuum ring 210 and removed from proximate the tooth according to arrows 228 in FIG. 9.

In one embodiment, and with reference to FIGS. 9A and 9B, the canal evacuation system 204 includes a cannula 230 coupled at one end 232 to the handpiece 206. The cannula 230 extends through the opening defined by the horseshoe-shaped vacuum ring 210 and has a rim 234 defining an opening. The canal evacuation system 204 may be coupled to an external source of vacuum in the clinician's office. As such, the source of vacuum may be routed to the opening at the rim 234 of the cannula 230. Evacuation of debris and irrigant through the rim 234 and into the cannula 230 may be similar to that described above with respect the cannula 70 in FIG. 4A.

With reference to FIGS. 8A and 8B, the canal evacuation system 204 includes a cannula 238 that may at least partially reside within the cannula 230. The cannula 238 may extend from within the cannula 230 and terminate at an end 240. The end 240 may be closed and rounded similar to that described above with regard to the end 84 of the cannula 72. A plurality of openings 114 may be proximate the end 240. The vacuum from the vacuum source may be coupled to the openings 114 of the cannula 238. The end 240 of the cannula 230 may have any of the configurations disclosed, for example, in FIGS. 4C-4D.

The relative size and arrangement of the cannula 230 and the cannula 238 may be similar to the arrangement between the cannula 70 and the cannula 72 shown above in FIG. 2. In this regard, the cannula 238 may be sized to fit within the cannula 230 and the cannulas 230 and 238 may be arranged concentrically as is shown best in FIG. 9A. A telescope-like relationship may exist between cannula 230 and the cannula 238 in which the cannulas 230, 238 move relative to one another between extended and retracted positions.

With reference to FIGS. 9A and 9B, the clinician may operate the extension control system 208 to move the cannulas 230 and 238 relative to one another. In the exemplary embodiment shown, the cannula 238 is movable relative to the cannula 230. The cannula 238 has a retracted position as shown in FIG. 9A and has an extended position shown in FIG. 9B. In these positions, the canal evacuation system 204 operates in a similar manner as the canal evacuation system 14 described above with respect to FIGS. 1-4B. In the retracted position shown in FIG. 9A, vacuum is produced at the rim 234 as indicated by arrow 244. Thus, irrigant and debris adjacent the rim 234 is evacuated through the cannula 230 according to arrow 244 and into the handpiece 206 as indicated by arrows 248. In the extended position shown in FIG. 9B, the cannula 238 extends from the rim 234 and seals the cannula 230 at the rim 234 so that vacuum is produced at the openings 114 as is indicated by arrows 250 proximate the end 240.

The cannula 238 is coupled to the extension control system 208. The clinician may therefore operate the extension control system 208 to move the cannula 238 relative to the cannula 230 position shown in FIG. 9B.

The endodontic device 200 may be used in a similar manner as that described above with respect to the endodontic device 10. In that regard, the endodontic device 200 may be positioned proximate a tooth that has been prepared for cleaning and disinfecting. The clinician may introduce an irrigant into the tooth cavity via the fluid delivery tube 220. Any excess irrigant from the fluid delivery tube 220 may be evacuated away by the vacuum ring 210 to prevent overflowing to the patient's mouth. The clinician may then begin cleaning and disinfecting the root canal of the tooth with the cannula 230. Similar to that described above with regard to the cannula 70, the cannula 230 may be used to disinfect and clean approximately ⅔ of the root canal. That leaves cleaning of the apical third of the root canal.

Once the upper portion of the root canal is sufficiently clean, the clinician may operate the extension control system 208 to extend the cannula 238 toward the apex of the tooth. Thus, the cannula 238 may be extended into a position similar to that shown in FIG. 6A. At this location, the cannula 238 may produce a negative apical pressure. As a result, irrigant is drawn from the pump chamber through the root canal to near the apical foramen where it is pulled into the cannula 238 via the openings 114. Once the root canal is thoroughly clean and dry, the clinician may then fill the root canal and restore the tooth as is known in the art.

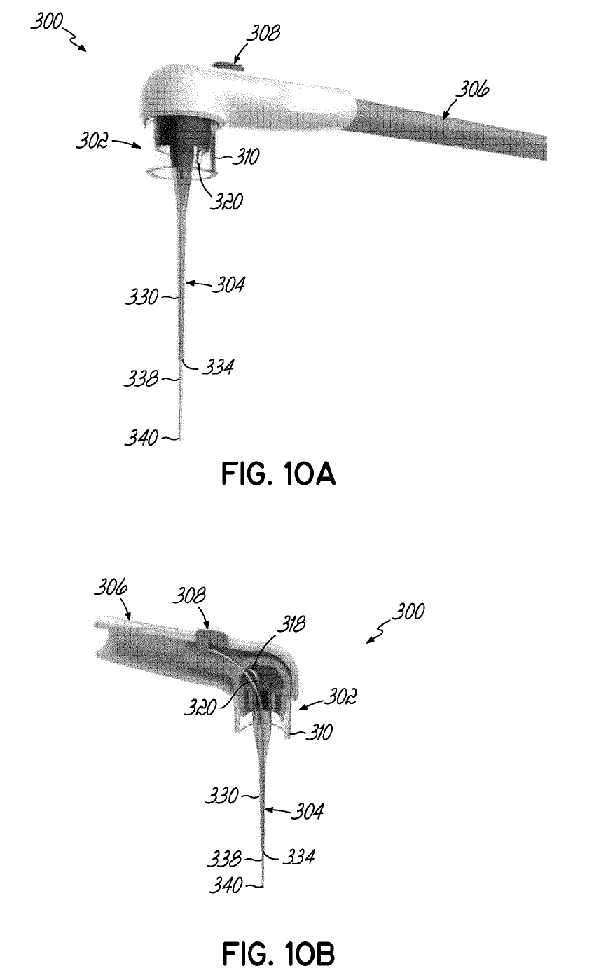

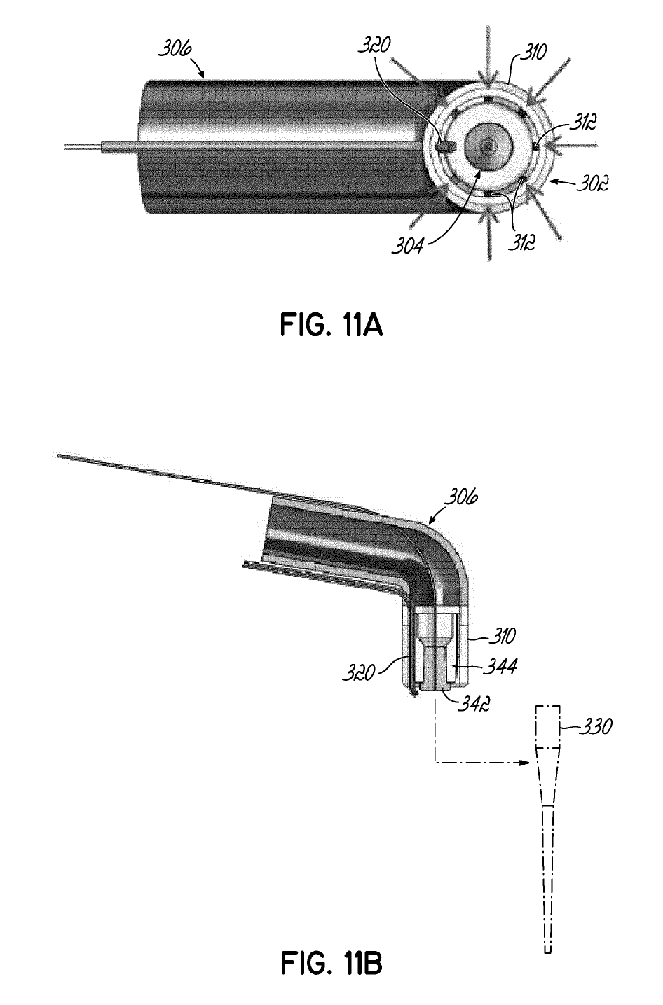

In another embodiment and with reference now to FIGS. 10A and 10B, an endodontic device 300 performs substantially the same as the endodontic devices 10 and 200, described above. In that regard, the endodontic device 300 may be utilized in endodontic therapy for cleaning and disinfecting a diseased tooth. To that end, the endodontic device 300 includes an irrigant system 302, a canal evacuation system 304, and a handpiece 306. Each of the irrigant system 302 and the canal evacuation system 304 may be at least partially contained within the handpiece 306 and extend therefrom for cooperative placement relative to a tooth (not shown). Each of the irrigant system 302 and the canal evacuation system 304 may perform substantially the same as the irrigant system 12, 202 and the canal evacuation system 14, 204 described above with reference to FIGS. 1-7B and 8A-9B, respectively.

As shown, the endodontic device 300 further includes an extension control system 308 housed within the handpiece 306. The extension control system 308 may be coupled to the canal evacuation system 304 so that the clinician may selectively move a portion of the canal evacuation system 304, as described below.

With reference now to FIGS. 10A and 10B, in one embodiment the irrigant system 302 includes a vacuum hood 310 that encircles a portion of the canal evacuation system 304. In the exemplary embodiment shown, the vacuum hood 310 may be a ring around the canal evacuation system 304 at the junction between the canal evacuation system 304 and the handpiece 306. By way of example only, at least a portion of the canal evacuation system 304 may be concentric with the vacuum hood 310. The vacuum hood 310 may couple to a passage 318 by way of tubing (not shown) and the handpiece 306 may be coupled to a source of vacuum in the clinician's office. In this way, a ring of vacuum is formed adjacent the vacuum hood 310. During use, the clinician may position the vacuum hood 310 over the crown of the tooth to evacuate any fluids that would otherwise escape into the patient's mouth during endodontic therapy.

With reference to FIGS. 10A and 10B, the irrigant system 302 may further include a fluid delivery tube 320 within the vacuum hood 310. Similar to the fluid delivery tube 60 described above with respect to FIGS. 1-4B, the fluid delivery tube 320 may be fluidly coupled to an irrigant source (not shown) that is external to the endodontic device 300. The clinician may then selectively flow an irrigant from the irrigant source through the fluid delivery tube 320 into a cavity within a tooth. It will be appreciated that any overflow of the irrigant from the cavity may be captured by the vacuum hood 310 and be removed from proximate the tooth.

In one embodiment, and with continued reference to FIGS. 10A and 10B, the canal evacuation system 304 includes a cannula 330 coupled to the handpiece 306. As described above, the cannula 330 extends through the opening defined by the vacuum hood 310 and has a rim 334 defining an opening. The canal evacuation system 304 may be coupled to an external source of vacuum in the clinician's office. As such, the source of vacuum may be routed to the opening at the rim 334 of the cannula 330. Evacuation of debris and irrigant through the opening at the rim 334 and into the cannula 330 may be similar to that described above with respect to the cannulas 70, 230 in FIGS. 4A and 8A, respectively.

The canal evacuation system 304 includes a cannula 338 that may at least partially reside within the cannula 330. During use, the cannula 338 may extend from within the cannula 330 and terminate at an end 340. Although not shown, the end 340 may be closed and rounded similar to that described above with regard to the end 84 of the cannula 72. A plurality of openings 114 may be proximate the end 340. The vacuum from the vacuum source may be coupled to the openings 114 of the cannula 338. The end 340 of the cannula 338 may have any of the configurations disclosed, for example, in FIGS. 4C-4D.

The relative size and arrangement of the cannula 330 and the cannula 338 may be similar to the arrangement between the cannula 70 and the cannula 72 shown above in FIG. 2. In this regard, the cannula 338 may be sized to fit within the cannula 330, and the cannula 330 and the cannula 338 may be arranged concentrically with respect to one another. The cannula 330 and the cannula 338 may slide relative to one another in a telescope-like relationship.

With continued reference to FIGS. 10A and 10B, the clinician may operate the extension control system 308 to move the cannulas 330 and 338 relative to one another. In the exemplary embodiment shown, the cannula 338 is movable with the cannula 330 remaining in a fixed location. The cannula 338 has a retracted position (not shown) and has an extended position shown in FIG. 10A. In these positions, the canal evacuation system 304 operates in a similar manner as the canal evacuation system 14 described above with respect to FIGS. 1-4B. Specifically, in the retracted position, vacuum is produced at the rim 334. Thus, irrigant and debris adjacent the rim 334 is evacuated through the cannula 330 and into the handpiece 306. In the extended position shown in FIG. 10A, the cannula 338 extends from the rim 334 and may seal at or in an overlapping region near the rim 334 so that vacuum is produced at the openings (not shown).

The cannula 338 is coupled to the extension control system 308. The clinician may therefore operate the extension control system 308 to move the cannula 338 relative to the cannula 330.

The endodontic device 300 may be used in a similar manner as that described above with respect to the endodontic device 10. In that regard, the endodontic device 300 may be positioned proximate a tooth that has been prepared for cleaning and disinfecting. The clinician may introduce an irrigant into the tooth cavity via the fluid delivery tube 320. Any excess irrigant from the fluid delivery tube 320 may be evacuated away by the vacuum hood 310 to prevent overflowing to the patient's mouth. The clinician may then begin cleaning and disinfecting the root canal of the tooth with the cannula 330. Similar to that described above with regard to the cannula 70, the cannula 330 may be used to disinfect and clean approximately ⅔ of the root canal. That leaves cleaning of the apical third of the root canal.

Once the upper portion of the root canal is sufficiently clean, the clinician may operate the extension control system 308 to extend the cannula 338 toward the apex of the tooth. Thus, the cannula 338 may be extended into a position similar to that shown in FIG. 10A. At this location, the cannula 338 may produce a negative apical pressure. As a result, irrigant is drawn from the pulp chamber through the root canal to near the apical foramen where it is pulled into the cannula 338 via the openings. Once the root canal is thoroughly clean and dry, the clinician may then fill the root canal and restore the tooth as is known in the art.

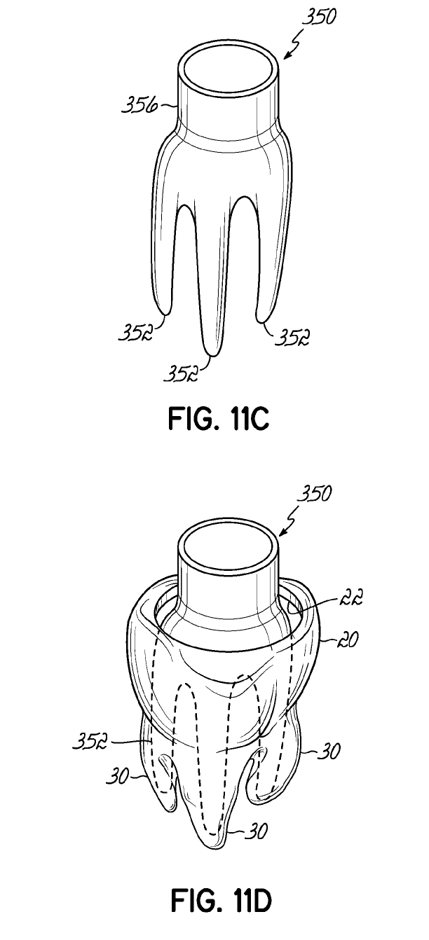

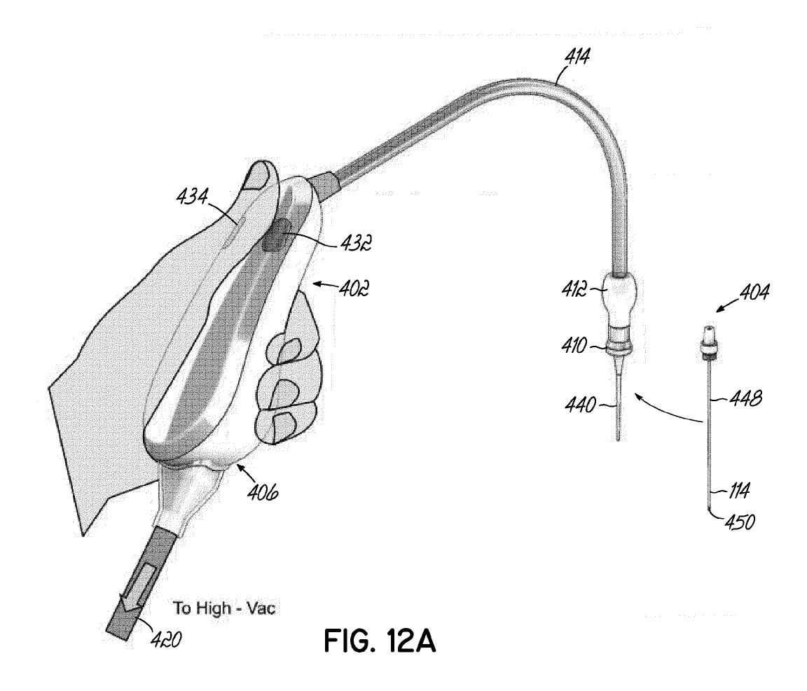

In one embodiment and with reference to FIG. 11A, the irrigant system 302 includes a plurality of ports 312 that are positioned at a location that is recessed from the opening of the vacuum hood 310. The ports 312 fluidly couple the vacuum hood 310 to the source of vacuum. The vacuum hood 310 may have a castellated configuration. In particular, the ports 312 inside the hood 310 as is shown in FIG. 11A have a castellated configuration.

In one embodiment and with reference to FIG. 11B, a portion of the canal evacuation system 304 may be disconnected from the handpiece 306. By way of example, the cannula 330 may be separated from the handpiece 306. A plug 342 may be used to cap a port 344 in the handpiece 306 formed when the cannula 330 is removed. In this configuration, the handpiece 306 may be used in an irrigation only mode in which fluid may be evacuated only through the vacuum hood 310. While the cannula 330 may have a single lumen through which fluid and debris may be evacuated, embodiments of the invention are not limited to single lumen cannulas.

By way of example, and with reference to FIG. 11C, in one embodiment, a multi-lumen cannula 350 may include two or more cannulas 352 that extend from a manifold-like main body 356. The multi-lumen cannula 350 may be used with any single one of the endodontic devices disclosed herein. As shown, there may be one cannula 352 for each root canal. As can be appreciated, the clinician may then insert one cannula 352 into each root canal with the main body 356 coupled to a handpiece. The clinician may irrigate each root canal simultaneously.

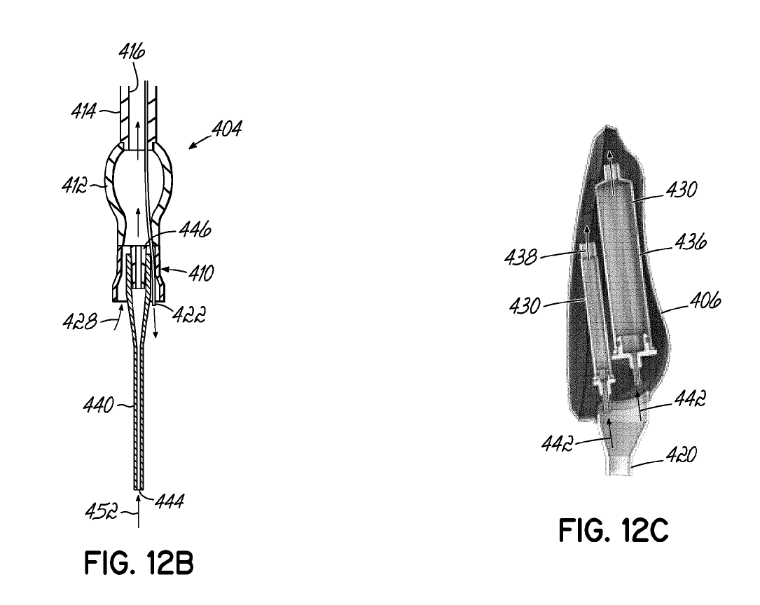

In another embodiment of the invention, with reference now to FIGS. 12A-12C, an endodontic device 400 performs substantially the same function as the endodontic device 10, described above. The endodontic device 400 may be utilized in endodontic therapy for cleaning and disinfecting a diseased tooth. To that end, the endodontic device 400 includes an irrigant system 402, a canal evacuation system 404, and a handpiece 406. The irrigant system 402 may be at least partially contained within the handpiece 406. The canal evacuation system 404 may extend from the handpiece 406 and may be placed separately from the handpiece 406 relative to a tooth (not shown). Each of the irrigant system 402 and the canal evacuation system 404 may perform substantially the same as any of the irrigant system and the canal evacuation system, respectively, described herein.

With reference now to FIGS. 12A and 12B, in one embodiment, the irrigant system 402 includes a vacuum hood 410 that may at least partially surround a portion of the canal evacuation system 404. In the exemplary embodiment shown, the vacuum hood 410 may have a roughly bell-shaped housing 412 and may be concentric with a portion of the canal evacuation system 404. In the exemplary embodiment shown, a portion of the canal evacuation system 404 extends coaxially from within the bell-shaped vacuum hood 410.

The irrigant system 402 further includes a flexible tube 414 that defines at least one vacuum passage 416. The flexible tube 414 may fluidly couple the bell-shaped housing 412 with the handpiece 406. The clinician may then move the vacuum hood 410 to within the patient's mouth with one hand while retaining the handpiece 406 externally with the other hand. Vacuum and fluids may pass in each direction between the bell-shaped housing 412 and the handpiece 406. The vacuum passage 416 may couple a vacuum source at 420 to the vacuum hood 410. During use, the clinician may position the vacuum hood 410 around the crown of the tooth and may even rest the vacuum hood 410 on the tooth to evacuate any fluids that would otherwise escape into the patient's mouth during endodontic therapy.

The irrigant system 402 may further include a fluid delivery tube 422 generally directed in the same direction as the longitudinal axis of the canal evacuation system 404. With reference to FIGS. 12A and 12C, the fluid delivery tube 422 may be fluidly coupled via at least one tube (not shown), which may be internal to the flexible tube 414, to an irrigant source 430 in the handpiece 406. The handpiece 406 may further include one or more buttons 432, 434 operably coupled to a corresponding chamber 436, 438. Chambers 436, 438 may be prefilled with a selected irrigant for use during endodontic therapy and be pneumatically coupled to compressed air or other energy source, as is indicated by arrows 442 in FIG. 12C. Buttons 432, 434 may activate the compressed air or other energy source to eject the selected irrigant from the corresponding chamber 436, 438. The clinician may then selectively flow an irrigant from a corresponding chamber 436, 438 through the fluid delivery tube 422 into a cavity within a tooth similar to that described above with regard to FIG. 9. It will be appreciated that any overflow of the irrigant from the cavity may be captured by the vacuum hood 410 and removed from proximate the tooth according to arrow 428 in FIG. 12B.

In one embodiment, and with reference to FIGS. 12A and 12B, the canal evacuation system 404 includes a cannula 440 selectively coupled within the vacuum hood 410 at a tubular joint 446. The cannula 440 extends through the opening defined by the vacuum hood 410 and has a rim 444 defining an opening. The canal evacuation system 404 may be coupled to the external vacuum source 420. As such, vacuum may be routed to the opening at the rim 444 of the cannula 440. Evacuation of debris and irrigant through the rim 444 (as indicated by arrow 452) and into the cannula 440 may be similar to that described above with respect to the cannula 70 in FIG. 4A.

With reference to FIG. 12A, the canal evacuation system 404 includes a cannula 448 that is interchangeable with the cannula 440 at the tubular joint 446. That is, the clinician may disconnect the cannula 440 and then insert the cannula 448 at the tubular joint 446. The cannula 448 may terminate at a closed end 450. The end 450 may be closed and rounded similar to that described above with regard to the end 84 of the cannula 72. A plurality of openings 114 may be proximate the end 450. Vacuum from the vacuum source 420 may be routed to the openings 114 of the cannula 448. The end 450 of the cannula 448 may have any of the configurations disclosed, for example, and FIGS. 4C-4D.

The relative size between the cannula 440 and the cannula 448 may be similar to that between the cannula 70 and the cannula 72 shown above in FIG. 2. In this regard, the cannula 448 may be sized to fit within the cannula 440, though the cannulas 440 and 448 are not arranged concentrically and thus differ from the endodontic devices 10, 200, and 300 described above in that regard. The cannula 448 is sized to fit within the apical third of a root canal and may be inserted in the root canal all of the way to the apical foramen.

The endodontic device 400 may be used in a similar manner as that described above with respect to the endodontic device 10. In that regard, the endodontic device 400 may be positioned proximate a tooth that has been prepared for cleaning and disinfecting. The clinician may selectively introduce an irrigant into the tooth cavity via the fluid delivery tube 422. Any excess irrigant from the fluid delivery tube 422 may be evacuated away by the vacuum hood 410 to prevent overflowing to the patient's mouth. The clinician may then begin cleaning and disinfecting the root canal of the tooth with the cannula 440. Similar to that described above with regard to the cannula 70, the cannula 440 may be used to disinfect and clean approximately ⅔ of the root canal.

In that regard, and with reference to FIG. 12A, the clinician may insert the cannula 440 into a cavity within the patient's mouth. By virtue of the flexible tube 414, the clinician may retain the handpiece 406 at a location externally of the patient's mouth. The clinician may then activate an irrigant contained within chamber 436 and/or 438 by pressing a corresponding button 432 and/or 434. The selected irrigant(s) may then flow from the fluid delivery tube 422 into the pulp chamber of the tooth. Any overflow of the selected irrigant may be evacuated by the vacuum hood 410. Furthermore, the irrigant may be drawn toward the apex of the tooth by the negative apical pressure generated at the rim 444 of the cannula 440. Although not shown, the clinician may move the cannula 440 in a motion to move the rim 444 up and down in the canal. By this motion and arrangement, the irrigant and debris adjacent the rim 444 is evacuated through the cannula 440 and into the handpiece 406. The clinician may activate either or both of the irrigant chambers 436, 438 during cleaning and disinfecting. In this manner, multiple irrigants may be alternated during endodontic therapy.

Once the clinician is satisfied that the pulp chamber and root canal are sufficiently clean, the clinician may then remove the macrocannula 440 from the joint 446 and couple the microcannula 448 with the joint 446. The cannula 448 may then be inserted into the root canal to a position at which the end 450 is located proximate the apical foramen of the root canal, as is generally shown in FIG. 6A. The clinician may then selectively activate either or both of the chambers 436, 438 to introduce a selected irrigant via the irrigant system 402 to the tooth. Negative apical pressure at or near the apical foramen draws the selected irrigant introduced in the pulp chamber inferiorly along the root canal to the openings at or near the apical foramen. Once the root canal is thoroughly clean and dry, the clinician may then fill the root canal and restore the tooth as is known in the art.

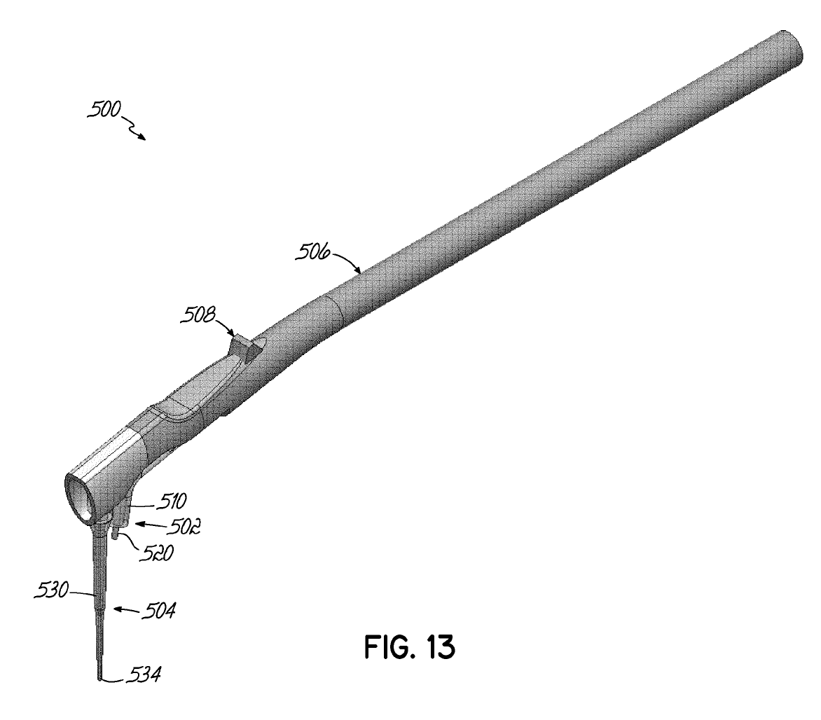

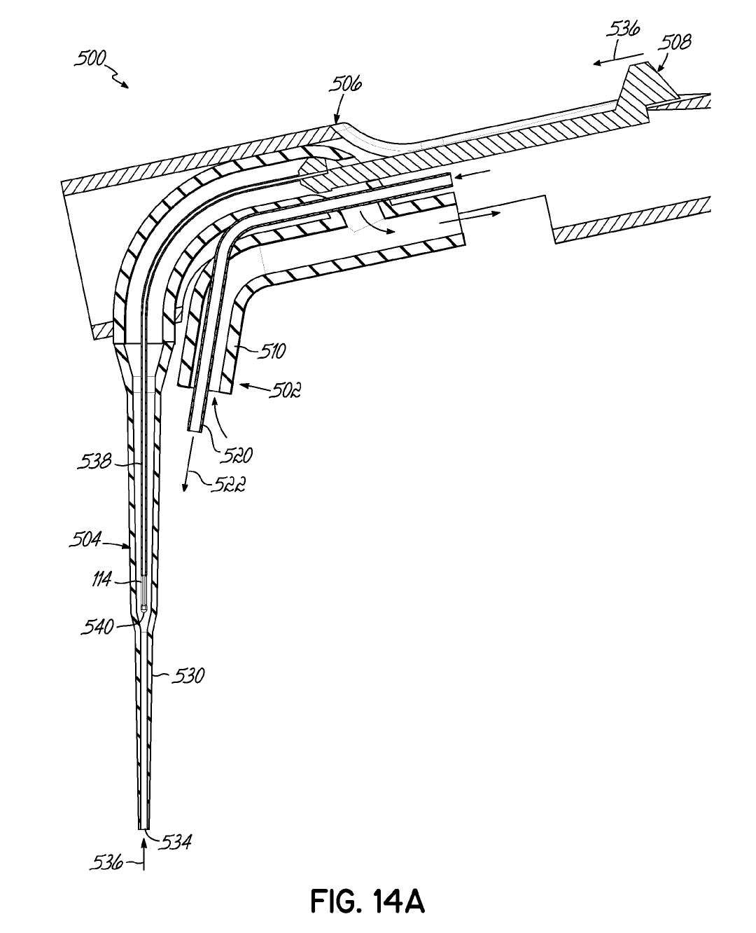

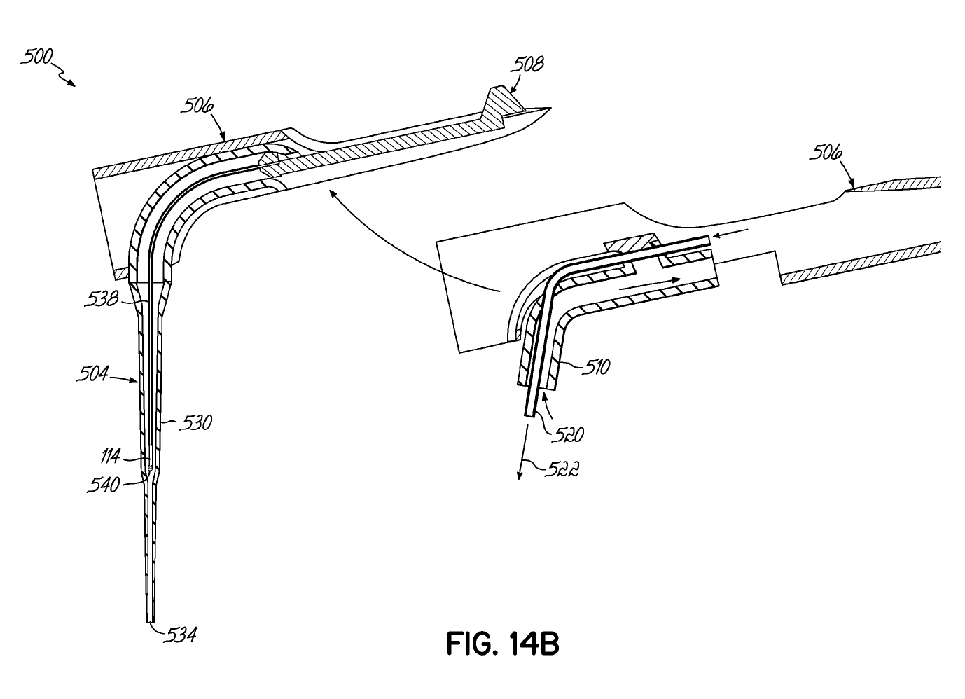

In another embodiment and with reference now to FIGS. 13, 14A, and 14B, an endodontic device 500 performs substantially the same function as the endodontic device 10, described above. Specifically, the endodontic device 500 may be utilized in endodontic therapy for cleaning and disinfecting a diseased tooth. To that end, the endodontic device 500 includes an irrigant system 502, a canal evacuation system 504, and a handpiece 506. Each of the irrigant system 502 and the canal evacuation system 504 may be at least partially contained within the handpiece 506 and extend therefrom for cooperative placement relative to a tooth (not shown). Each of the irrigant system 502 and the canal evacuation system 504 may perform substantially the same as the irrigant system 12 and the canal evacuation system 14 described above with reference to FIGS. 1-7B, respectively. As shown, the endodontic device 500 further includes an extension control system 508 housed within the handpiece 506. The extension control system 508 may be coupled to the canal evacuation system 504 so that the clinician may selectively move a portion of the canal evacuation system 504, as described below.

With reference now to FIGS. 13 and 14A, in one embodiment, the irrigant system 502 includes a vacuum tube 510 that extends from the handpiece 506 adjacent the canal evacuation system 504. This arrangement may be similar to the arrangement between the irrigant system 12 and the canal evacuation system 14 of the endodontic device 10 shown in FIG. 1 and described above. In the exemplary embodiment shown, the vacuum tube 510 may project from the handpiece 506. The vacuum tube 510 may be a flexible piece of tubing extending from the handpiece 506 and be coupled to a source of vacuum in the clinician's office. In this way, vacuum exists at the opening of the vacuum tube 510. During use, the clinician may position the vacuum tube 510 adjacent the crown of the tooth to evacuate any fluids that would otherwise escape into the patient's mouth during endodontic therapy.

The irrigant system 502 may further include a fluid delivery tube 520 extending from within the vacuum tube 510. As shown, the fluid delivery tube may penetrate the vacuum tube 510 within the handpiece 506 and so project from the interior of the vacuum tube 510 at a position external to the handpiece 506. As shown, the fluid delivery tube 520 may extend or project slightly beyond the opening of the vacuum tube 510 and so may be closer to the tooth when the endodontic device 500 is positioned proximate the tooth. Similar to the fluid delivery tube 60 described above with respect to FIGS. 1-4B, the fluid delivery tube 520 may be fluidly coupled to an irrigant source (not shown) external to the endodontic device 500. The clinician may then selectively flow an irrigant from the irrigant source through the fluid delivery tube 520 into a cavity within a tooth according to arrow 522 in FIG. 14A. It will be appreciated that any overflow of the irrigant from the cavity may be captured by the vacuum tube 510 and be removed from proximate the tooth.

In one embodiment, and with continued reference to FIGS. 13 and 14A, the canal evacuation system 504 includes a cannula 530 coupled to the handpiece 506. As described above, the cannula 530 extends generally perpendicularly from the handpiece 506 and has a rim 534 defining an opening. The canal evacuation system 504 may be coupled to an external source of vacuum in the clinician's office. As such, the source of vacuum may be routed to the opening at the rim 534 of the cannula 530. Evacuation of debris and irrigant through the rim 534 and into the cannula 530 according to arrow 536 may be similar to that described above with respect to cannula 70 in FIG. 4A.

The canal evacuation system 504 further includes a cannula 538 that may at least partially reside within the cannula 530. That is, all or a portion of the cannula 538 may be inside the cannula 530. The cannula 538 may terminate at an end 540 and be movable from within the cannula 530 with the extension control system 508. Although not shown, the end 540 may be closed and rounded similar to that described above with regard to the end 84 of the cannula 72. A plurality of openings 114 may be proximate the end 540. The vacuum from the vacuum source may be coupled to the openings 114 of the cannula 538. The end 540 of the cannula 538 may have any of the configurations disclosed, for example, in FIGS. 4C-4D.

The relative size and arrangement of the cannula 530 and the cannula 538 may be similar to the arrangement between the cannula 70 and the cannula 72 shown above in FIG. 2. In this regard, the cannula 538 is sized to fit within the cannula 530, and the cannulas 530 and 538 may be arranged concentrically with respect to one another. A telescope-like relationship may exist between cannula 530 and the cannula 538 in which the cannulas 530, 538 move relative to one another between retracted and extended positions.

With continued reference to FIGS. 13 and 14A, the clinician may operate the extension control system 508 according to arrow 536 in FIG. 14A to move the cannulas 530 and 538 relative to one another. In the exemplary embodiment shown, the cannula 538 is movable relative to the cannula 530 which is held in a fixed relation to the handpiece 506. The cannula 538 has a retracted position as shown in FIG. 14A and, although not shown, has an extended position similar to that shown in FIG. 4B. In these positions, the canal evacuation system 504 operates in a similar manner as the canal evacuation system 14 described above with respect to FIGS. 1-4B. In the retracted position shown in FIG. 14A, vacuum is produced at the rim 534 (indicated by arrow 536). Thus, irrigant and debris adjacent the rim 534 is evacuated through the cannula 530 and into the handpiece 506. In the extended position (not shown), the cannula 538 extends from the rim 534 and may seal at or in an overlapping region near the rim 534 so that vacuum is produced at the openings 114 (shown in FIG. 14A).

The cannula 538 is coupled to the extension control system 508. The clinician may therefore operate the extension control system 508 to move the cannula 538 through the cannula 530.

The endodontic device 500 may be used in a similar manner as that described above with respect to the endodontic device 10. The endodontic device 500 may be positioned proximate a tooth that has been prepared for cleaning and disinfecting. The clinician may introduce an irrigant into the tooth cavity via the fluid delivery tube 520. Any excess irrigant from the fluid delivery tube 520 may be evacuated away by the vacuum tube 510 to prevent the irrigant from overflowing into the patient's mouth. The clinician may then begin cleaning and disinfecting the root canal of the tooth with the cannula 530. Similar to that described above with regard to the cannula 70, the cannula 530 may be used to disinfect and clean approximately ⅔ of the root canal. It will be appreciated that the endodontic device 500 produces two sources of vacuum simultaneously in the tooth. One source of vacuum is at the crown of the tooth (i.e., at vacuum tube 510) and the other source of vacuum is in the root canal (i.e., at the rim 534). That leaves cleaning of the apical third of the root canal.

Once the upper two thirds portion of the root canal is sufficiently clean, the clinician may operate the extension control system 508 to extend the cannula 538 toward the apex of the tooth. Thus, the cannula 538 may be extended into a position similar to that shown for the cannula 72 shown in FIG. 6A. At this location, the cannula 538 may produce a negative apical pressure proximate the apical foramen. As a result, irrigant is drawn from the pulp chamber through the root canal to near the apical foramen where it is pulled into the cannula 538 via the openings 114. It will be appreciated that the endodontic device 500 produces two sources of vacuum when the cannula 538 is in the extended position. One source of vacuum is at the crown of the tooth (i.e., at vacuum tube 510) and the other source of vacuum is in the root canal near the apical foramen (i.e., at the openings 114). Once the entire root canal is thoroughly clean and dry, the clinician may then fill the root canal and restore the tooth as is known in the art.

With reference now to FIG. 14B, in one embodiment, the irrigant system 502 may be movable relative to the canal evacuation system 504. In the exemplary embodiment shown, the vacuum tube 510 and the fluid delivery tube 520 may be removably coupled via a snap fit or other connection to the handpiece 506. When disconnected, the tubes 510 and 520 remained tethered to the handpiece 506 by the tubes 510 and 520, which may each be flexible. Advantageously, this may improve placement of the fluid delivery tube 520 and the vacuum tube 510 relative to the tooth and the canal evacuation system 504 during endodontic therapy.

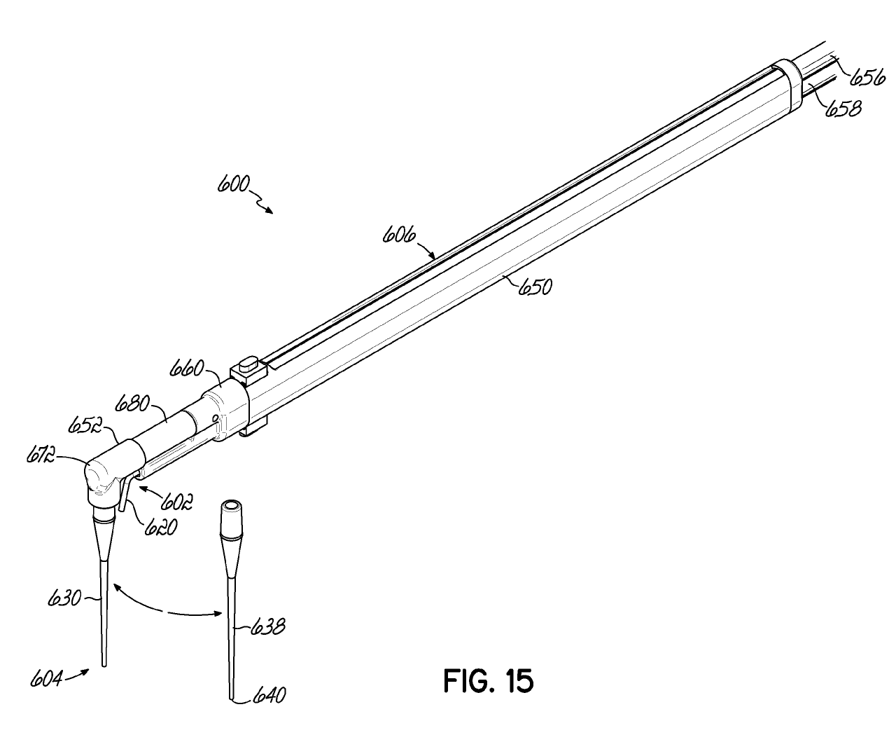

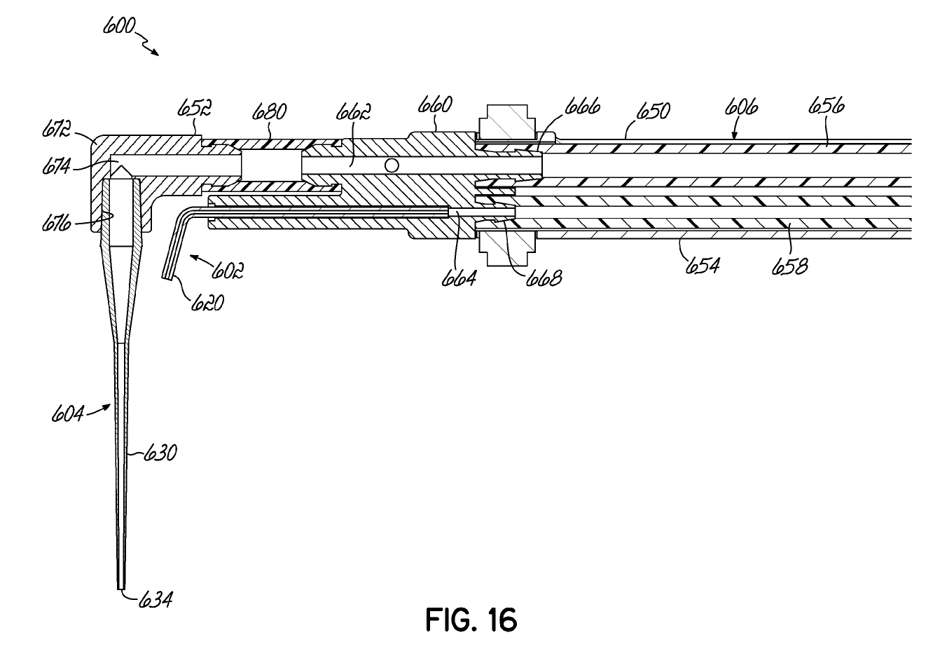

In another embodiment and with reference now to FIGS. 15 and 16, an endodontic device 600 performs substantially the same as the endodontic device 10, described above. Specifically, the endodontic device 600 may be utilized in endodontic therapy for cleaning and disinfecting a diseased tooth. To that end, the endodontic device 600 includes an irrigant system 602, a canal evacuation system 604, and a handpiece 606. Each of the irrigant system 602 and the canal evacuation system 604 may be at least partially contained within the handpiece 606 and extend therefrom for cooperative placement relative to a tooth (not shown). Each of the irrigant system 602 and the canal evacuation system 604 may perform substantially the same as any of the irrigant system and the canal evacuation system described herein.

With reference now to FIGS. 15 and 16, in one embodiment, the irrigant system 602 includes a fluid delivery tube 620 extending from the handpiece 606. Similar to the fluid delivery tube 60 described above with respect to FIGS. 1-4B, the fluid delivery tube 620 may be fluidly coupled to an irrigant source (see, e.g., FIG. 33) external to the endodontic device 600. The clinician may then selectively flow an irrigant from the irrigant source through the fluid delivery tube 620 into a cavity within a tooth. In the embodiment shown, the irrigant system 602 is not equipped with a vacuum tube. Thus, the endodontic device 600 produces a single source of vacuum at the tooth, that is, in the root canal.

In one embodiment, and with continued reference to FIGS. 15 and 16, the canal evacuation system 604 includes a cannula 630 coupled to the handpiece 606. As described above, the cannula 630 extends generally perpendicularly from the handpiece 606 and has a rim 634 defining an opening. The canal evacuation system 604 may be coupled to an external source of vacuum in the clinician's office. As such, the source of vacuum may be routed to the opening at the rim 634 of the cannula 630. Evacuation of debris and irrigant through the rim 634 and into the cannula 630 may be similar to that described above with respect to cannula 70 in FIG. 4A.

The canal evacuation system 604 further includes a cannula 638 that may be interchangeably coupled to the handpiece 606 in place of the cannula 630. The cannula 638 may terminate at an end 640. Although not shown, the end 640 may be closed and rounded similar to that described above with regard to the end 84 of the cannula 72. A plurality of openings 114 may be proximate the end 640. The vacuum from the vacuum source may be coupled to the openings 114 of the cannula 638. The end 640 of the cannula 638 may have any of the configurations disclosed, for example, in FIGS. 4C-4D.

The dimensions of the cannula 630 and the cannula 638 may be similar to the dimensions of the cannula 70 and the cannula 72, respectively, shown above in FIG. 2. In this regard, although the cannula 638 may be sized to fit within the cannula 630, the cannulas 630, 638 are used interchangeably with the handpiece 606. The cannulas 630 and 638 may be disposable components of the endodontic device 600.

With continued reference to FIGS. 15 and 16, the handpiece 606 may be generally of two-part construction of an elongate member 650 coupled to an end effector 652. With reference to FIG. 16, in one embodiment, the elongate member 650 includes a housing 654 having a plurality of tubes 656 and 658 contained therein. The tube 656 may be coupled to a source of vacuum (not shown) in the clinician's office at one end thereof and route vacuum to the cannula 630 or the cannula 638. The tube 658 may be coupled to a source of irrigant (not shown) and supply a selected irrigant to the tooth via the fluid delivery tube 620.

The end effector 652 may include a main body portion 660 having a vacuum passage 662 and a fluid delivery passage 664 therein. The vacuum passage 662 is at least partially defined by a fitting 666 to which the vacuum tube 656 is coupled. Similarly, fluid delivery passage 664 is at least partially defined by a fitting 668 to which the fluid delivery tube 658 is coupled. The fluid delivery tube 620 may be housed within the main body portion 660 in fluid communication with the fluid delivery passage 664.

The end effector 652 may further include an end piece 672 that defines a passage 674 ending in a port 676. The end piece 672 is coupled to the main body portion 660 and routes vacuum therefrom to the cannula 630 or the cannula 638. In particular, either cannula 630, 638 is received within the port 676 and is in fluid communication with the passage 674 for routing vacuum to the cannula 630, 638 from the vacuum source. In the exemplary embodiment shown, the main body portion 660 further includes a sight tube 680 that couples the end piece 672 to the main body portion 660. It will be appreciated that the clinician may visually ascertain the functioning of the cannula 630 or the cannula 638 by observing fluid extracted from the tooth as it passes through the sight tube 680.

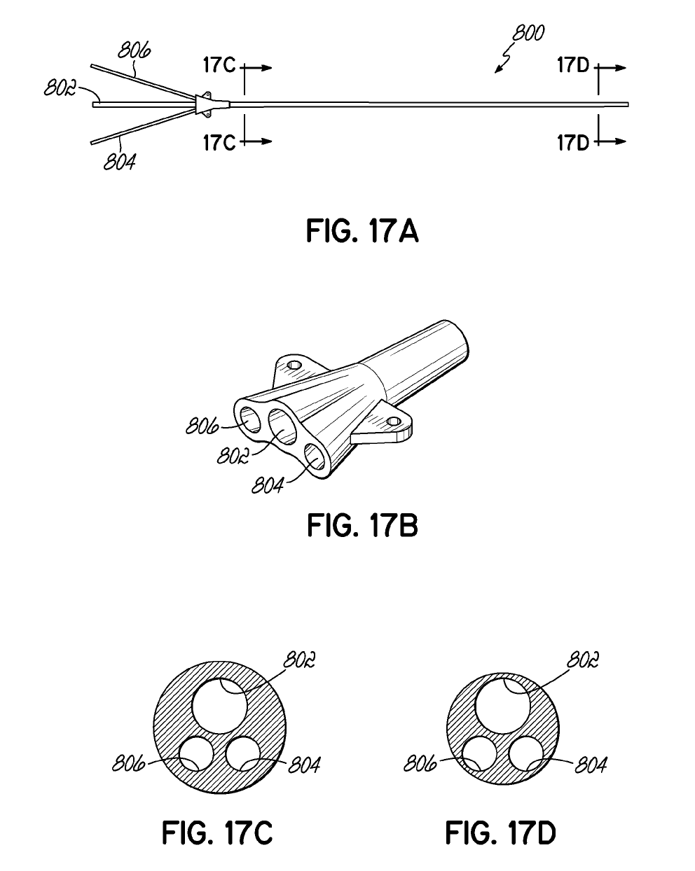

With reference to FIGS. 1 and 17A-17D, in one embodiment, the device 10 may include the fluid delivery line 44 for transporting irrigants to the handpiece 16, as is described above. The device 10 is not limited to the fluid delivery line 44 but may include multiple tubes for delivering multiple irrigants to the handpiece 16. With reference to FIGS. 17A-17D, a multi-lumen tube 800 may fluidly couple the handpiece 16 to an equal number of different fluids. In particular, the clinician may then select one fluid from multiple available fluids for dispensing from the fluid delivery tube 60. As is described below, a fluid delivery system may provide a source of multiple fluids for use by the clinician. As is shown in FIGS. 17A-17D, the multi-lumen tube 800 may include three separate lumens 802, 804, 806. The lumens 802, 804, and 806 may be the same or different dimensions. By selecting the size of the lumen 802, 804, 806, the clinician may more effectively regulate fluid flow and velocity. When coupled with a user selectable push button system, the clinician may select a fluid for delivery through the multi-lumen tube 800. A tube clamping system (not shown) may clamp the multi-lumen tube 800 to prevent flow of fluid through the tube 800. The clamping system may be selectively engaged with one or more of the lumens 802, 804, 806. For example, the tube clamping system may selectively engage one or more of the lumens to block flow through the lumen while allowing a selected fluid to flow through one lumen.

In addition or alternatively, the multi-lumen tube 800 may flow a selected fluid through one of the lumens 802, 804, 806 while the used fluid may be evacuated through another of the lumens 802, 804, 806. That is, the tube 800 may provide for bi-directional use of the fluid being delivered to the handpiece 16 and the fluid being evacuated from the root canal.

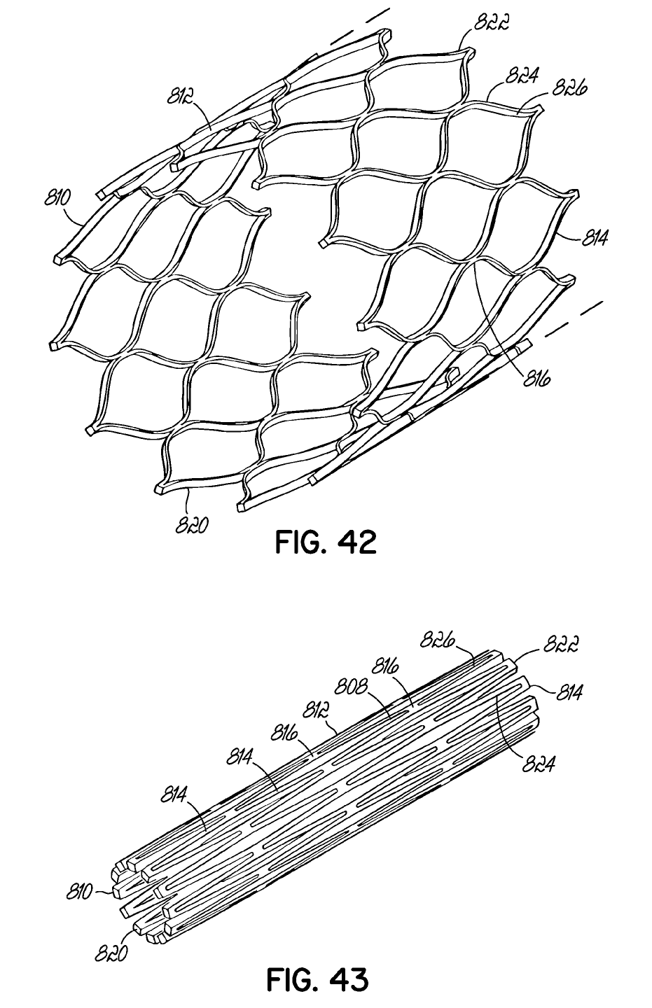

In one embodiment, any single one of the endodontic devices described herein may be utilized to irrigate while simultaneously applying vacuum along the depth of the root canal in combination with shaping of the root canal. Irrigant may be delivered during use of an abrasive tip (not shown). The abrasive tip may be hollow and capable of distributing vacuum along the depth of the root canal during suctioning. For example, such a tip may essentially be a macrocannula or a microcannula as is described herein with an abrasive outer layer or other cutting points along the outside surface. By way of example, a hollow NiTi or stainless steel file may be used that is capable of rotating (e.g., small reciprocating motion or slow low-torque rotation) vibrating, and/or vertical movement while in the root canal. The file may be configured as a interconnected network of metal beams manufactured by cutting out sections of a metal sheet, as is described with reference to FIGS. 42 and 43. This configuration may be similar to a Self Adjusting File (SAF), which has a cage-like structure capable of localized expansion and contraction to self-adjust to the variable shape of the root canal. A SAF or similar tool may have an adaptive diameter. SAFs may be commercially available from ReDent Nova. A similar tool may include a net of NiTi to which abrasive is attached. The net may expand and contract to conform to the shape of the root canal in a similar manner as a SAF. With either tool, irrigant may be dispensed and evacuated as described herein.

By way of example and with reference to FIGS. 42 and 43, in one embodiment, a cannula 812 having an adaptive diameter similar to that described above is shown. The cannula 812 or a portion thereof may include a series of interconnected curved beams 814 with adjacent beams 814 meeting at merge sections 816 and so are formed into a pyramid or a cylinder 810 (as shown). The beams 814 include a curved segment 824 and are formed with an inflection point 826 between merge sections 816. The beams 814 may be formed by removing intermediate portions of a sheet of material. This interconnected beam structure 808 is capable of expanding (FIG. 42) and contracting (FIG. 43) in diameter and may be coupled at a forward end 820 or rear end 822 to an end of a cannula for use during endodontic therapy.

To facilitate both expansion and contraction, the beams 814 may have a cross-section which is greater in the radial direction (i.e. thickness) than in the circumferential direction (i.e. width). The beams 814 are generally continuously curved to reduce or minimize stress concentration in the structure 808. The beams 814 straighten (i.e., the curved sections 824 flatten) during compression until they are nearly straight, as is shown in FIG. 43, in which adjacent beams 814 may contact one another.

While compressed, the thickness of the beams 814 prevents overlap. In a tightly packed or contracted configuration, the curved sections 824 straightened out, come together, and generally lie flat in close proximity to each other. In one embodiment, the sections 824 touch. The beams 814 resist overlap because the thickness of each beam 814 require substantial radial displacement to move over or under adjacent the beam 814. While expanded and during expansion, the thickness of the beams 814 and the configuration of the beams increase the strength of the cannula 812 and reduce or minimize stress concentrations in the cannula 812. This structure may be connected to and form the tip any of the cannulas described herein. Embodiments of the invention are not limited to the exemplary embodiment shown in FIGS. 42 and 43 as other expandable and collapsible structure may be incorporated into or form a cannula. Therefore, any one of those structures may incorporate or be coated with abrasive particles such that during endodontic therapy the structure may expand and conform to the root canal to remove a portion thereof while simultaneously evacuating debris and fluid from the canal.

With these tools, rotating, vibrating, and/or reciprocating motions may be mechanically generated within or external to a handpiece, described above. By way of example, reciprocating motion of either one or both of the cannulas in the root canal may be generated by pulsing the vacuum within the cannula and may produce turbulence and shear waves within or vibration of the fluid adjacent the cannula. The slight perturbations of vacuum may produce movement of the cannula and thus relative movement between the tooth and the cannula.

The clinician may then shape the root canal while simultaneously flushing irrigant through the root canal and evacuating the irrigant and debris. The debris being evacuated from the root canal may be monitored in real time or close to real time (i.e., monitoring with a slight delay of a few seconds). In one embodiment, the evacuated debris and fluid may be analyzed in situ via the Root Canal Debridement Effectiveness Device and Method described in U.S. Patent Application No. 62/341,822, filed on May 26, 2016 and incorporated by reference herein in its entirety. Root canal cleanliness may be related to the quantity and/or type of debris evacuated. Thus, by monitoring the debris in real time, one of the endodontic devices or systems disclosed herein may be capable of notifying the clinician that the root canal is sufficiently clean. This may be when the debris is reduced to a predetermined level or when debris of a specific type is no longer present in a detectable quantity.

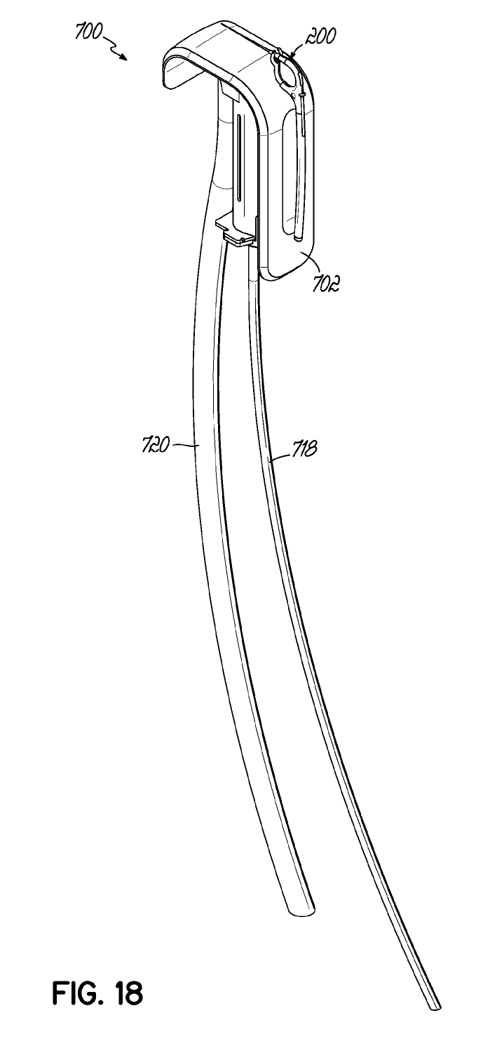

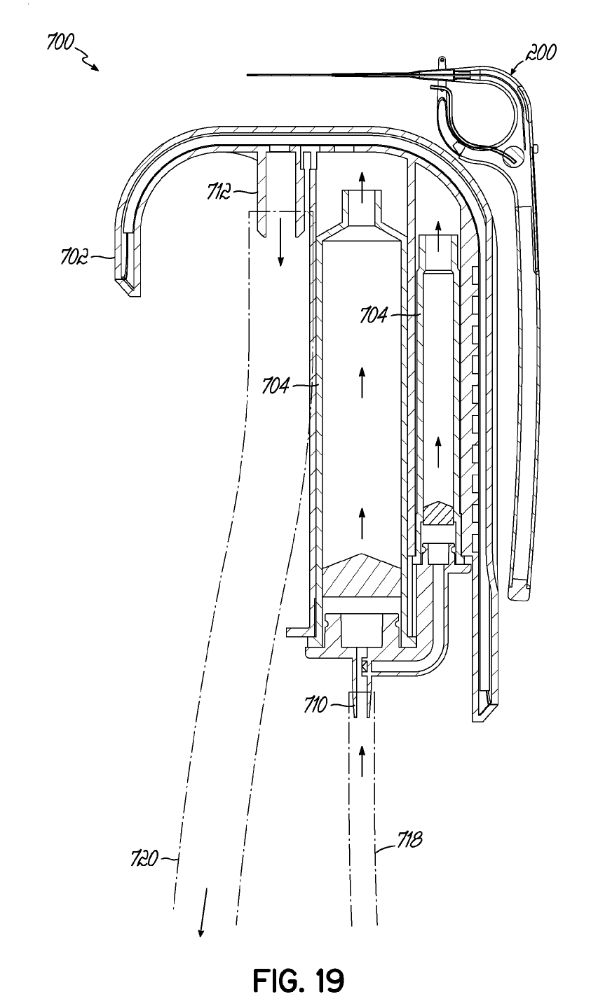

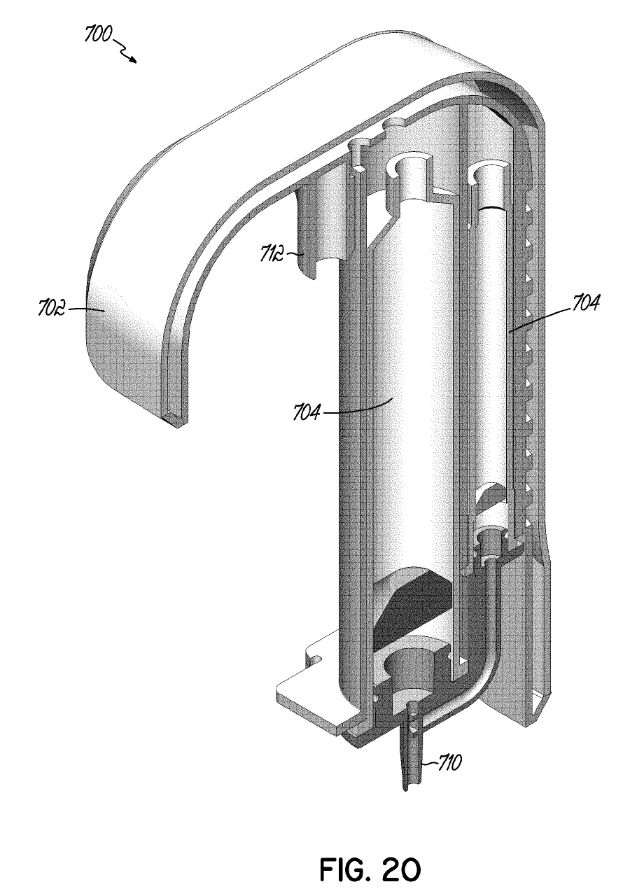

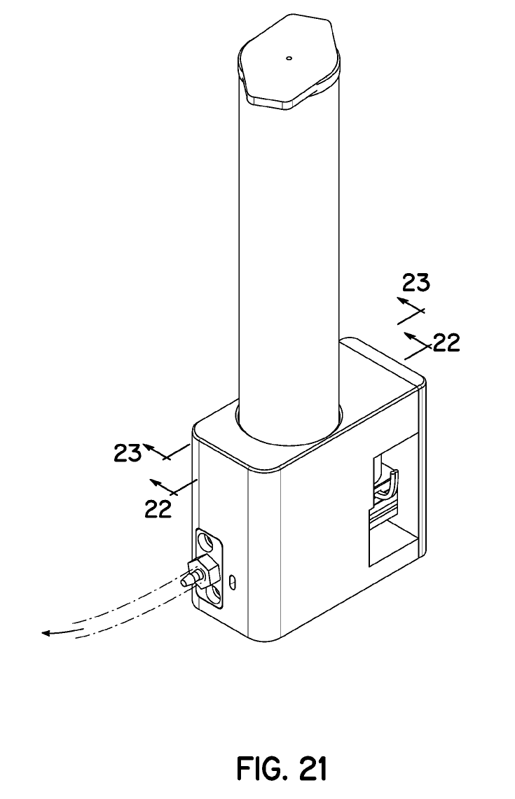

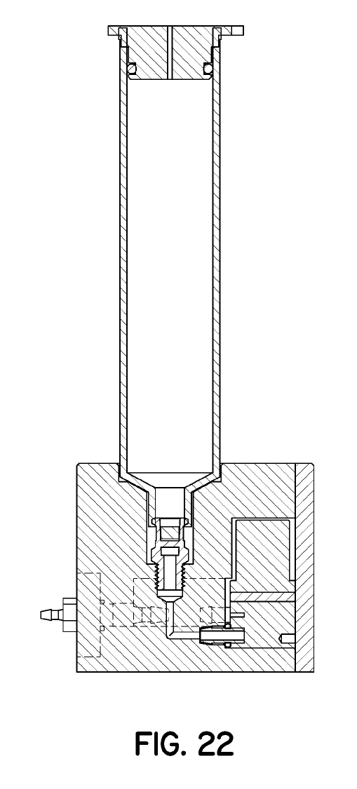

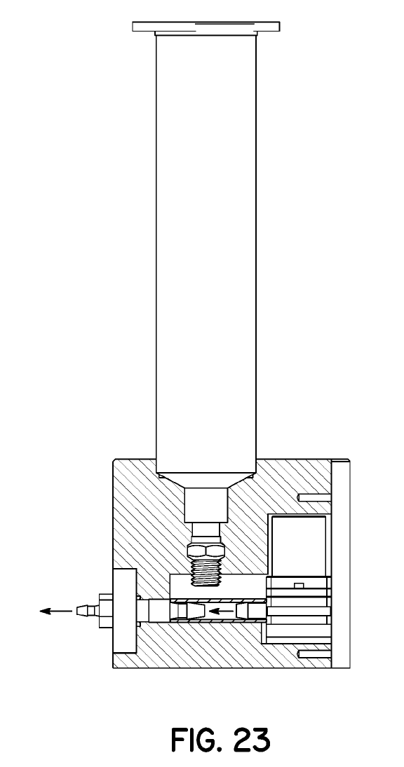

In another aspect of the present invention and with reference now to FIGS. 18-23, in one embodiment, the endodontic device 200 may be operably coupled to a fluid delivery system 700. While the endodontic device 200 is depicted, it will be appreciated that any of the endodontic devices described herein may be coupled to a fluid delivery system 700. The fluid delivery system 700 supplies irrigants used during endodontic therapy. That is, the clinician may selectively supply an irrigant from the fluid delivery system 700 to the corresponding endodontic device. The fluid delivery system 700 while being operably coupled to the endodontic device is separate from the device but may be in the vicinity of the patient. As described above, one or more irrigants may be utilized during endodontic therapy. Typical irrigants may include sodium hypochlorite (NaOCl) and Ethylenediaminetetraacetic acid (EDTA), though other fluids may alternatively or additionally be utilized.

The fluid delivery system 700 may include a frame 702, which may have a generally J-shaped configuration and may define a plurality of fluid chambers 704. In the exemplary embodiment, the fluid delivery system 700 includes two chambers 704. One chamber 704 may be prefilled with NaOCl and the other chamber 704 may be filled with EDTA. The frame 702 further defines an inlet port 710 and an outlet port 712. The inlet port 710 may be coupled via a tube 718 to pressurized air available in the clinician's office. The outlet port 712 is downstream of each of the chambers 704. Although not shown being coupled together, a tube 720 may fluidly couple the outlet port 712 to the endodontic device 200 and so fluidly couple the chambers 704 to the endodontic device 200.

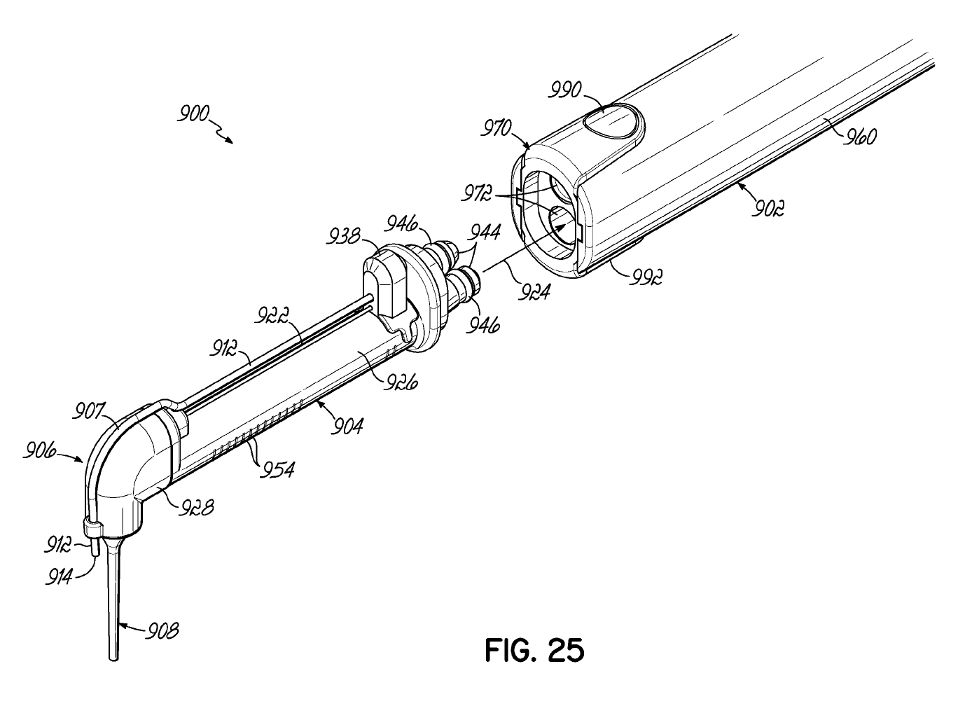

With reference to FIGS. 24-27, in which like reference numerals refer to like features throughout the figures, in one embodiment, the endodontic device 900 is separable into two components. One component may be reusable and the other component that directly contacts the patient during use of the device 900 may be disposable. In this way, the clinician need not be concerned with disinfecting the portion of the device 900 most likely to be contaminated with biological fluids. Rather, that portion is thrown away following an endodontic procedure. In the exemplary embodiment shown, the endodontic device 900 includes a handpiece 902 and an end effector 904 shown assembled in FIG. 24 and disassembled in FIG. 25. Each of the handpiece 902 and the end effector 904 is described in detail below. Consistent with the above, the end effector 904 may be a consumable that is thrown away following a single endodontic procedure.

In general, similar to the endodontic devices above, the endodontic device 900 includes an irrigant system 906 and a canal evacuation system 908 each of which may be at least partially housed within each of the handpiece 902 and the end effector 904. The irrigant system 906 and the canal evacuation system 908 extend beyond the end effector 904 and so are insertable into a prepared tooth as is described above.

While being similar in some ways, the endodontic device 900 differs from the endodontic devices above in other ways. However, each of the irrigant system 906 and the canal evacuation system 908 may perform substantially the same function as any of the irrigant system and the canal evacuation system described herein.

By way of comparison, the irrigant system 906 is oriented differently than the irrigant system 602 of the endodontic device 600 shown in FIG. 16. In particular, the irrigant system 906 includes a fluid delivery tube 912 on the upper side of the end effector 904 rather than being positioned underneath the handpiece 606 as is shown, for example, in FIG. 15. The fluid delivery tube 912 terminates at an end 914 at a location furthest from the clinician or forms the furthest-most projection from the end effector 904. Advantageously, when activated, fluid may be more easily observed to be dispensed from the end 914 and aimed toward the opening 22 of the tooth 20 (FIG. 5A). Similar to the irrigant systems described herein, the irrigant system 906 includes a source of vacuum (described below) in or projecting from the handpiece 902 and end effector 904 so that it is positioned proximate the opening 22 of the tooth 20 during an endodontic procedure.

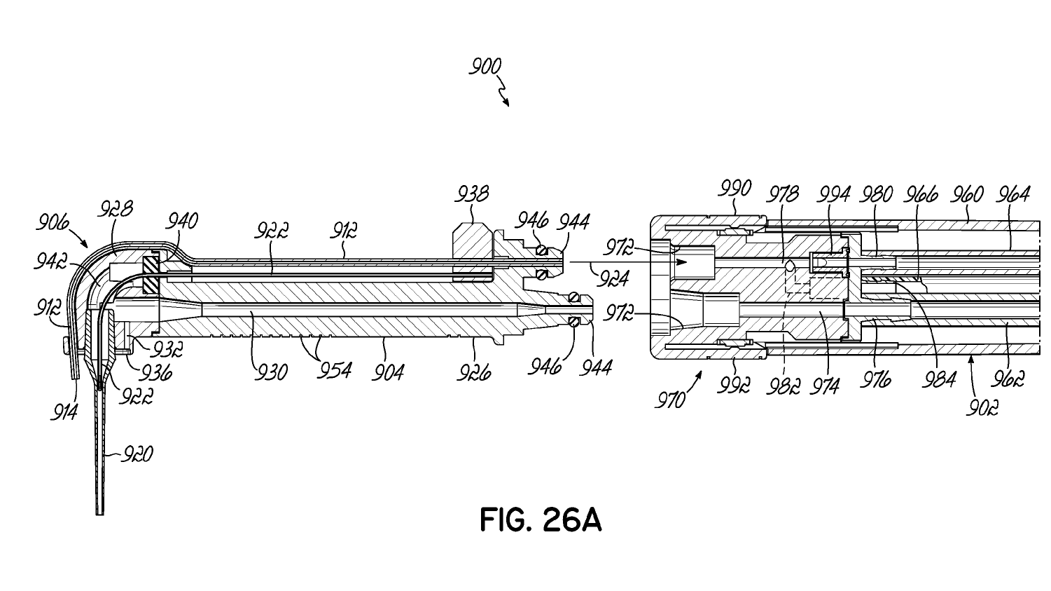

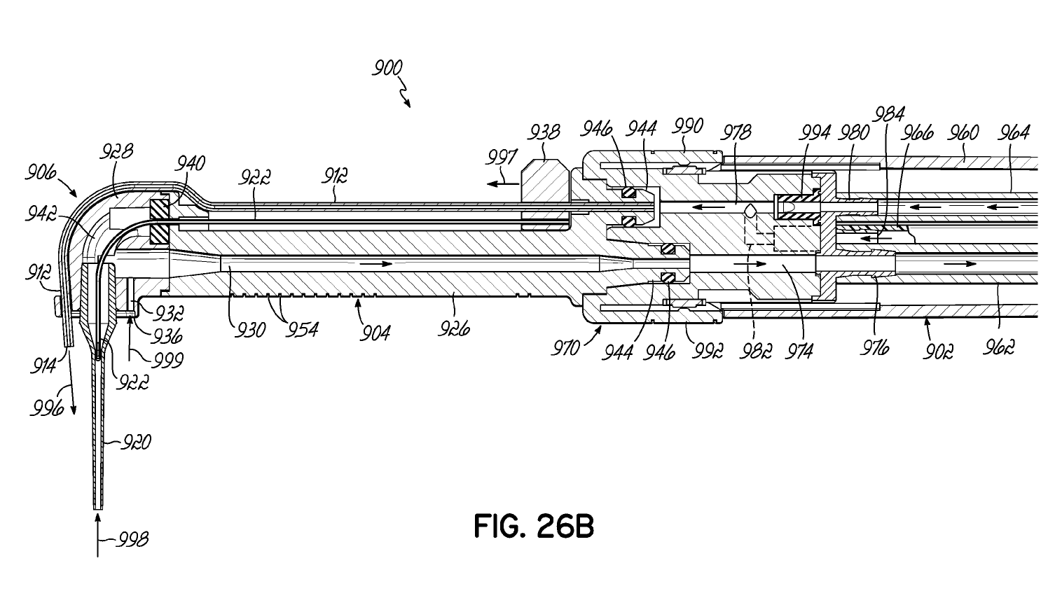

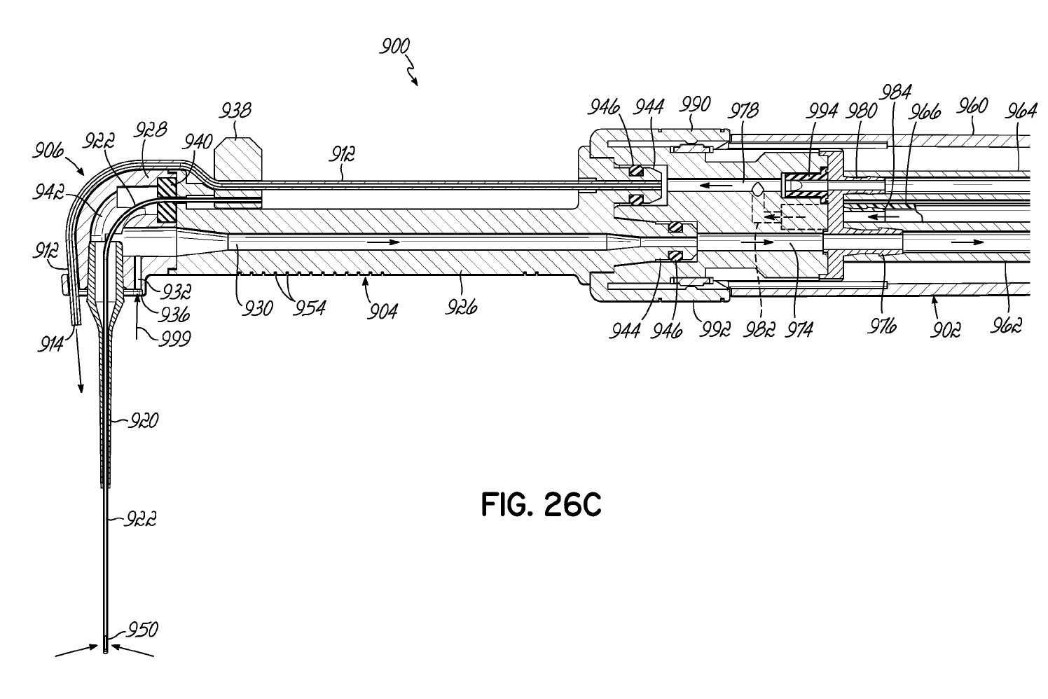

The canal evacuation system 908 includes two cannulas 920, 922 of different sizes. In that regard, the cannulas 920, 922 may be positioned and movable relative to one another similar to cannulas 70, 72 described above with reference, for example, to FIGS. 1-4B. As is shown by comparison of FIG. 24 with FIG. 25, the cannula 922 is movable from within the cannula 920 between an extended position (FIG. 24) and a retracted position (FIG. 25). In the extended position, the cannula 922 is insertable into a tooth in a manner similar to the cannula 72 to disinfect and clean the apical third of a root canal. And, when the cannula 922 is retracted to a position within the cannula 920 (FIGS. 25 and 26A), the cannula 920 is insertable into a tooth in a manner similar to the cannula 70 to disinfect and clean the upper ⅔ of the root canal.

With reference now to FIG. 25, the end effector 904 may be selectively attached to, and releasable from, the handpiece 902, for example, according to arrow 924. Each of the end effector 904 and the handpiece 902 may be secured together at a joint such that both vacuum and irrigant may travel between them without leakage. That is, the joint is fluid tight. In that regard, and with reference to FIGS. 25 and 26A, the end effector 904 includes a main body 926 coupled to a cap portion 928. A longitudinal bore 930 extends through the main body 926 and is fluidly coupled to one or more ports 932 in the cap portion 928. The ports 932 may extend generally perpendicularly to the longitudinal bore 930 and be exposed through a vacuum hood 936 surrounding each of the cannulas 920, 922. The vacuum hood 936 and ports 932 may be positioned adjacent a crown of a tooth during an endodontic procedure so as to evacuate fluid from the tooth and thereby prevent overflow of the fluid into the patient's mouth. The cannula 920 may be secured to the cap portion 928 and be open to the longitudinal bore 930. While the end effector 904 is described with reference to two components, i.e., a main body 926 and a cap portion 928, embodiments of the invention are not limited to any specific number of components.

As is described above, the cannula 922 is movable within the end effector 904 and, to that end, is coupled to a slider 938. With reference to FIG. 26A, the cap portion 928 includes a secondary bore 942 that is open to the longitudinal bore 930. A seal 940 caps the secondary bore 942 at one end generally opposite the cannula 920. The cannula 922 is capable of sliding through the seal 940 during use of the device 900. In that regard, the slider 938 is operable by the clinician to move the cannula 922 relative to the main body 926 through the seal 940. In one embodiment, the slider 938 slides on the fluid delivery tube 912.

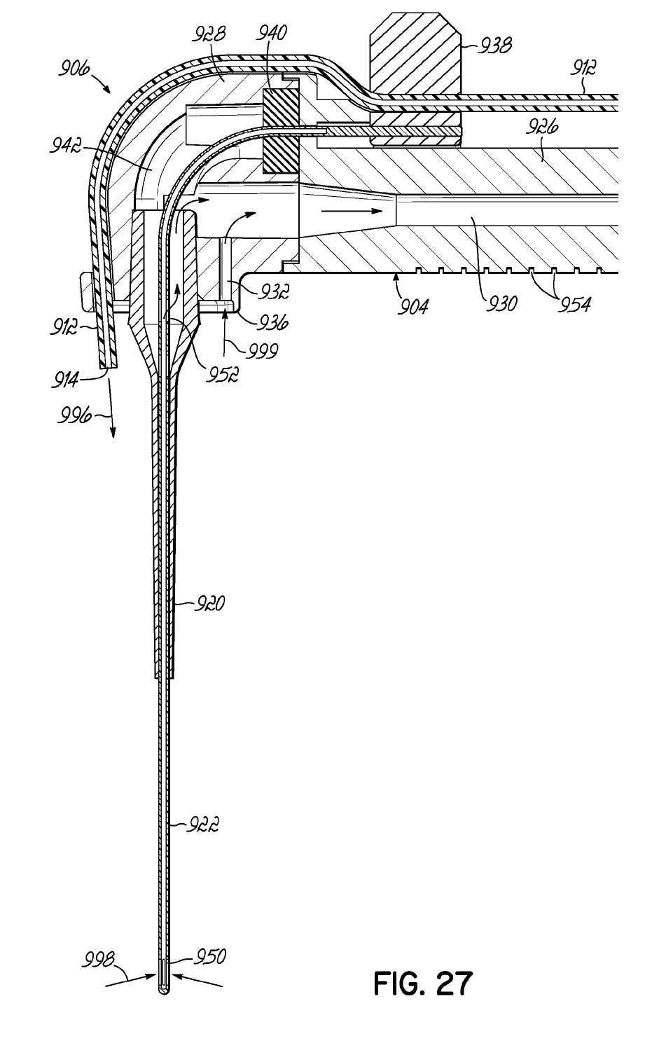

The main body 926 may include indicia, such as a series of graduation marks 954, by which the clinician may adjust the position of the slider 938 to position the cannula 922 at a specific location within the tooth 20. That is, any particular extended length of the cannula 922, for example, beyond the cannula 920, may be determined by observing the location of the slider 938 relative to the graduation marks 954. As shown best in FIG. 27, the cannula 922 includes openings 950 at one end, similar to the openings 114 described above in conjunction with FIGS. 4C-4E, and also includes one or more mid-exit holes 952 at a location in which the mid-exit holes 952 are open to the longitudinal bore 930 when the cannula 922 is extended for use, as is shown in FIG. 27. The mid-exit hole 952 may be at least about 10 mm from the closed end of the cannula 922. In one embodiment, a single mid-exit hole 952 may be have a greater open area than any single one of the openings 114.

As described above, the end effector 904 is removably attachable to the handpiece 902. In that regard, the main body 926 includes one or more projections 944 each of which cooperate with recesses, described below, on the handpiece 902. As shown, each of the projections 944 may be a conical projection through which one of the longitudinal bore 930 or the fluid delivery tube 912 extends for fluid engagement with the handpiece 902. Each projection 944 may include an o-ring 946 to seal against the handpiece 902 to prevent leakage of irrigant and vacuum from the device 900.

In one embodiment, the handpiece 902 includes a housing 960, in which one or more tubes run longitudinally nearly the length of the handpiece 902, and may extend from one end thereof (as is shown in FIG. 24) to be connected to a fluid delivery system, described herein, and a vacuum source (shown, for example, in FIG. 32). As shown in FIG. 26A, the housing 960 includes three tubes, a first tube 962 for vacuum, a second tube 964 for a first fluid, and a third tube 966 for a second fluid. Although not shown in FIG. 26A, the housing 960 may include yet another tube for a third fluid. The handpiece 902 may include a manifold 970 at one end that includes one or more recesses 972. The recesses 972 receive the projections 944 on the end effector 904 during assembly of the device 900. By the manifold 970, the clinician may direct delivery of at least one of the first fluid, the second fluid, and the third fluid from the end effector 904.

To that end, in one embodiment and with reference to FIGS. 26A and 26B, the manifold 970 includes a first bore 974 that extends longitudinally through a first hose barb 976. The first tube 962 is coupled to the first hose barb 976 so that vacuum may be transmitted through the tube 962 and through the manifold 970 to the end effector 904. Similarly, a second bore 978 in the manifold 970 extends longitudinally through a second hose barb 980. The second tube 964 is coupled to the second hose barb 980 so that a fluid may be delivered through the tube 964 and through the manifold 970. A third bore 982 (shown in phantom line) intersects the second bore 978 within the manifold 970 and extends through a third hose barb 984. The third tube 966 is coupled to the third hose barb 984 so that a fluid may be delivered through the tube 966 and through the manifold 970 via the second bore 978. By this arrangement, the first and second fluids are delivered from the manifold 970 to the end effector 904 via the second bore 978. Although not shown, the manifold 970 may include other bores that intersect the second bore 978. Each of these other bores may be fluidly coupled to a tube which is in turn coupled to a source of fluid. That is, multiple fluids may at least partially share the same pathway in the manifold 970, i.e., through the second bore 978, to the end effector 904 to be dispensed from the fluid delivery tube 912. The clinician may select which of the multiple fluids is to flow through the manifold 970 to be dispensed to a tooth.

In that regard, and with reference to FIGS. 24-26A and 32, the manifold 970 includes button mechanisms 990, 992 and valves 994 that separate each of the tubes 964, 966 from their corresponding bores 978, 982. The clinician may press one of the button mechanisms 990, 992 to turn on or off the fluid flow. This may include pressing one button mechanism to turn a supply pump on to supply fluid to the handpiece 902 and pressing the other button mechanism to turn the supply pump off.

The endodontic device 900 operates in a similar manner as the other endodontic devices described herein. In particular, and with reference to FIG. 26B, once the handpiece 902 is assembled with the end effector 904, the cannula 920 may be inserted into an opening in a tooth (for example, in a manner similar to that shown in FIG. 5A). The cannula 922 is in its retracted position in which the vacuum is pulled through the cannula 920. In essence, the cannula 922 does not interfere or participate in the initial evacuation through the cannula 920.

Once the cannula 920 is inserted into a tooth, the clinician may press one of the button mechanisms 990, 992 to turn fluid flow on for delivery through the fluid delivery tube 912. As shown, fluid exits the end 914 of the fluid delivery tube 912 according to arrow 996 in FIG. 26B. When active, vacuum at the tip of the cannula 920 may evacuate fluid through the cannula 920 according to arrow 998 and through the longitudinal bore 930 of the end effector 904. That fluid may then be drawn through each of the bore 974 and tube 962 of the handpiece 902 towards a source of vacuum. At the same time, fluid may be withdrawn from near the crown of the tooth through the vacuum hood 936 at the ports 932 according to arrow 999. In accordance with other embodiments of the endodontic device, the device 900 provides two locations at which to evacuate fluid from the tooth, one at the tip of the cannula 920 or cannula 922 and the other at the vacuum hood 936. At any point, the clinician may alternate between two or more fluids as described below.

Once initial evacuation through the cannula 920 is complete, the clinician may extend the cannula 922 from within the cannula 920. The clinician may then selectively extend the cannula 922 from within the cannula 920 to a position shown in FIG. 26C in which the openings 950 are outside of the cannula 920 and are exposed for evacuating fluid and debris from within a root canal. The clinician may slide the slider 938 in the direction indicated by arrow 997 in FIG. 26B to a predetermined location according to the graduation marks 954. In this way, and with reference to FIG. 26C in which the slider 938 is shown in its forward-most position with the cannula 922 being fully extended, the clinician may position the openings 950 of the cannula 922 at a predetermined depth within a root canal.

When active, and with reference to FIGS. 26C and 27, vacuum at the openings 950 pulls the fluid and debris proximate the openings 950 into the cannula 922, which may be referred to as a microcannula herein and is described above. The evacuated fluid and debris pass through the longitudinal bore 930 and out of the handpiece 902 in a manner similar to that described above with regard debris and fluid evacuated through the cannula 920. Further in that regard, vacuum passes within the cannula 922 and out of the mid-exit holes 952 shown best in FIG. 27. When extended, the cannula 920 and the cannula 922 may form a vacuum seal in a region of their overlap. Another seal is formed between the cannula 922 and the seal 940, which seals a secondary bore 942 from the external environment. Thus, vacuum within the longitudinal bore 930 is transmitted via the mid-exit holes 952 to the openings 950.

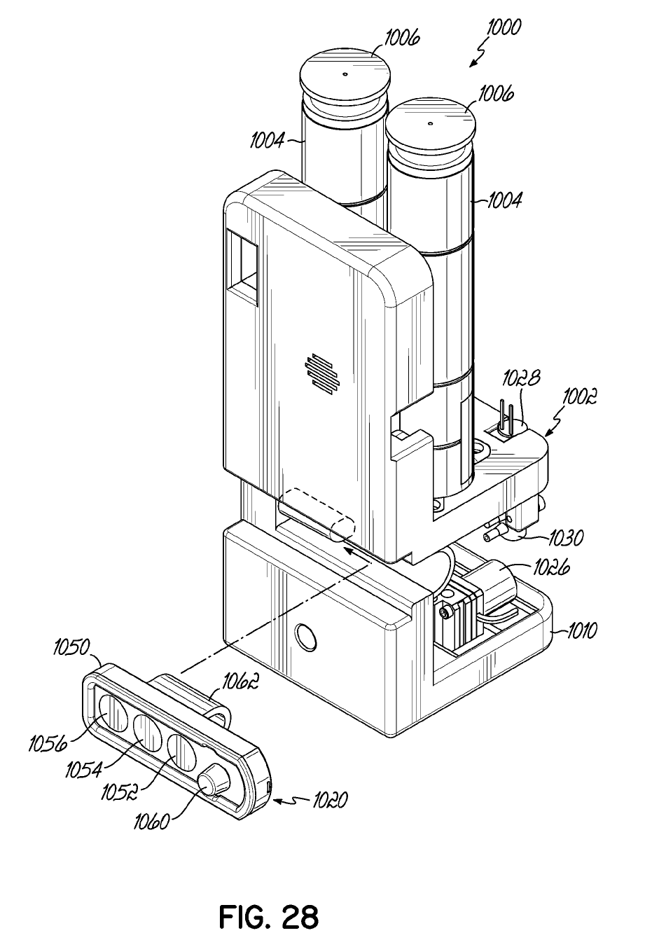

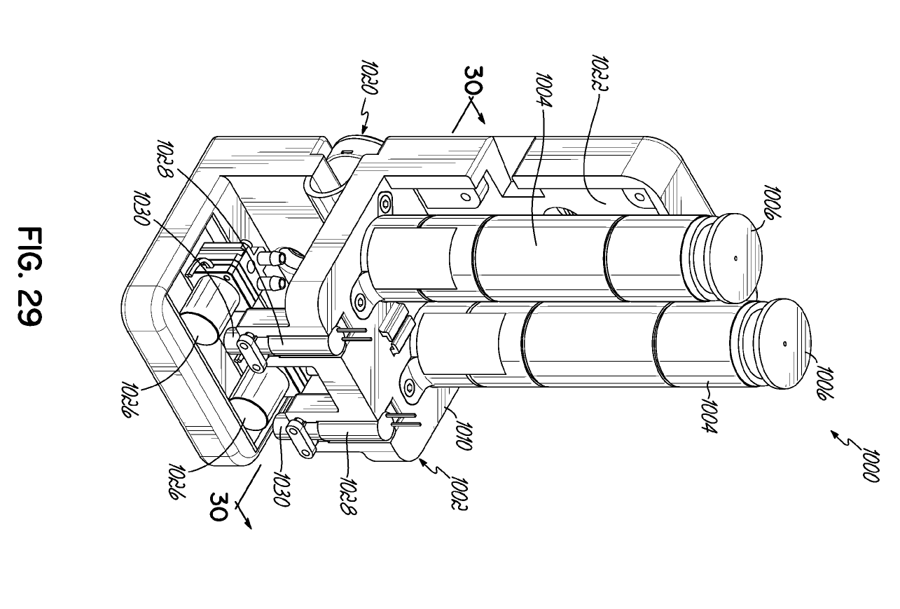

According to another aspect of the present invention, in one embodiment and with reference to FIGS. 28, 29, and 32, an endodontic treatment system 1008 (FIG. 32) includes an endodontic device, such as one of the endodontic devices disclosed herein, coupled to a fluid delivery system 1000. In the exemplary embodiment, the device 900 is shown. However, other endodontic devices disclosed herein may be coupled to the delivery system 1000. The fluid delivery system 1000 may include a fluid pumping unit 1002 for storing and delivering one or more irrigants to an endodontic device, such as endodontic device 900, via tubes 964, 966. As shown, the endodontic device 900 may be coupled to a remote vacuum source 1012 in the clinician's office. The endodontic treatment system 1008 may include a control system 1020 removably attached to the pumping unit 1002 and by which the clinician may remotely control fluid delivery to the patient through the endodontic device 900.

The fluid pumping unit 1002 includes one or more fluid reservoirs 1004. In the exemplary embodiment shown, the pumping unit 1002 includes fluid reservoirs 1004 each of which are fluidly coupled to an irrigant system, such as irrigant system 906 shown in FIG. 24, by separate tubes. Embodiments of the invention are not limited to two fluid reservoirs 1004. It will be appreciated that there may be only a single reservoir or more than two reservoirs. Each fluid reservoir 1004 may be filled with a different irrigant (e.g., “Fluid A” and “Fluid B”) by removing a respective lid 1006 and pouring the fluid into the fluid reservoirs 1004.

With reference to FIGS. 28-30 and 32, the pumping unit 1002 includes a frame 1010 which supports various components including, for example, the fluid reservoirs 1004. A mainboard 1022 may house electronics for monitoring and powering the pumping unit 1002. A pump 1026 may be coupled to each fluid reservoir 1004 and may be controlled by electronics on the mainboard 1022. The pump 1026 may be pneumatically, electrically, mechanically, or chemically powered as is known in the art. By way of example only, the pump 1026 may be a centrifugal pump. During endodontic therapy, the clinician may individually activate each pump 1026 to deliver a selected irrigant from the corresponding fluid reservoir 1004 to an endodontic device for dispensing into the opening in a tooth, as is described above.

Although not shown, the mainboard 1022 may house or be coupled to sensors that monitor the level of the fluid in the corresponding fluid reservoir 1004. This may include a low-medium-full type sensor or a sensor that merely indicates that one of the fluid reservoirs 1004 is empty. The level sensors may be optical, a mechanical float, or another type of sensor known in the art.

The pumping unit 1002 may further include a pair of solenoids 1028 with each solenoid 1028 being operatively coupled to a valve 1030. As shown, the valves 1030 may be three-way valves. The fluid reservoir 1004 may be coupled to the pump 1026 by a tube 1032. When active, the pump 1026 may pump the fluid through tube 1034 to the valve 1030, which may then direct the fluid through the tube 1036 to an endodontic device operated by the clinician. As shown, the valve 1030 may be coupled to a recirculation tube 1042 within the fluid reservoir 1004 by a tube 1038. In one embodiment, the pump 1026 is a centrifugal pump and may be primed prior to delivering fluid to the endodontic device. Fluid flow through the valve 1030 and recirculation tube 1042 may provide a pathway by which the pump 1026 may be primed prior to use. The solenoids 1028 and pumps 1026 for each of the fluid reservoirs 1004 may be controlled remotely by the clinician with the control system 1020 to select a fluid available within the fluid reservoir 1004 for delivery to an endodontic device.

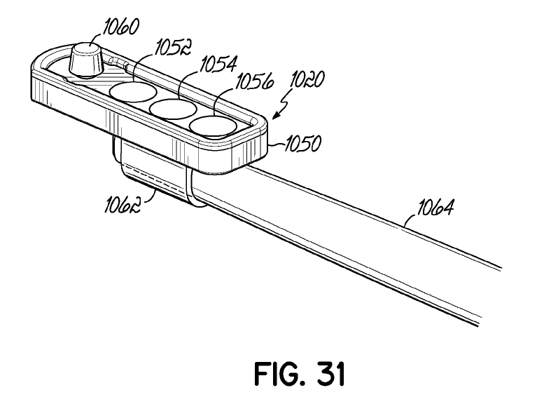

With reference to FIGS. 28 and 31, in one embodiment, the clinician may remotely control the pumping unit 1002. In that regard, the control system 1020 may be moved to a location remote from the pumping unit 1002. For example, the control system 1020 may be removably secured to an endodontic device described above. Alternatively, a control system may be integrated in to the endodontic device as is described in detail below. The control system 1020 may be operatively coupled to the on/off button mechanisms 990, 992, for example, to control the delivery of the irrigant from the fluid delivery system 1000 to the endodontic device 900.

As shown, in one embodiment, the control system 1020 includes a control pad 1050 that houses electronics necessary to control the pumps 1026 in the pumping unit 1002. In that regard, the control pad 1050 may include push buttons 1052, 1054 and 1056 for controlling a respective one of the pumps 1026. In particular, for example, one push button 1052 may control one pump 1026 so that the clinician may dispense one irrigant (e.g., EDTA) from one of the fluid reservoirs 1004. Activation of other push button 1054 may dispense a different irrigant into the tooth from the other reservoir 1004. The push button 1056 may facilitate priming of the pumps and all of the tubing between the pumping unit 1002 and an endodontic device.

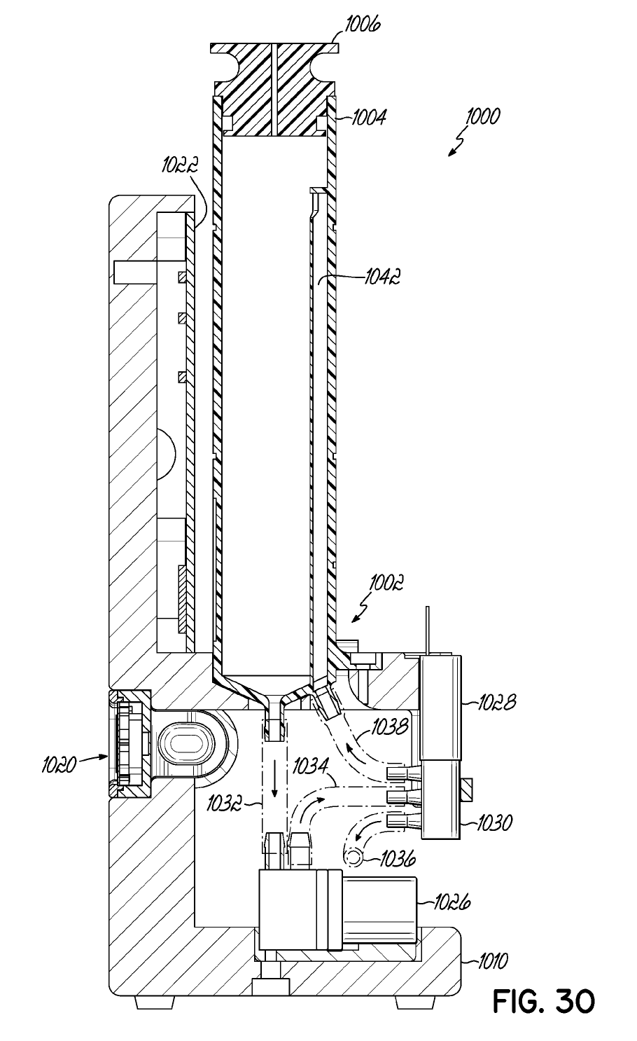

Specifically, prior to a procedure, the tubing between the pumping unit 1002 and the handpiece may be empty. Activation of the push button 1056 may fill all of the tubing 964, 966, 1036 coupled to each of the fluid reservoirs 1004 thus priming the pumping unit 1002 and tubing to an endodontic device before use. Advantageously, the clinician may selectively and iteratively dispense different fluids into the tooth during an endodontic procedure. Also shown in FIG. 30 is a flow control knob 1060 by which the clinician may control the flow rate of the selected irrigant.

The control pad 1050 may include a strap 1062 so that the clinician may attach the control system 1020 to an endodontic device 1064 (FIG. 31), which may be any single one of the endodontic devices described herein.

With reference now to FIGS. 33-41, in which like reference numerals refer to like features throughout the figures, in one embodiment, an endodontic treatment system 1100 includes an endodontic device 1102 coupled to a docking station, referred to herein as a fluid delivery system 1104 (similar to fluid delivery system 1000), each described in detail below. In general, a clinician may utilize the endodontic device 1102 during an endodontic procedure to control the flow of irrigant into and evacuate that irrigant from a prepared tooth, described above. The fluid delivery system 1104 may contain at least one source of that irrigant. The various features described in relation to the embodiments above even though those features may not be described specifically with regard to the exemplary embodiments shown in FIGS. 33-14 may be used alone or in any combination with the endodontic treatment system 1100.

In general, the endodontic device 1102 and the fluid delivery system 1104 may be fluidly and electrically coupled together via a plurality of tubes 1106 and an electrical cable 1108, respectively. One or more of the tubes 1106 permit one or more irrigants contained within the fluid delivery system 1104 to flow to the endodontic device 1102. Another of the tubes 1106 may couple a source of vacuum to the endodontic device 1102 so that used irrigant and debris created during the endodontic procedure may be evacuated from the endodontic device 1102 to a source vacuum (not shown).

The electrical cable 1108 may provide electrical communication between the endodontic device 1102 and the fluid delivery system 1104 and so may allow the clinician to operate the fluid delivery system 1104 with controls located on the endodontic device 1102. Advantageously, the clinician need not release the endodontic device 1102 to operate the fluid delivery system 1104. It will be appreciated that other communication means, such as wireless communication devices, may allow the clinician to control the fluid delivery system 1104 from controls built in or on the endodontic device 1102 and so the cable 1108 may not be used. The endodontic device 1102 and the fluid delivery system 1104 may be similar to the devices and delivery systems described above such that any single one of the endodontic devices described above may be coupled to the fluid delivery system 1104, and other fluid delivery systems (e.g., the fluid delivery system 1000) may be coupled to the endodontic device 1102. Embodiments of the invention are therefore not limited to the exemplary combination of the endodontic device 1102 and the fluid delivery system 1104 shown in FIGS. 33-41.

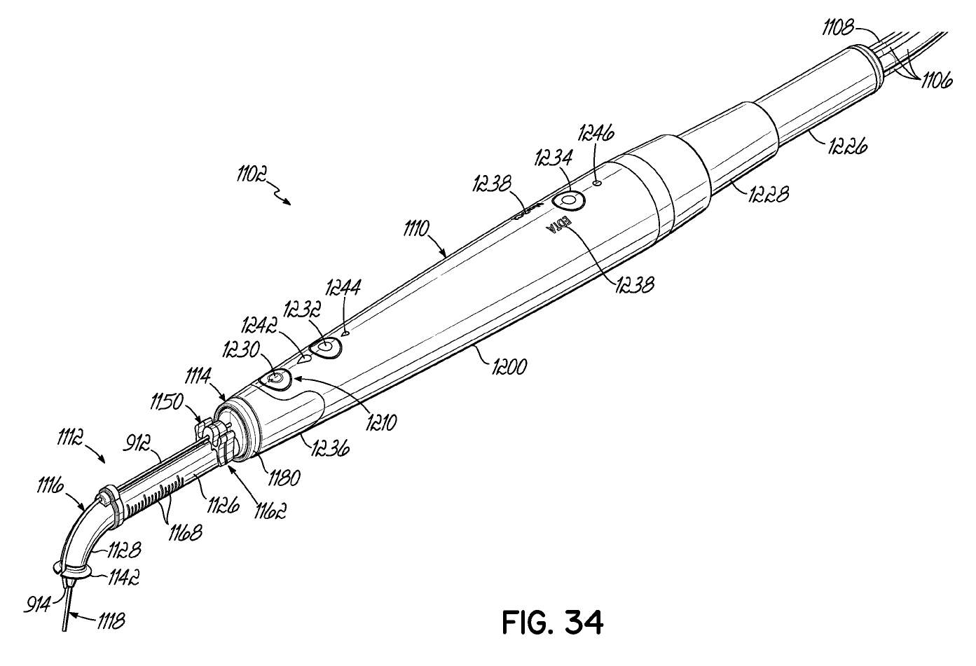

In the exemplary embodiment shown in FIGS. 33, 34, 35A, and 35B, the endodontic device 1102 includes a handpiece 1110 and an end effector 1112 coupled together at a joint 1114. With reference specifically to FIG. 34, the endodontic device 1102 includes an irrigant system 1116 and a canal evacuation system 1118, each of which may be at least partially housed in or form a portion of the handpiece 1110 and housed in or form a portion of the end effector 1112. Each of the irrigant system 1116 and the canal evacuation system 1118 may perform substantially the same as any of the irrigant system and the canal evacuation system described herein. In one embodiment, vacuum is supplied to each of the irrigant system 1116 and the canal evacuation system 1118, similar to other endodontic devices described herein.

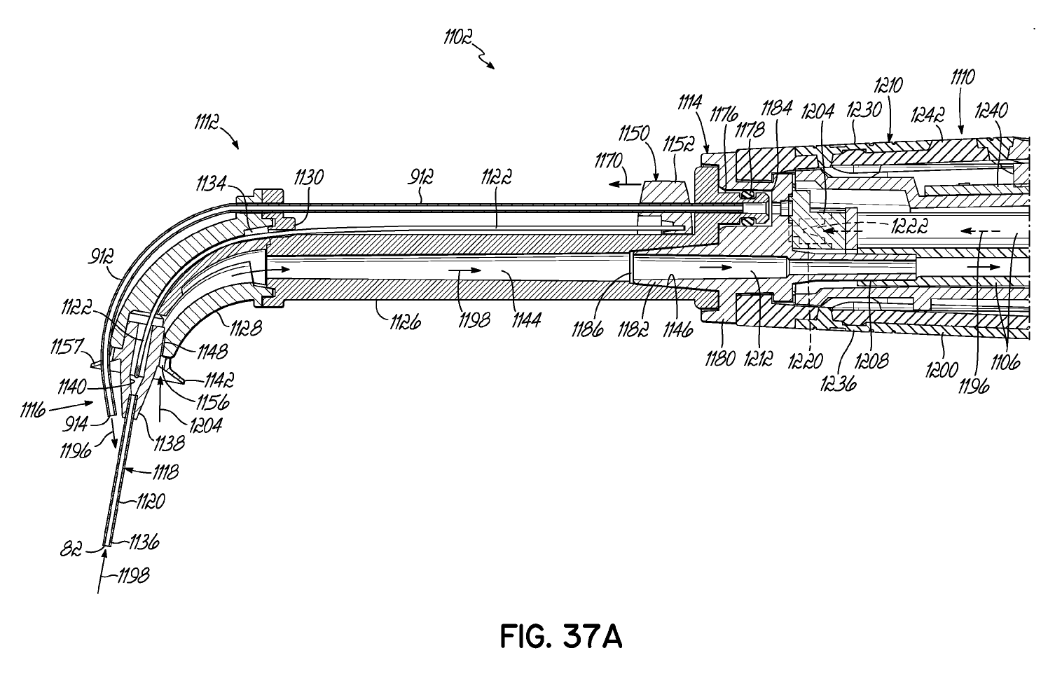

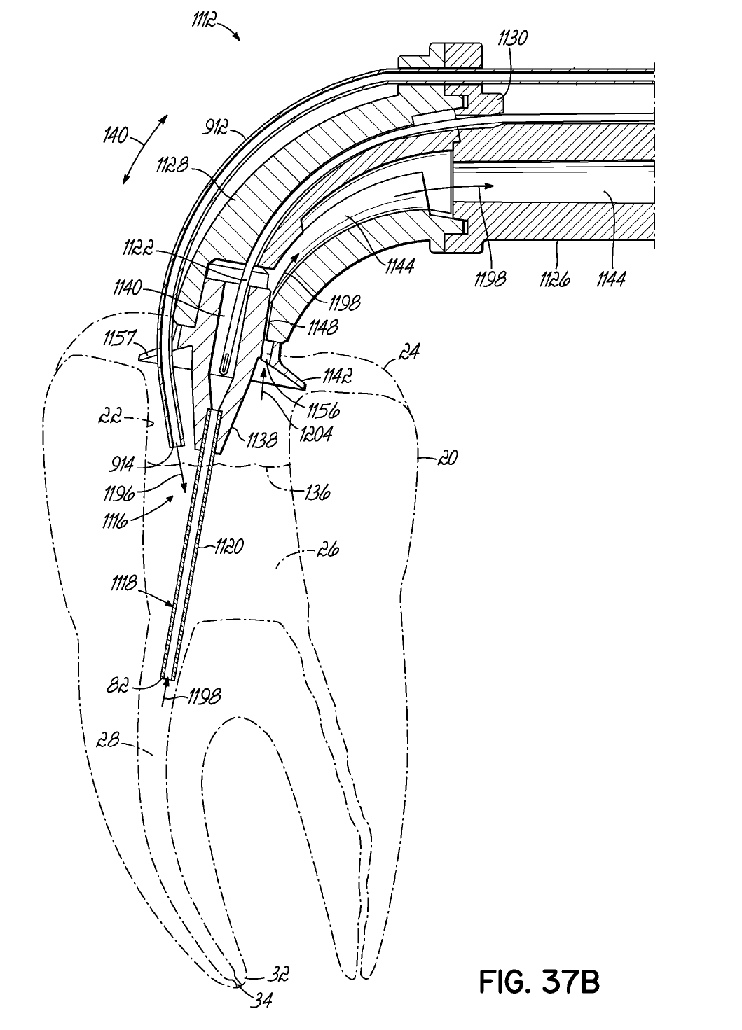

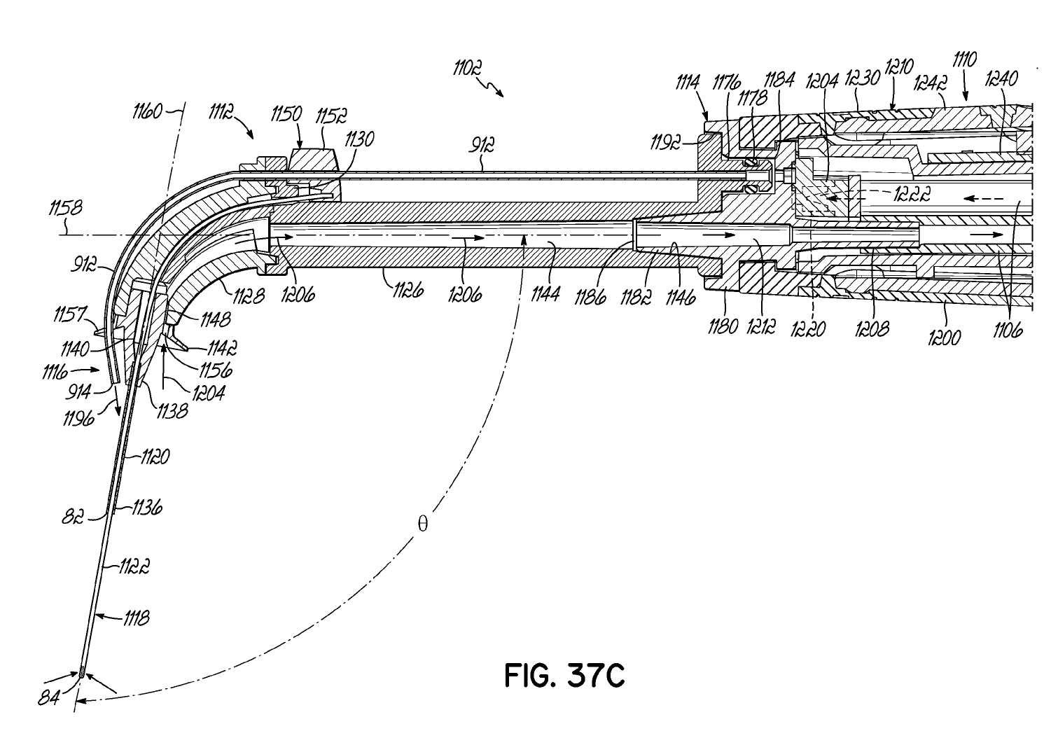

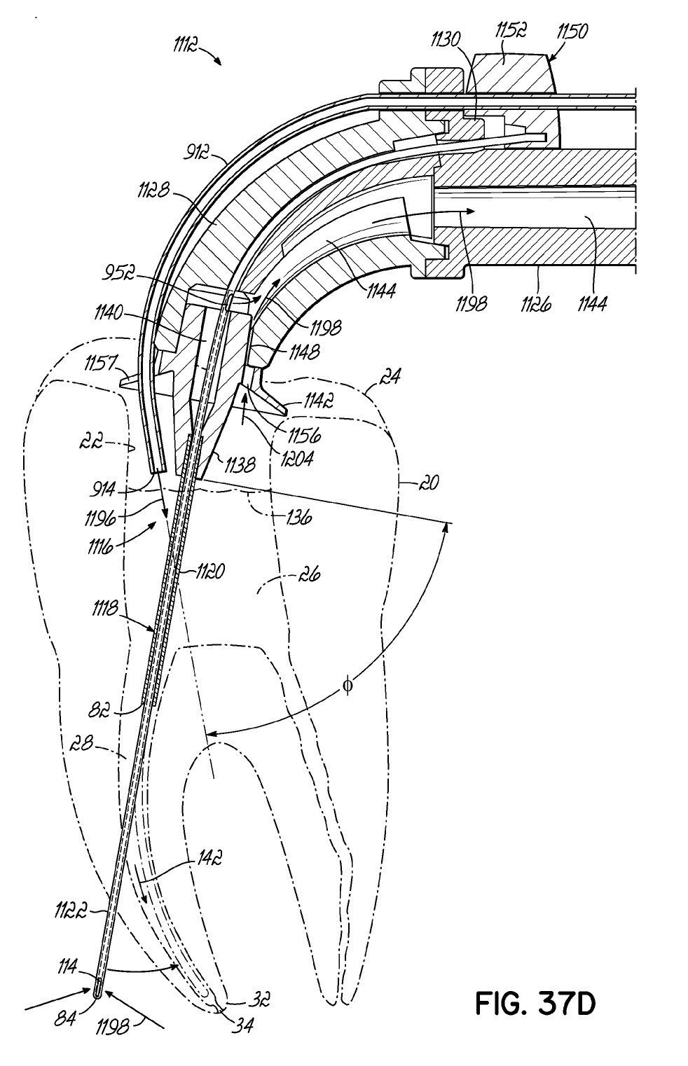

The irrigant system 1116 and the canal evacuation system 1118 may terminate at the end effector 1112 and so are at least partially insertable into a prepared tooth as is described above with reference to FIGS. 5A-6D. A clinician may manipulate the end effector 1112 to a position in which each of the irrigant system 1116 and the canal evacuation system 1118 are proximate the opening 22 in the tooth 20 (FIG. 37B). The clinician may then control irrigant flow from or through the endodontic device 1102 into the opening 22 of the tooth 20 while evacuating irrigant from the tooth 20 at possibly two locations within or proximate the tooth 20 to efficiently remove debris and thoroughly disinfect the pulp chamber 26 and root canals 28.

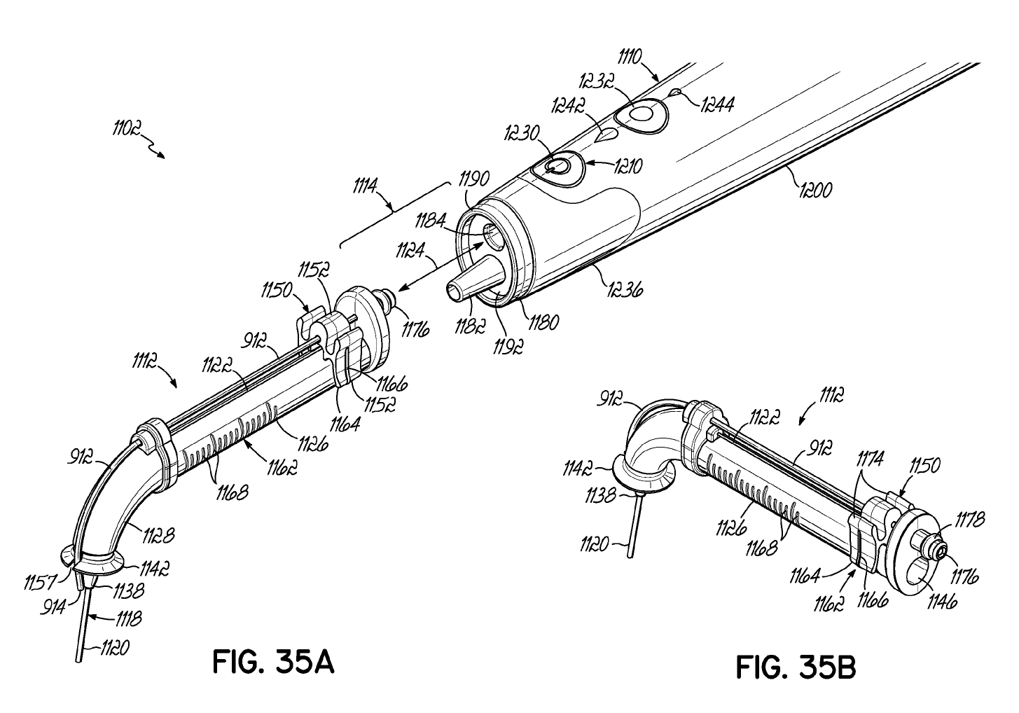

In one embodiment, at least the irrigant system 1116 is fluidly coupled to the fluid delivery system 1104 via one of the tubes 1106 so that at least one irrigant may flow from the fluid delivery system 1104 through the irrigant system 1116. More specifically, and with reference to FIGS. 34, 35A, and 35B, the irrigant system 1116 includes the fluid delivery tube 912 that terminates on the end effector 1112 at end 914. In this way, one or more irrigants may be dispensed from the fluid delivery system 1104, through one or more of the tubes 1106, through the handpiece 1110, and out of end 914. In one embodiment, the end effector 1112 includes a main body portion 1126 coupled to a cap portion 1128 that are separately molded and then assembled with an adhesive or other securing means. With reference to FIG. 35A, the main body portion 1126 and the cap portion 1128 define a bore 1144 that extends longitudinally through the main body portion 1126 and generally follows any curvature of the cap portion 1128. The bore 1144 may open to a funnel-like receptacle 1146 at one end that receives a portion of the handpiece 1110 to form a portion of the joint 1114. As shown, the fluid delivery tube 912 may be generally external to each of the main body portion 1126 and the cap portion 1128. While the end effector 1112 is described with reference to two components, i.e., the main body portion 1126 and the cap portion 1128, embodiments of the invention are not limited to any specific number of components.

With reference to FIGS. 34, 37A, and 37B, the canal evacuation system 1118 includes two cannulas 1120, 1122 of different sizes. In the exemplary embodiment, the outside diameter of the cannula 1122 fits within the inside diameter of the cannula 1120. In this regard, the cannulas 1120, 1122 may be concentrically positioned relative to one another similar to other pairs of cannulas described above. The two cannulas 1120, 1122 may be movable relative to one another between a retracted position (FIGS. 37A and 37B) and an extended position (FIGS. 37C and 37D) during an endodontic procedure similar to that shown in FIGS. 5A-6B, described above.

In the exemplary embodiment, the outside diameter of the cannula 1122 is slightly less than to about equal to the inside diameter of the cannula 1120. In this way, the cannula 1122 is slidable relative to the cannula 1120 while also forming a vacuum seal between the cannula 1122 and the cannula 1120 when the cannula 1122 is in the extended position and a vacuum is routed through the canal evacuation system 1118. While the difference in size between the cannulas 1120 and 1122 enables a vacuum seal to be formed between them, embodiments of the invention are not limited to this configuration, as other structural features on the cannula 1120 or on the cannula 1122 may provide a seal when the cannulas 1120, 1122 are extended relative to one another.

The cannula 1120 may be referred to herein as a macrocannula, and the cannula 1122 may be referred to herein as a microcannula. The cannulas 1120, 1122 may be fluidly coupled to one of the tubes 1106 through which vacuum is provided in the end effector 1112 so that fluid proximate one of the cannulas 1120, 1122 may be evacuated from the tooth through the end effector 1112 and through the handpiece 1110 as is described below.

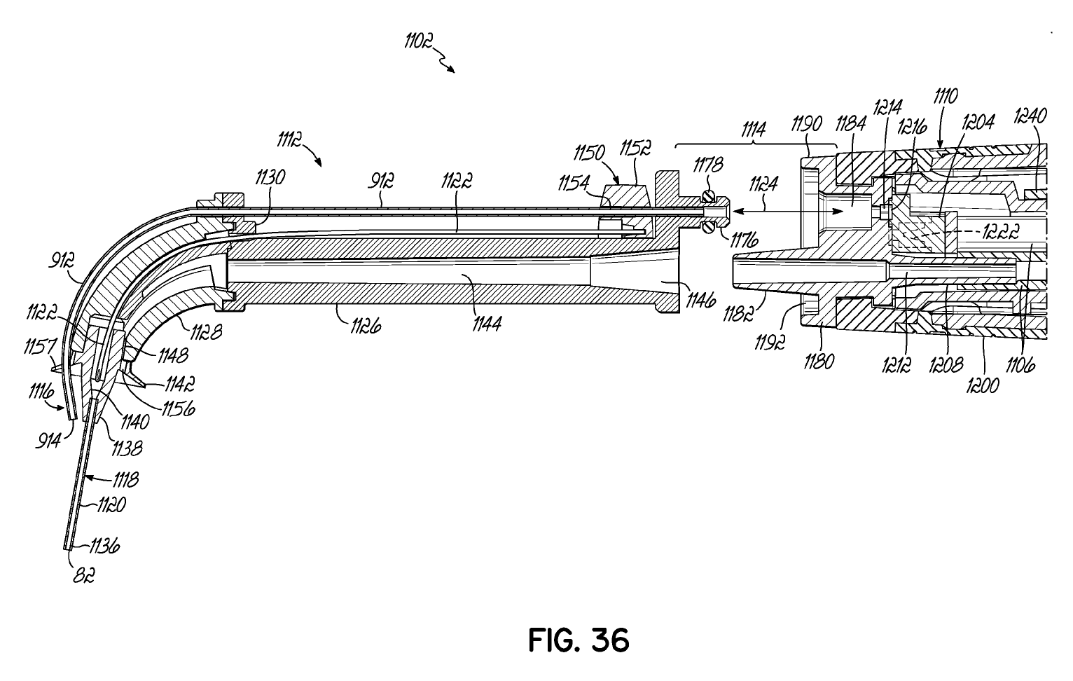

As shown best in FIGS. 35A and 36, the macrocannula 1120 may include a uniform tubular member 1136 that is coupled to a separate hood portion 1138. It will be appreciated that embodiments of the invention are not limited to this two-part construction of the tubular member 1136 and hood portion 1138. For example, the tubular member 1136 and hood portion 1138 may be formed of a single piece of plastic, for example. The hood portion 1138 may include a through bore 1140, an enlarged umbrella-like rim 1142, and an opening 1156 offset from but generally parallel to the through bore 1140. The through bore 1140 and opening 1156 provide different pathways through which vacuum is routed from the bore 1144. In the exemplary embodiment shown, the hood portion 1138 distributes vacuum between the irrigant system 1116 and the canal evacuation system 1118 via the opening 1156 and the through bore 1140, respectively.

The uniform tubular member 1136 has at least a uniform inside dimension along its length and may be plastic that is glued or secured by other means within the hood portion 1138. By way of example only and not limitation, the tubular member 1136 may be about 20 mm in length though embodiments of the present invention are not limited to any specific length macrocannula 1120.

The hood portion 1138 may be an elastic material, such as a polyurethane or similar material, a portion of which may have a cone-like configuration terminating in the umbrella-like rim 1142. An opening or a slot 1157 may extend through the hood portion 1138 to receive the fluid delivery tube 912. In view of the elastic nature of the hood portion 1138, the umbrella-like rim 1142 is compliant and so may seal against the crown of the tooth during use of the endodontic device 1102. It will be appreciated that the seal may not be a complete seal in view of at least the slot 1157 but that enclosing the opening 22 (FIG. 37B) with the hood portion 1138 helps prevent irrigant from escaping into the patient's mouth as well as facilitates evacuation of the irrigant from the tooth 20.

The microcannula 1122 may be similar to other microcannulas described herein. By way of example only, the microcannula 1122 may be stainless steel (e.g., SAE 316 SS) or NiTi and have the end 84 in one of the configurations shown in FIGS. 4C-4E and described above. By way of further example, the microcannula 1122 may be constructed of multiple different materials, such as stainless steel and plastic. That is, a multi-part construction with a stainless steel tip coupled to a hollow plastic shaft. This two-part construction may improve bendability. The microcannula 1122 may be 30 mm in length though embodiments of the present invention are not limited to any particular length of microcannula 1122.

At the other end of the bore 1144, there is a port 1148 that is sized to receive the hood portion 1138. At least a portion of the port 1148 remains open when the hood portion 1138 is assembled into the cap portion 1128. As shown, the port 1148 is aligned with the opening 1156 after insertion. The bore 1144 fluidly couples each of the cannula 1120 and, through the aligned opening 1156 and port 1148, a region generally bounded by the enlarged umbrella-like rim 1142 to a vacuum source (e.g., vacuum source 1012 in FIG. 32).

Further, the port 1148 may be smaller in cross-sectional dimension than the cross-sectional dimension of the opening 1156. As a result, the relative dimensions between the port 1148 and the openings 114 in the microcannula 1122 simultaneously produce sufficient evacuation proximate the hood portion 1138 in a region bounded by the rim 1142 and proximate the end 84 of the cannula 1122, when the microcannula 1122 is in the extended position (a fully extended position is shown in FIG. 37B). By way of example only, the port 1148 need not be circular and may be equivalent in area to a circular opening of about 0.1 mm in diameter when the configuration of the end 84 of the microcannula 1122 is that shown in FIG. 4C with a swaged end and an outside diameter of about 0.13 mm and having openings 114 that are about 0.102 mm in width and about 0.4 mm in length. Although not shown, in embodiments in which the opening 1156 is smaller in cross-sectional dimension than the port 1148, the ratio of the cross-sectional dimensions of the opening 1156 relative to the dimensions of the openings 114 in the microcannula 1122 determine the relative suction between the irrigant system 1116 and the canal evacuation system 1118.

With reference to FIGS. 37A and 37B, in one embodiment, the canal evacuation system 1118 further includes a seal portion 1130 which caps a guide channel 1134. The microcannula 1122 passes through the main body portion 1126 at the seal portion 1130, which prevents vacuum leakage between the microcannula 1122 and each of the main body portion 1126 and the cap portion 1128. The guide channel 1134 orients the microcannula 1122 for extension and retraction through the macrocannula 1120. As shown in FIG. 37A, in one embodiment, the end 84 of the microcannula 1122 is positioned in the through bore 1140 of the hood portion 1138. During extension of the microcannula 1122, as is described below, the guide channel 1134 ensures that the end 84 of the microcannula 1122 enters the macrocannula 1120.

As is generally shown in FIG. 37C, in one embodiment, the cannulas 1120, 1122 are not oriented perpendicularly to the main body portion 1126 and so may differ from orientations of the cannulas described above. Instead of 90°, the cannulas 1120, 1122 are oriented at a non-orthogonal angle relative to a longitudinal axis 1158 defined by the main body portion 1126. As shown, the longitudinal axis 1158 may be generally parallel to the bore 1144 through the main body portion 1126. In the exemplary embodiment shown, the handpiece 1110 may also lie on or be parallel to the axis 1158.

A longitudinal axis of the microcannula 1122 (when in an extended, relaxed position) may define an axis 1160, as shown. The axis 1158 and the axis 1160 may intersect and define an angle Θ, as shown in FIG. 37C. In one embodiment of the invention, the angle Θ may be greater than 90°. By way of example only, the angle Θ may be greater than 90° up to about 145°, and by way of further example, the angle Θ may be greater than 90° and less than about 110°. In the exemplary embodiment shown, the angle Θ is about 100°. Advantageously, Applicants identified that utilizing an angle greater than 90° permits the use of a microcannula made of stainless steel. In that regard, Applicants found that stainless steel microcannulas work harden when used at an angle of about 90° and may be more susceptible to brittle failure during use. The same stainless steel microcannula may be usable at angles greater than 90°, such as about 100°. Furthermore, stainless steel is corrosion resistant to many of the irrigants used in endodontic procedures, including EDTA. By contrast, NiTi cannulas, which are capable of being used at an angle of about 90°, because of their superelastic nature, were found to corrode very quickly when exposed to EDTA and so are not usable in contact with this fluid in endodontic procedures.

In one embodiment, and with reference to FIGS. 34-36, the endodontic device 1102 includes an extension control system 1150, which may be operatively coupled to the canal evacuation system 1118. In particular, by manipulating the extension control system 1150, the clinician may selectively extend and retract the cannula 1122. The extension control system 1150 may serve other functions. For example, it may also permit the clinician to measure the position of the apical foramen of the root canal relative to the crown of the tooth, as is described below.

To these and other ends, the extension control system 1150 includes a slider 1152 that is movable relative to the main body portion 1126. In the exemplary embodiment, the slider 1152 is slidably coupled to the fluid delivery tube 912. The clinician may selectively move the slider 1152 to different positions generally along the length of the main body portion 1126. By way of example only, the full travel of the slider 1152 along the end effector 1112 may be from about 25 mm to about 90 mm. As shown best in FIG. 36, the slider 1152 includes a bore 1154 that receives the fluid delivery tube 912. In this configuration, the fluid delivery tube 912 may function like a rail and guide the slider 1152 as it is moved along the main body portion 1126.

With reference to FIGS. 36, 37A, and 37B, the slider 1152 receives one end of the cannula 1122. In the embodiment shown, the cannula 1122 is secured to the slider 1152 in a manner that plugs that end of the cannula 1122. As the clinician moves the slider 1152 relative to the main body portion 1126 according to arrow 1170 in FIG. 37A, the cannula 1122 also moves relative to the main body portion 1126. By way of example only, and with reference to FIG. 37C, when the cannula 1122 is in the fully extended position, the slider 1152 may abut an end portion of the main body portion 1126. Full extension is not required, that is, slider 1152 may be positioned anywhere between the fully retracted position shown FIG. 37A and the fully extended position shown in FIG. 37C. In this way, the clinician may operate the slider 1152 to selectively extend and retract the cannula 1122 from the end effector 1112. As is described below, embodiments of the present invention contemplate predetermined relative positions between the microcannula 1122 and the macrocannula 1120.

Further in that regard, the extension control system 1150 may provide an indication of a relative position between the cannula 1122 and the hood portion 1138. The clinician may position the cannula 1122 at desired, predetermined positions within the apical third of the root canal without having to measure the extension of the cannula 1122 prior to insertion into a tooth.

In one embodiment, the extension control system 1150 may further include a locking system 1162 that secures the extension control system 1150 at one or more predetermined positions. As shown in FIG. 35A, in the exemplary embodiment, the locking system 1162 may include a pair of clips 1164 that slide along the exterior surface of the main body portion 1126. The clips 1164 may extend from the slider 1152 and be resiliently disposed against the exterior surface of the main body portion 1126. A projection 1166 on the clips 1164 is pressed against the exterior surface of the main body portion 1126. The main body portion 1126 may include a plurality of grooves or tick marks 1168 in which the projections 1166 of the clips 1164 releasably engage.

As can be appreciated by at least FIG. 35A, as the slider 1152 is pushed along the main body portion 1126, the projections 1166 on the clips 1164 encounter the tick marks 1168. The configuration of the projections 1166 and the tick marks 1168 produce a plurality of fixed positions between the slider 1152 and the main body portion 1126 that resist invert movement of the slider 1152. The resiliency of the clips 1164 against the main body portion 1126 may emit a tactile and/or audible click as the projections 1166 engage selective ones of the tick marks 1168. By this response, a clinician may know the position of the slider 1152 (and the microcannula 1122) relative to the main body portion 1126 without a visual check.

The tick marks 1168 may be equally spaced apart and a predetermined distance so as to present a ruler by which the clinician may measure extension of the microcannula 1122. The distance between the tick marks 1168 may correspond to a predetermined distance of movement of the end 84 of the microcannula 1122. By way of example only, and not limitation, the tick marks 1168 may be spaced apart at a distance sufficient to change the depth of the microcannula 1122 by about 1 mm per each tick mark 1168, though other predetermined distances may be utilized, such as about 0.5 mm or about 0.25 mm. In this way, the tick marks 1168 may correlate to the length of the microcannula 1122 that extends from the macrocannula 1120 or another fixed location on the end effector 1112. It will be appreciated that the arrangement of the projections and the grooves may be reversed from that shown and described herein. For example, the tick marks 1168 may be formed in the clip 1164 and the projection 1166 may extend outwardly from the exterior surface of the main body portion 1126. Furthermore, the locking system 1162 may prevent inadvertent movement of the extension control system 1150, as is described below.

In one embodiment and with reference to FIG. 35A, the locking system 1162 may include an unlocking feature, such as tabs 1174, that are operable to unlock the extension control system 1150. In a locked position, the extension control system 1150 may remain in one position and resist inadvertent movement, such as push back, of the cannula 1122. As shown, the tabs 1174 may extend from the clips 1164 of the slider 1152. Once the locking system 1162 is engaged, the clinician may desire to unlock the slider 1152 to reposition the microcannula 1122 relative to the cannula 1120. To do so, the projection 1166 may be disengaged from the respective tick mark 1168. The clinician may squeeze the tabs 1174 which, via a lever action, overcomes the bias of the clips 1164 against the main body portion 1126. Thus, squeezing the tabs 1174 may disengage the projections 1166 from the tick marks 1168. The slider 1152 may then be more easily movable relative to the main body portion 1126 and so the clinician may selectively, intentionally reposition the slider 1152.

Similar to the end effectors described above, the end effector 1112 may be a consumable that is thrown away after a single endodontic procedure while the handpiece 1110 is a durable component that is reusable during additional procedures. With reference to FIGS. 35A, 35B, and 36, in view of the disposable, consumable nature of the end effector 1112, it may be selectively attached to, and releasable from, the handpiece 1110 according to arrow 1124 at the joint 1114. Further, the end effector 1112 and the handpiece 1110 may be secured together such that both vacuum and irrigant may travel between them without fluid leakage during use. In other words, the joint 1114 is fluid tight.

To these and other ends, in one embodiment, at that end of the end effector 1112 at the joint 1114, as shown best in FIGS. 35A and 35B, the fluid delivery tube 912 may pass into or through a male fitting 1176 that projects from the main body portion 1126 to cooperate with the handpiece 1110. In the exemplary embodiment, the male fitting 1176 includes an O-ring 1178, which seals against the handpiece 1110 to prevent leakage of irrigant at the joint 1114 during use of the endodontic device 1102. At the joint 1114, the funnel-like receptacle 1146 receives a portion of the handpiece 1110.

In particular, in one exemplary embodiment, a manifold 1180 may form one end of the handpiece 1110. As shown, the manifold 1180 may extend beyond a housing 1200, which forms an external case of the handpiece 1110, to form one half of the joint 1114. At its other end, the housing 1200 may also enclose an inner body 1226 and an intermediate ring 1228 that compresses the inner body 1226 onto the tubes 1106 and electrical cable 1108. The housing 1200 may facilitate easy cleaning of the handpiece 1110.

The manifold 1180 may form the joint 1114 with the end effector 1112 in one orientation. This one-way connection may prevent improper assembly of the end effector 1112 onto the manifold 1180. To that end, the manifold 1180 may include a conical projection 1182 that cooperates with the funnel-like receptacle 1146 in the main body portion 1126. The manifold 1180 also includes a receptacle 1184 that receives the male fitting 1176 and forms a fluid-tight seal with the handpiece 1110 utilizing the O-ring 1178. Embodiments of the invention are not limited to the arrangement shown. Other configurations of the manifold 1180 and the end effector 1112 may prevent improper assembly. For example, the arrangement of the projections and receptacles on the manifold 1180 and end effector 1112 may be reversed from that shown. The manifold 1180 may also include a rim 1190 that defines a cavity 1192. As shown, the conical projection 1182 may extend from within the cavity 1192 beyond the rim 1190.

In further regard to the joint 1114, and with reference to FIGS. 36 and 37A, when the end effector 1112 is assembled with the handpiece 1110, the funnel-like receptacle 1146 cooperates with the conical projection 1182 to form a vacuum tight seal in the joint 1114. This may be true even though the conical projection 1182 may not fully seat to the bottom of the funnel-like receptacle 1146, as shown by the gap 1186 between the conical projection 1182 and the funnel-like receptacle 1146 in FIG. 37A. Even if the conical projection 1182 does not extend fully into the funnel-like receptacle 1146, a vacuum-tight seal may be formed between the surfaces of the conical projection 1182 and the receptacle 1146. When the male fitting 1176 enters the receptacle 1184 to a depth at which the O-ring 1178 contacts the manifold 1180, a fluid-tight seal is formed between the handpiece 1110 and the fluid delivery tube 912. Advantageously, this configuration of the funnel-like receptacle 1146 and the receptacle 1184 may allow for variation in manufacturing tolerances in the dimensions of the funnel-like receptacle 1146 while still forming a fluid-tight seal in the joint 1114. This configuration ensures that a single one of the handpieces 1110 may accept a wider range in the manufacturing tolerances of disposable end effectors 1112. The arrangement of the conical projection 1182 and receptacle 1184, which is generally a male and female arrangement, may also prevent improper assembly of the end effector 1112 to the handpiece 1110, described above.

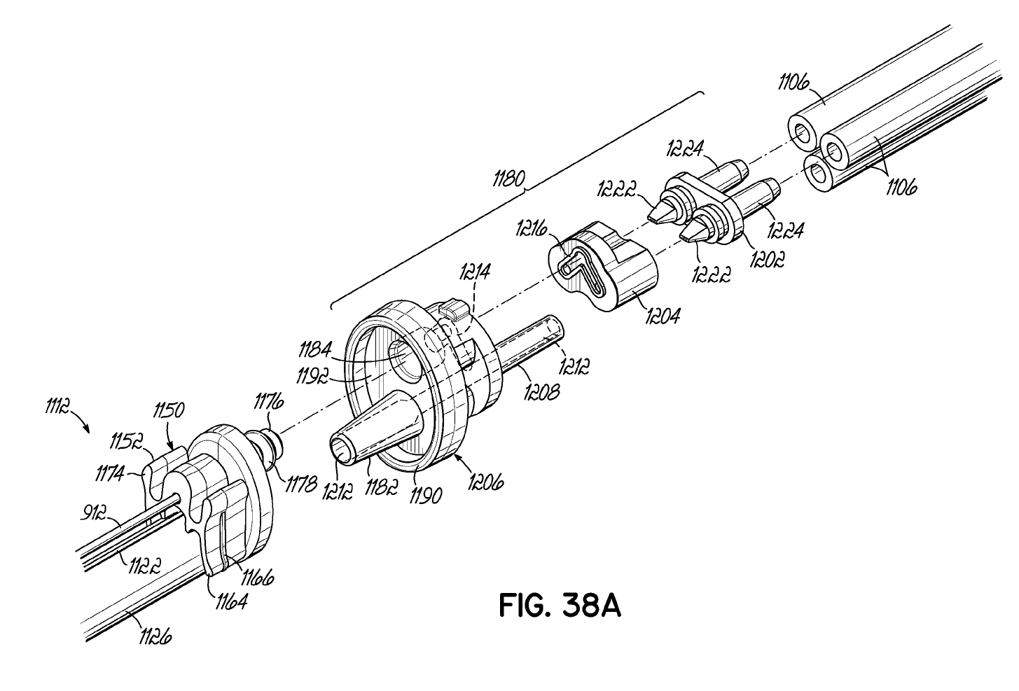

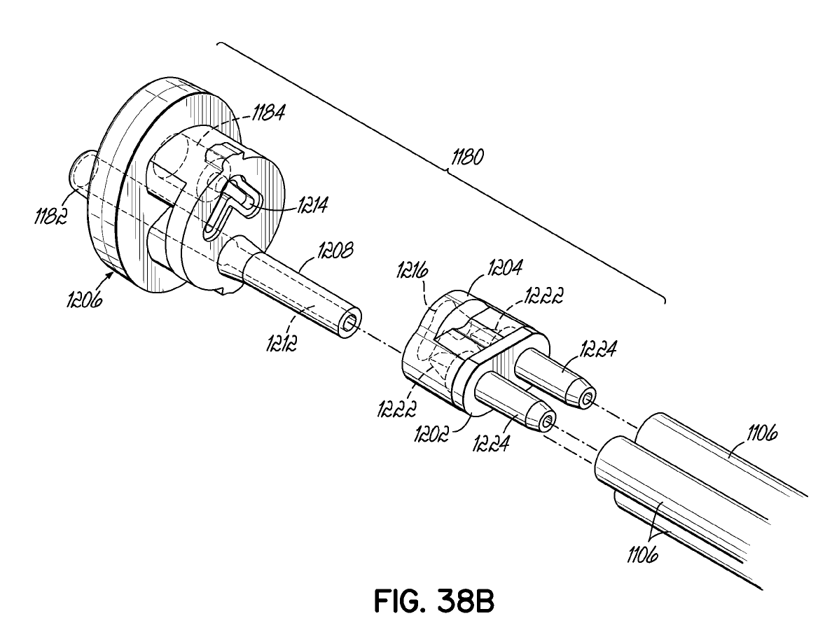

Further, as shown in FIGS. 37A and 38A, the main body portion 1126 may be inserted into the cavity 1192 such that the rim 1190 surrounds at least a portion of the main body portion 1126 when the end effector 1112 is assembled onto the handpiece 1110. This arrangement may improve the mechanical stability of the joint 1114 and so further ensure the fluid-tight seal of the joint 1114.

In one embodiment, and with reference to FIGS. 34, 37A, 38A, and 38B, the housing 1200 may enclose a portion of the manifold 1180 at one end thereof and enclose the tubes 1106 which may extend longitudinally nearly the length of the housing 1200 to couple to the manifold 1180. The tubes 1106 fluidly couple the handpiece 1110 to the fluid delivery system 1104 (FIG. 33) and supply irrigant to the end effector 1112, described above.

In particular, with reference to FIG. 38A, the manifold 1180 may be an assembly of at least three components including a valve portion 1202, a valve housing 1204, and a coupling portion 1206, which may be glued together prior to insertion into the housing 1200. As shown, the coupling portion 1206 forms an end of the manifold 1180 and includes the conical projection 1182 and the receptacle 1184 that form a portion of the joint 1114 with the end effector 1112. The coupling portion 1206 further includes a hose connection 1208, such as a hose barb, to which the tube 1106 is coupled. Collectively, the hose connection 1208 and the conical projection 1182 define a through bore 1212 which is intermediate between the tube 1106 and the bore 1144 of the end effector 1112 and so transmits vacuum from the tube 1106 to the end effector 1112. The coupling portion 1206 may further include a V-shaped channel 1214 that fluidly communicates with the receptacle 1184.

The valve housing 1204 is positioned intermediate the coupling portion 1206 and includes a V-shaped channel 1216 that matches the V-shaped channel 1214 of the coupling portion 1206. Collectively, V-shaped channels 1214, 1216 form an irrigant flow channel 1220 (labeled in FIG. 37A) that communicates with the receptacle 1184 and with the fluid delivery tube 912 when the end effector 1112 is assembled with the handpiece 1110.

The valve portion 1202 includes a plurality of valves 1222. In the exemplary embodiment, the valve portion 1202 includes two valves 1222 though it will be appreciated that the number of valves 1222 may correspond to the number of irrigants utilized in the endodontic procedure. Valves 1222 may substantially prevent unintended backflow past the valve portion 1202 and so prevent cross contamination of the irrigants from different tubes 1106. By way of example only, the valves 1222 may be duckbill valves. Each valve 1222 includes a hose connector 1224 to which one of the tubes 1106 is coupled. In the exemplary embodiment, fluid flow through either of the valves 1222 passes through the irrigant flow channel 1220 and into the end effector 1112 at the receptacle 1184. As shown, the relative volume of the irrigant flow channel 1220 is small and may measure only about 1 mL or less. Thus, the volume of irrigant in the channel 1220 is also small. In this regard, there is very limited cross-contamination between different irrigants, when present, in the irrigant flow channel 1220. Furthermore, when the end effector 1112 is disconnected from the handpiece 1110 at the joint 1114 only a small amount of fluid (e.g., a drop), if any, in the irrigant flow channel 1220 may drain from the manifold 1180.

In one embodiment, and with reference now to FIGS. 34, 35A, and 37A, the clinician may control the flow of irrigant prior to, during, and/or following an endodontic procedure by manipulating controls contained within the handpiece 1110 and/or within the fluid delivery system 1104. In regard to the handpiece 1110, the housing 1200 may enclose a portion of the irrigant system 1116. For example, the irrigant system 1116 may include an irrigant control system 1210 enclosed in the handpiece 1110 by which the clinician may select one or more irrigants and adjust the flow rate of the selected irrigant that is dispensed from the fluid delivery tube 912. In the exemplary embodiment, the irrigant control system 1210 may be coupled to the fluid delivery system 1104 via the electrical cable 1108. The clinician may then select and dispense one of the irrigants available in the fluid delivery system 1104 by operating the irrigant control system 1210. The electrical cable 1108 then transmits a plurality of control signals from the handpiece 1110 to the fluid delivery system 1104.

To that end and with continued reference to FIGS. 34, 35A, and 37A, in one embodiment, the irrigant control system 1210 includes a plurality of button mechanisms 1230, 1232, 1234, and 1236 accessible to the clinician on the handpiece 1110. The button mechanisms 1230, 1232, 1234, and 1236 may be combinations of microswitches and/or membrane switches as are known in the art. The button mechanisms 1230, 1232, 1234, and 1236 may be operatively coupled to one or more printed circuit boards 1240 (labeled in FIG. 37A) also contained within the handpiece 1110. The printed circuit board 1240 may then be operatively coupled to the fluid delivery system 1104 with the electrical cable 1108. The clinician may then control the fluid delivery system 1104 by manipulating the mechanisms 1230, 1232, 1234, and 1236.

By way of example only, the button mechanisms 1230 and 1236 may control the electrical power of the endodontic treatment system 1100. In one embodiment, for example, depression of one of the button mechanisms 1230 and 1236 may turn the treatment system 1100 “on” in which case a selected irrigant may flow from the fluid delivery tube 912. Depressing one of the button mechanisms 1230 and 1236 again may turn the treatment system 1100 “off” in which case the selected irrigant may stop flowing from the fluid delivery tube 912. This may be referred to as push-on-push-off control. Alternatively, the clinician may press and hold one of the button mechanisms 1230 and 1236 to turn the treatment system 1100 “on” and keep the treatment system 1100 “on.” Releasing the button mechanism 1230 or 1236 turns the treatment system 1100 “off.” This may be referred to as push-on-release-off control.

In one embodiment of the invention, when the treatment system 1100 is turned off, the fluid delivery system 1104 may withdraw all of the irrigant or a portion of the irrigant from the fluid delivery tube 912. Basically the fluid delivery system 1104 may suction the irrigant from the end effector 1112. In this way, the treatment system 1100 avoids residual dripping of irrigant from the fluid delivery tube 912 at a time when the clinician does not wish to have fluid exiting the fluid delivery tube 912, such as when drips would land in the patient's mouth.

By way of further example, button mechanism 1232 may control the flow rate of the selected irrigant from the fluid delivery system 1104. In the exemplary embodiment, and with reference to FIG. 34, the clinician may select between one of two different flow rates, for example, a first flow rate and a second, lower flow rate by depressing the button mechanism 1232. By way of example only, the first flow rate may be about 8 mL per minute and the second, lower flow rate may be about 4 mL per minute.

The button mechanism 1232 may be operatively coupled to indicator lights 1242, 1244 positioned adjacent the button mechanism 1232. As can be appreciated from FIG. 34, the indicator light 1242 is a larger droplet shaped light than the smaller droplet shaped light 1244. When lit, the light 1242 indicates a higher flow rate has been selected. When the clinician depresses the button mechanism 1232, the indicator light 1242 may energize and so visually indicate a high flow rate. When the clinician depresses the button mechanism 1232 again, the indicator light 1244 may energize while the indicator light 1242 may turn off to confirm a switch to a low flow rate. The reverse operation from a low flow rate to a high flow rate is also contemplated.

By way of further example and with reference to FIG. 34, button mechanism 1234 may allow the clinician to select one of the irrigants from multiple irrigants available from the fluid delivery system 1104. In the exemplary embodiment, a clinician may select one irrigant from a choice of two irrigants, for example, EDTA and NaOCl as is noted by the indicia 1238 (FIG. 34) on the housing 1200. Depression of the button mechanism 1234 once may select EDTA in which case an indicator light 1246 may turn one color for that particular liquid and the fluid delivery system 1104 may deliver EDTA through the fluid delivery tube 912.

If the clinician depresses the button mechanism 1234 again, the indicator light 1246 may turn a second, different color and the fluid delivery system 1104 may deliver NaOCl through the fluid delivery tube 912. Accordingly, with the button mechanisms 1230, 1232, 1234, 1236, the clinician may control the type of irrigant delivered, when the endodontic device 1102 delivers irrigant, and the flow rate of that irrigant through a corresponding one of the tubes 1106 coupled to the fluid delivery system 1104.

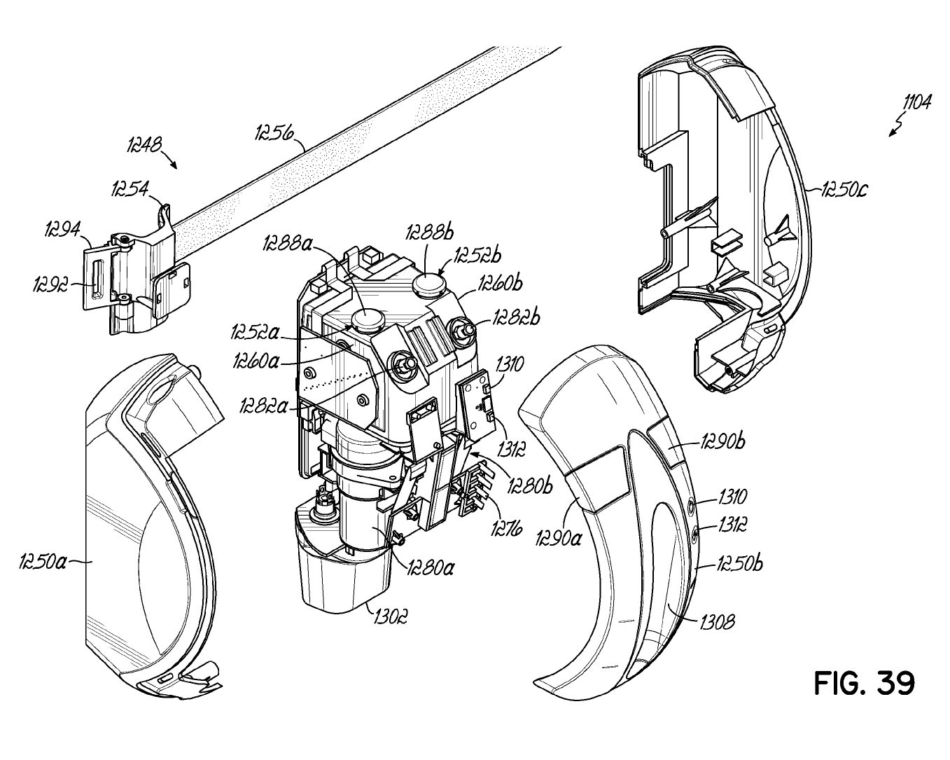

Referring now to FIGS. 39-41, one exemplary embodiment of the fluid delivery system 1104 and one exemplary embodiment of a mounting system 1248 are shown. The fluid delivery system 1104 includes a housing 1250a, 1250b, and 1250c, which is referred to collectively as housing 1250 when assembled, that encloses a plurality of irrigant supply systems 1252a, 1252b each sufficient to store and pump a respective irrigant through a corresponding one of the tubes 1106. The irrigant supply systems 1252a, 1252b thus supply the irrigant system 1116 with irrigant for use in an endodontic procedure. The housing 1250 and the plurality of irrigant supply systems 1252a, 1252b enclosed by the housing 1250 may be secured to a piece of office furniture, such as a chair or a table, by the mounting system 1248.

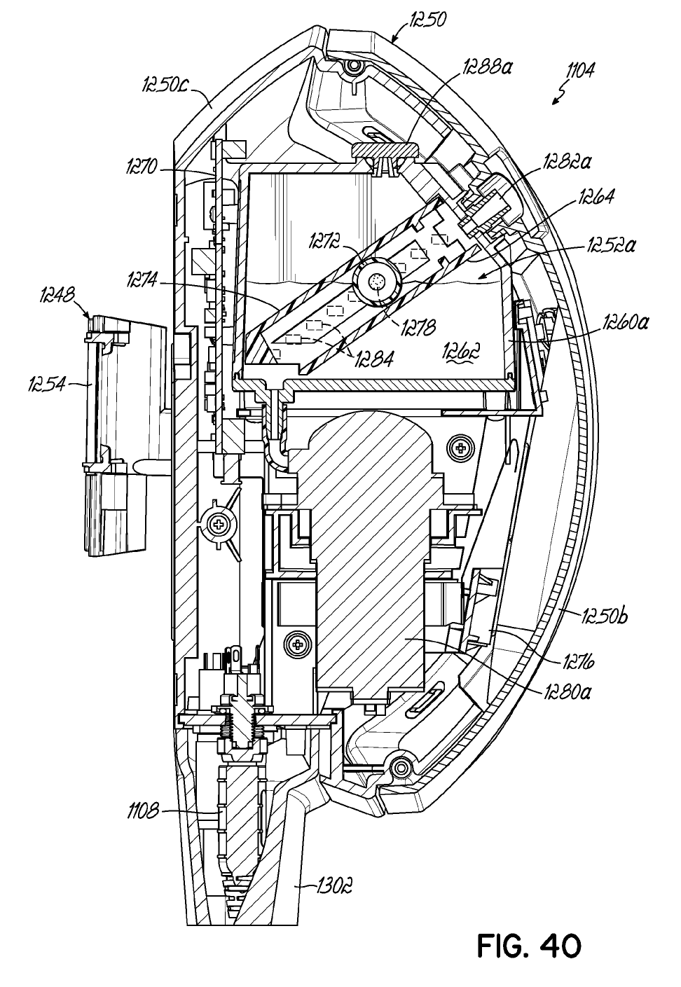

With reference to FIGS. 39 and 40, in one embodiment, each of the irrigant supply systems 1252a, 1252b include a reservoir 1260a, 1260b, which may include an irrigant 1262. Without being restricted to any particular size, each reservoir 1260a, 1260b may be sized to contain up to about 100 mL of irrigant though between about 20 mL and about 25 mL may be sufficient for any particular endodontic procedure. Each reservoir 1260a, 1260b may be selectively removable from and reattachable to the fluid delivery system 1104. In that regard, a clinician may remove the reservoir 1260a, 1260b for filling at a location remote from the fluid delivery system 1104. Once the reservoir 1260a, 1260b is full, it may be inserted back into the fluid delivery system 1104. Advantageously, refilling the reservoirs may be completed at a location in which spills of NaCOl may not cause problems and may be easily cleaned up. A fluid level sensing mechanism 1264 detects the level of the irrigant 1262 in the reservoir 1260a. Although not shown, a separate fluid level sensing mechanism is operably coupled to the reservoir 1260b. The fluid level sensing mechanism 1264 may then transmit a signal to a printed circuit board 1270 indicative of the amount of irrigant remaining in the reservoir 1260. The fluid level sensing mechanism 1264 includes a float 1272 movably mounted in a guide 1274. The float 1272 may support a magnet 1278 that may be magnetically coupled to one or more of a plurality of sensors 1284. For clarity, only one reservoir and one fluid level sensing mechanism of two is shown in FIG. 40.

Accordingly, as the irrigant 1262 in the reservoir 1260 is reduced, the float 1272 (and magnet 1278) moves downward toward the bottom of the reservoir 1260a. A signal generated by the sensing mechanism 1264 via the magnetic coupling of the magnet 1278 to one or more of the sensors 1284 may be received at the printed circuit board 1270. Ultimately, the printed circuit board 1270 sends signals to energize or de-energize one or more indicator lights 1276, which are visible through the housing 1250. Thus, in one exemplary embodiment, as the irrigant 1262 is utilized in an endodontic procedure, one or more of the indicator lights 1276 may be de-energized so as to give the clinician a visual indication of the usable fluid remaining in the reservoir 1260. In one embodiment, the indicator lights 1276 provide a one minute guarantee of irrigant availability at the selected flow rate. The clinician may then be aware of an imminent loss of irrigant and so may plan accordingly.

Each of the irrigant supply systems 1252a, 1252b may include a pump 1280a, 1280b that is fluidly coupled to the corresponding reservoir 1260a, 1260b and by which an irrigant may be pumped through a corresponding tube 1106 to the endodontic device 1102. By way of example, the pumps 1280a, 1280b may each be a peristaltic pump or another pump type described herein capable of pumping at least about 8 mL per minute according to a first flow rate. Embodiments of the invention are not limited to a pump having any particular flow rate as different capacity pumps may be utilized in accordance with embodiments of the present invention.

Referring to FIG. 33, the fluid delivery system 1104 may include controls, such as an on/off button mechanism 1310 that is accessible through the housing 1250. The button mechanism 1310 may be operatively coupled to the printed circuit board 1270 for controlling the electrical power to each of the pumps 1280a, 1280b. The clinician may simply press the on/off button 1310 to turn the power to the fluid delivery system 1104 on.

In one embodiment, the fluid delivery system 1104 includes another button mechanism that may form one component of the irrigant control system 1210. For example, in the exemplary embodiment, a system prime button mechanism 1312 is accessible through the housing 1250 and may be operatively coupled to the printed circuit board 1270. Depression of the system prime button mechanism 1312 may cause the fluid delivery system 1104, particularly the irrigant supply systems 1252a, 1252b to automatically flow a predetermined amount of irrigant through the tubes 1106 and into the endodontic device 1102.

In particular, activation of the system prime button mechanism 1312 may cause each of the pumps 1280a, 1280b to pump irrigant from their respective reservoirs 1260a, 1260b through the tube 1106 and into or through the endodontic device 1102. By way of example only, each of the pumps 1280a, 1280b may pump at a rate of about 25 mL per minute through the endodontic treatment system 1100 to prime all the tubing that exists between the pump 1280a, 1280b and the end 914 of the fluid delivery tube 912. It is estimated that this may take less than one minute to complete. In this way, the clinician may conveniently prepare the treatment system 1100 for use by filling at least two of the tubes 1106 with fluid so that the fluid is immediately accessible for dispensing from the handpiece 1110.

During an endodontic procedure, the irrigant 1262 may be depleted. Referring to FIGS. 34 and 40, the irrigant in the reservoirs 1260a, 1260b, such as the irrigant 1262 in the reservoir 1260a, may be replenished by injecting the irrigant through a fitting 1282a, 1282b mounted in an opening in the reservoir 1260a, 1260b. By way of example only, the fitting 1282a, 1282b may be a Luer lock type fitting capable of receiving a Luer lock syringe. Each of the fittings 1282a, 1282b is covered by a movable door 1290a, 1290b by which the clinician may gain access to the fitting 1282a, 1282b through the housing 1250b. In the exemplary embodiment shown, each irrigant supply system 1252a, 1252b further includes a vent 1288a, 1288b on each reservoir 1260a, 1260b. As irrigant is drawn from the reservoir 1260a, 1260b, the vent 1288a, 1288b allows a back flow of air into the reservoir 1260a, 1260b and consequently prevents vacuum build up in the headspace above the irrigant in the reservoir 1260a, 1260b.

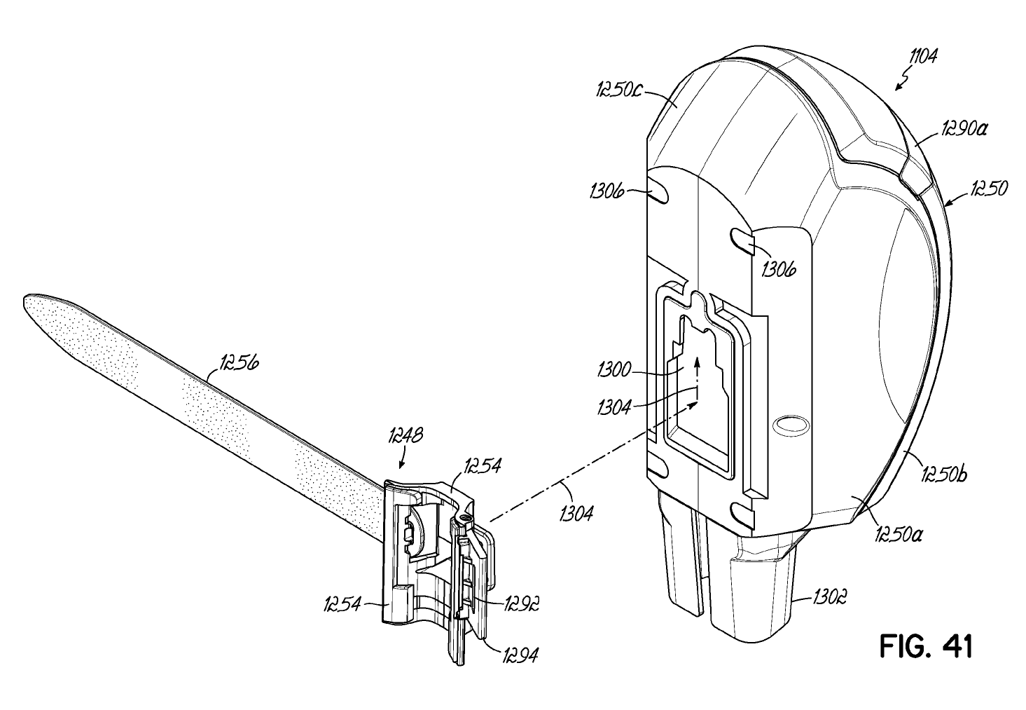

With reference to FIGS. 39 and 41, the mounting system 1248 includes a generally U-shaped frame 1254 that cooperates with a structural component in the clinician's office, such as a support on a tool station, a leg of a cart, or an arm or leg of a chair, among other furniture. By way of example only, the structural component may be a tubular bar that is vertically or horizontally oriented. A strap 1256 may then be wrapped around the structural component and pass through an opening 1292 in a buckle 1294. The buckle 1294 may then be used to tension or stretch (i.e., the strap 1256 may be elastic material) the strap 1256 around the structural component to securely fasten the mounting system 1248 to the structural component. Once the mounting system 1248 is secured onto a chair or other structure, the housing 1250 may be slidably secured within a recess 1300 on the backside of the housing 1250 as is indicated by the arrows 1304 in FIG. 41. With reference to FIGS. 33 and 39, the housing 1250 may include a receptacle 1308 in which the endodontic device 1102 may be stored between endodontic procedures.

As an alternative to the mounting system 1248, the housing 1250 may include a plurality of feet 1306, shown in FIG. 41, so that the fluid delivery system 1104 may be placed on a table or similar horizontal surface. The feet 1306 may be of an antiskid material so that the fluid delivery system 1104 may resist inadvertent sliding movement on the table.

With reference to FIGS. 33 and 40, in one embodiment, a shroud 1302 may surround various ports for coupling each of the tubes 1106 and electrical cable 1108 to a respective one of the pumps 1280a, 1280b and the printed circuit board 1270. The tubes 1106 and the electrical cable 1108 may be secured within the shroud 1302.

In one embodiment, a clinician may operate the treatment system 1100 during an endodontic procedure, such as during a root canal described above. With reference to FIGS. 33 and 39, prior to operating the treatment system 1100, the clinician may energize the fluid delivery system 1104 by pressing button 1310. The clinician may fill the reservoirs 1260a, 1260b with different irrigants, such as NaOCl and EDTA, through the fittings 1282a, 1282b. As the clinician fills the reservoirs 1260a, 1260b, the float 1272 in each of the reservoirs 1260a, 1260b floats toward the top of the reservoir 1260a, 1260b and the indicator lights 1276 may then visually indicate the level of irrigant in the reservoirs 1260a, 1260b.

To fill the tubes 1106 with irrigant, the clinician may then press the button 1312. Each of the irrigant supply systems 1252a, 1252b may alternatively or simultaneously activate. In either case, the corresponding pump 1280a, 1280b may pump irrigant from the reservoir 1260a, 1260b through the attached tube 1106 to the corresponding valve 1222. In this way, the fluid delivery system 1104 primes the tube 1106 and the handpiece 1110 with irrigant. Irrigant may therefore fill the tube 1106 up to the valve 1222.

Prior to dispensing irrigant from the fluid delivery tube 912, and with reference to FIGS. 33, 34, and 37A, the clinician may press one more of the button mechanisms 1230, 1232, 1234, 1236. By way of example, the clinician may press the button mechanism 1234 to select NaOCl in which case the indicator light 1246 may turn blue, the color blue being associated with NaOCl. Then, the clinician may press the button 1232 to select a high flow rate in which case the printed circuit board 1240 energizes the light 1242. Accordingly, the handpiece 1110 may visually confirm the clinician's selections of NaOCl at a high flow rate for dispensing from the fluid delivery tube 912. The clinician may then easily identify an improper selection and make the necessary changes to the selected irrigant and/or flow rate prior to dispensing irrigant from the fluid delivery tube 912.

During an endodontic procedure, with a high flow rate of NaOCl selected, the clinician may dispense NaOCl from the fluid delivery tube 912 into the patient's root canal. The clinician may dispense irrigant in a similar manner as with other endodontic devices described herein. In the exemplary embodiment, and with reference to FIGS. 37A and 37B, once the end effector 1112 is assembled with the handpiece 1110 in accordance with the arrow 1124 in FIG. 35A, the cannula 1120 may be inserted into an opening of a tooth.

If necessary, and with the cannula 1122 in the retracted position shown in FIGS. 37A and 37B, the clinician may trim the tubular member 1136 with a knife or a pair scissors to a desired length in order to fit the tubular member 1136 into the upper two thirds of the patient's root canal. That is, the clinician may custom fit the cannula 1120 to a particular patient's tooth.

Once any trimming is complete, the clinician may insert the cannula 1120 into the patient's root canal. The clinician may insert the macrocannula 1120 into the patient's tooth to a depth sufficient to place the hood portion 1138, particularly the umbrella-like rim 1142, into contact with the crown of the tooth, as is generally shown in FIG. 37B. The rim 1142 may seal the opening 22 in the tooth and may also provide a fixed reference point from which the depth of the root canal 28 may be measured, as is described below.

With the microcannula 1122 in the retracted position, the clinician may operate the irrigant control system 1210 to dispense the selected irrigant (e.g., NaOCl) into the canal via the delivery fluid to 912. In particular, the clinician may start the flow of NaOCl into the root canal 28 by pressing one of the buttons 1230 and 1236 that causes the corresponding pump 1280a or 1280b to force fluid through the corresponding valve 1222, through the fluid delivery tube 912 according to arrows 1196 in FIG. 37A, and from the end 914 according to arrow 1196. Advantageously, the location of buttons 1230 and 1236 allow the clinician to use one or more of a finger or a thumb to control the flow of NaOCl (i.e., irrigant 136 in FIG. 37B) from the fluid delivery tube 912. For procedures on the maxillary jaw, the clinician may opt for pressing button 1236 to dispense irrigant, and for procedures on the mandibular jaw, the clinician may opt for using button 1230 to dispense irrigant. Thus, the handpiece 1110 accounts for an ergonomically proper grip for ease of access to the buttons 1230 or 1236 and so addresses the needs of the clinician to efficiently complete procedures on either jaw.

As is best shown in FIGS. 37C and 37D, the fluid delivery tube 912 may be pointed toward the macrocannula 1120 so that discharge of the irrigant from the end 914 according to arrow 1196 causes irrigant to impinge upon the macrocannula 1120. In other words, discharge of the irrigant from the end 914 may not be parallel to the axis of the macrocannula 1120. By way of example only, and not limitation, an angle ϕ (labeled in FIG. 37D) between an axis perpendicular to the axis of the macrocannula 1120 and the axis of the fluid delivery tube 912 proximate the end 914 may be greater than about 45° but less than about 90°. In the exemplary embodiment shown in FIG. 37A, the angle ϕ is about 81°. Advantageously, the angled relationship between the stream of irrigant from the fluid delivery tube 912 and the macrocannula 1120 reduces splash of the irrigant by taking advantage of the surface tension between the irrigant and the macrocannula 1120. The surface tension acts to draw the irrigant toward the macrocannula 1120 and help retain the irrigant on the macrocannula 1120. Overall, this configuration reduces splashing as the irrigant enters the pulp chamber 26 and root canal 28.

As the clinician dispenses NaOCl from the fluid delivery tube 912, the canal evacuation system 1118 withdraws used NaOCl along with debris and other fluids from the tooth. In particular, and with reference to FIG. 37B, vacuum is pulled through the macrocannula 1120, as is indicated by the arrow 1198, proximate its rim 82. The irrigant system 1116 also provides vacuum at the hood portion 1138 particularly proximate the openings 1156 in a region under the umbrella-like rim 1142. In this configuration, two sources of vacuum are therefore provided at the tooth, that is, one source in the root canal and one at or near the opening sufficient to prevent inadvertent splashing and overflow of the irrigant from the tooth 20. Furthermore, when the endodontic device 1102 is utilized in an inverted orientation, such as during an endodontic procedure on the maxillary jaw, the umbrella-like rim 1142 captures irrigant that is not drawn into the root canal 28.

With reference to FIGS. 37A and 37B, debris and fluid evacuated from the tooth may be evacuated from either location (i.e., at rim 82 or proximate hood portion 1138) and pass through the bore 1144 of the end effector 1112 according to arrows 1198, through the manifold 1180 and out of the handpiece 1110 via the tube 1106. As is described above, in one embodiment, the evacuated debris and fluid may be analyzed in situ via the Root Canal Debridement Effectiveness Device and Method described in U.S. Patent Application No. 62/341,822 and incorporated by reference herein in its entirety. In accordance with the endodontic devices described herein, it is possible to provide a continuous stream of irrigant 136 (e.g., NaOCl) from the fluid delivery tube 912 into the pulp chamber 26 without concern that the irrigant overflows the opening 22. Advantageously, a continuous stream of irrigant 136 provides a more thorough cleaning and disinfecting of the tooth 20.

At the same time or subsequent to filling the pulp chamber with irrigant, the clinician may clean the upper two thirds of the root canal 28 with the macrocannula 1120. Similar to the other devices described herein, although not shown, the clinician may cycle the endodontic device 1102 in an occlusal-gingival direction (as is generally indicated by arrow 140) to pull the macrocannula 1120 in and out of the root canal 28. The NaOCl 136 and debris residing in the upper portion of the root canal 28 may be evacuated through the macrocannula 1120. This cyclic motion, when combined with evacuation, may remove NaOCl 136 in the root canal 28 and may also remove a substantial portion of any debris in the root canal 28. In this manner, a region of negative pressure proximate the rim 82 is produced in the upper portion of the root canal 28 that may draw NaOCl 136 from the pulp chamber 26 into the root canal 28. If the cannula 1120 becomes clogged, according to one embodiment of the invention, the clinician may cut off an end portion of the cannula 1120 to remove the clog and restore evacuation at the newly established rim. The apical third of the root canal 28, however, may still require cleaning and disinfecting.

In that regard, with reference now to FIGS. 33, 34, 37C and 37D, in one embodiment, once the upper portion of the root canal 28 is sufficiently cleaned of debris and used irrigant, the clinician may extend the microcannula 1122 to clean the remaining apical third of the root canal 28. Prior to or at about the same time, the clinician may also select a reduced flow rate of irrigant from the fluid delivery system 1104 by pressing the button 1232. The handpiece 1110 may confirm the clinician's selection of the lower flow rate by energizing the light 1244 while extinguishing the light 1242. A signal may be sent from the handpiece 1110 to the fluid delivery system 1104 by which the corresponding pump 1280a, 1280b pumps NaOCl at a lower rate through the end effector 1112 from the end 914 and into the pulp chamber 26.

As described above, the clinician may operate the extension control system 1150 by pushing the slider 1152 toward the cap portion 1128 of the end effector 1112. Further in this regard, in one embodiment, the clinician may extend the microcannula 1122 from within the macrocannula 1120 until it reaches the apical foramen 34. The clinician may feel resistance to further extension when the end 84 reaches that location. In this way, the clinician may take a meaningful measurement of the depth of the root canal 28 in relation to the hood portion 1138, particularly relative to the umbrella-like rim 1142 if it is seated against the crown 24 of the tooth 20. The clinician may then retract the slider 1152 to withdraw the microcannula 1122 to a predetermined location in the root canal 28 relative to the apical foramen 34. This may ensure that the end 84 is a known distance from the apical foramen 34. By way of example, the clinician may then retract the slider 1152 by about 1 mm or approximately the distance from one tick mark 1168 to an adjacent tick mark 1168. This may position the end 84 at about 1 mm from the apical foramen 34. Moving the slider 1152 may also engage the locking system 1162 (shown in FIG. 34) at the desired extension of the microcannula 1122.

Once locked, the locking system 1162 may resist inadvertent movement of the microcannula 1122 during irrigation. For example, the microcannula 1122 may not be inadvertently pushed back or pushed further away from the apical foramen 34 during irrigation or during insertion of the microcannula 1122 if the microcannula 1122 is bumped against another object. Only by intentionally engaging the tabs 1174 may the locking system 1162 be released so that the slider 1152 and cannula 1122 may be moved.

As shown in FIG. 37D, moving the slider 1152 moves the mid-exit holes 952 into communication with the bore 1140 of the hood portion 1138. As shown the bore 1140 fluidly communicates with the bore 1144, and the microcannula 1122. In view of the seal 1130, vacuum is routed from the bore 1144, through the mid-exit holes 952, and through the microcannula 1122 to the openings 114 at end 84. Debris and used irrigant therefore flows in the opposite direction according to arrows 1198 through the end effector 1112. Advantageously, there is no need to remove a large cannula and insert a smaller cannula during the endodontic procedure as both are immediately available in the end effector 1112.

As is shown in FIG. 37D, the microcannula 1122 may be extended to the apex 32 and into contact with the apical foramen 34. The cannula 1122 may flex to follow the canal 28 (as is shown in phantom line in FIG. 37D). Although not shown, the clinician may force the end 84 through the apical foramen 34 with little or no consequence in a manner similar to that described above with regard to FIG. 6C. Because a vacuum is present at the openings 114, if the end 84 penetrates the apical foramen 34, it is unlikely that any irrigant 136 will escape into the surrounding tissue. Furthermore, the clinician may note the loss of fluid being vacuumed from the root canal 28 and so may understand that the cannula 1122 is proximate the apical foramen 34 within the root canal 28. In one embodiment, the end 84 may seal the apical foramen 34 and prevent irrigant from passing through the apical foramen 34 during irrigant flow and during evacuation through the microcannula 1122.

Once the clinician is satisfied with the position of the cannula 1122, evacuation of the apical third of the root canal 28 proceeds. Similar to evacuation with the cannula 1120, the endodontic device 1102 may produce two sources of vacuum simultaneously in or near the tooth. One source of vacuum is at the crown of the tooth (i.e., at 1156) with the umbrella-like rim 1142 enhancing evacuation by limiting air ingress into the pulp chamber 26. The other source of vacuum is in the root canal 28 (i.e., at the openings 114). Because the cannula 1122 provides apical negative pressure, irrigant 136 travels from the pulp chamber 26 toward the apex 32 and so cleans and disinfects the apical third of the root canal 28. Irrigant flow, as indicated by arrows 142, is toward the openings 114 and then into the cannula 1122.

Once irrigation with NaOCl is complete, the clinician may switch to EDTA. To do so and with reference to FIG. 34, the clinician may first release button mechanism 1230 or 1236 or otherwise turn off the flow of NaOCl from the end effector 1112. In one embodiment, when irrigant flow from the fluid delivery system 1104 is stopped either by releasing button mechanism 1230 1236 or by pressing the button mechanism 1230 or 1236 again (i.e., when the fluid delivery system 1104 is on and therefore actively pumping irrigant), the corresponding pump 1280a, 1280b may automatically reverse flow of irrigant to withdraw any residual irrigant from the end effector 1112. This may be achieved, for example, by reversing the pumping direction of the corresponding pump 1280a, 1280b by 180° to drawback irrigant from between the joint 1114 and the end 914 of the fluid delivery tube 912. Withdrawing residual irrigant from the end effector 1112, for example, to at least the corresponding valve 1222 in the manifold 1180, may prevent irrigant from dripping from the end effector 1112 when it cannot be captured by the canal evacuation system 1118. Furthermore, when the end effector 1112 is removed from the handpiece 1110, such as when a new end effector 1112 is to be assembled with the handpiece 1110, withdrawal of irrigant into the handpiece 1110 may prevent residual irrigant from escaping the handpiece 1110 or from the used end effector 1112. Advantageously, this may improve the safety and cleanliness of the endodontic device 1102. It will be appreciated that a reverse pumping feature may be applicable to any of the endodontic devices described herein.

Once NaOCl flow is stopped and any residual NaOCl is withdrawn from the end effector 1112 according to embodiments of the invention described above, the clinician may then select EDTA by simply pressing the button 1234. Pressing button 1234 may send one or more signals from the handpiece 1110 to the fluid delivery system 1104 (FIGS. 33 and 39) shutting down the corresponding pump 1280a, 1280b (if not already idled) for the reservoir 1260a, 1260b containing NaOCl and activating the corresponding pump 1280a, 1280b for the reservoir 1260a, 1260b containing EDTA.

When EDTA is selected via the button 1234, the light 1246 may change colors from, for example, blue to purple, providing a visual confirmation of the clinician's selection of irrigant. According to the button mechanism 1234 available on handpiece 1110, there is no need to swap syringes containing different irrigants with the microcannula. Furthermore, there's no need to remove the microcannula from the patient's mouth to change irrigants. Thus, the clinician may save substantial amounts of time during the endodontic procedure. As described above, other irrigants may include enzymes, such as, pepsin and serine protease. These irrigants may be utilized in a similar manner as the EDTA and NaOCl. In one embodiment, irrigants (particularly NaOCl) may be heated to increase the temperature by up to about 40° F. The endodontic device 1102 like the other endodontic devices described herein may be capable of sonic or ultrasonic vibration of the irrigant to improve perturbation within the root canal. Further, a combination of irrigants and mechanical debridement and heating may thus produce a chemical-mechanical endodontic process. Once irrigation with the EDTA is complete, the clinician may shut off EDTA flow which may produce a reversal of the corresponding pump 1280a, 1280b described above and so may prevent inadvertent dripping of EDTA.

As with the other endodontic devices described herein, the endodontic device 1102 may provide quantitative information about clogging of the opening 114. If the clinician notices a drop in cleaning efficiency of the cannula 1122, the clinician may retract the cannula 1122 by selectively moving the slider 1152. As is described above, any debris adhered to the openings 114 may be wiped off the exterior surface of the cannula 1122 by virtue of the close fit between the outside surface of the cannula 1122 and the inside surface of the cannula 1120. By this movement, the clinician may restore the evacuation efficiency of the cannula 1122. The clinician may then extend the cannula 1122 to the same position as before retraction as is provided by the locking system 1162. In this manner, the entire length of the root canal, including the apical third, is treated with negative apical pressure.

Often the clinician will repeat the above procedure of cleaning with NaOCl and then EDTA. Iteration of irrigants may be determined by the cleanliness of the root canal and may be repeated until the root canal reaches a threshold of cleanliness as determined by the clinician. This may be easily achieved in accordance with the endodontic treatment system 1100. The clinician may alternate between the two fluids by pressing the button 1234 to select one of multiple irrigants for use. The handpiece 1110 then communicates that information via the electrical cable 1108 to the fluid delivery system 1104 which then activates the appropriate pump 1280a, 1280b for pumping the irrigant to the tooth. In all cases, the canal evacuation system 1118 captures used irrigant and debris from the root canal.

Once the pulp chamber 26 and root canals 28 are sufficiently clean, the clinician may dry the root canals 28 and the pulp chamber 26 with the cannula 1122 in preparation for filling and sealing the tooth 20. In that regard, air may be blown through the microcannula 1122 and/or macrocannula 1120. Alternatively, the microcannula 1122 may be used to evacuate residual moisture while air is blown through the opening 22 of the tooth (see, for example, FIG. 5A). Evacuation through the microcannula simultaneously with blowing air through the opening 22 may circulate air in the apical third of the root canal 28 to more rapidly and thoroughly dry the root canal 28. The moisture within the root canal may be monitored via a capacitance or microwave sensor or similar device to provide real-time feedback on the moisture level within the root canal. In one embodiment, a moisture absorbent material, for example, a synthetic cotton fiber, may be added to the microcannula 1122 to absorb any moisture that evades evacuation or evaporation.

Once the root canals 28 are clean and sufficiently dry, the clinician may dispense an obturation material into the prepared canals. Any of the orthodontic devices described herein may be used to fill the root canal 28 with the obturation material. For example and with regard to the endodontic device 1102, the obturation material may be injected directly into the root canal 28 through the macrocannula 1120. The microcannula 1122 may be extended to near the apical foramen 34. Operation of the canal evacuation system 1118 through the microcannula 1122 may draw the obturation material to or near the apical foramen 34. This may be achieved without injecting the obturation material through the apical foramen 34. The clinician may then be assured that the material fills the apical third of the root canal 28. In one embodiment, the macrocannula 1120 and/or the microcannula 1122 is left in the root canal 28 once filling is complete.

In one embodiment and with reference to FIGS. 35A and 36, once the endodontic procedure is complete, the clinician may remove the used end effector 1112 in the direction of the arrow 1124. The end effector 1112 separates from the handpiece 1110 at the joint 1114. When the end effector 1112 is removed any fluid in the joint 1114 may not leak from the manifold 1180 in view of the reverse pumping operation performed by the pumps 1280a, 1280b. Furthermore, in view of the small volume of liquid that may be in the coupling portion 1206, there will be very little irrigant available to leak when the clinician exchanges one end effector 1112 for another end effector 1112. During assembly of a new end effector 1112 onto the handpiece 1110, the one-way configuration of the joint 1114 may prevent improper assembly of a new end effector 1112 onto the handpiece 1110. Once a new end effector 1112 is assembled with the handpiece 1110, the clinician may then proceed to the next endodontic procedure. The clinician may the dispose of the used end effector 1112.

While the present invention has been illustrated by a description of various preferred embodiments and while these embodiments have been described in some detail, it is not the intention of the inventors to restrict or in any way limit the scope of the appended claims to such detail. Additional advantages and modifications will readily appear to those skilled in the art. The various features of the invention may be used alone or in any combination depending on the needs and preferences of the user.

What is claimed is:

1.-169. Canceled

170. An endodontic device comprising:
a canal evacuation system for evacuating a root canal of a tooth that includes:
a first cannula, and
a second cannula,
wherein the first cannula and the second cannula are movable relative to one another from a retracted position to an extended position in which the second cannula extends from the first cannula,
wherein when in the retracted position, at least the first cannula evacuates the root canal,
wherein when in the extended position, at least the second cannula evacuates the root canal.

171. The endodontic device of claim 170,
wherein when in the retracted position, an end of the first cannula is insertable into the root canal,
wherein when in the extended position, an end of the second cannula is insertable into the root canal.

172. The endodontic device of claim 170,
wherein when in the retracted position, an end of the first cannula extends beyond an end of the second cannula,
wherein when in the extended position, an end of the second cannula extends beyond the end of the first cannula.

173. The endodontic device of claim 170, wherein when in the extended position, the second cannula extends to a location at or near an apex of the tooth.

174. The endodontic device of claim 170, wherein when in the retracted position, an end of the second cannula is positioned inside the first cannula.

175. The endodontic device of claim 170, wherein the second cannula is concentric with the first cannula.

176. The endodontic device of claim 170, wherein the first cannula has an opening at one end and the second cannula extends through the opening when in the extended position.

177. The endodontic device of claim 170, wherein the first cannula has a portion having an inside diameter and the second cannula has a portion having an outside diameter that is equal to or less than the inside diameter.

178. The endodontic device of claim 177, wherein when in the extended position, the portion of the first cannula and the portion of the second cannula form a vacuum seal during evacuation of the root canal.

179. The endodontic device of claim 170, further including a hood portion through which the first cannula and the second cannula extend, and that terminates in a rim configured to cover at least a portion of a crown of a tooth.

180. The endodontic device of claim 179, wherein the hood portion has a conical configuration.

181. The endodontic device of claim 179, wherein the hood portion has a uniform tubular configuration.

182. The endodontic device of claim 179, wherein an end of the second cannula is in the hood portion when the second cannula is in the retracted position.

183. The endodontic device of claim 170, further comprising an irrigant system including a fluid delivery tube configured to dispense fluid into the tooth.

184. The endodontic device of claim 183, wherein the irrigant system includes a vacuum port.

185. The endodontic device of claim 184, wherein the vacuum port is within one of a vacuum hood, vacuum tube, or vacuum ring.

186. The endodontic device of claim 170, wherein the canal evacuation system includes an extension control system that is operatively coupled to at least one of the first cannula and the second cannula and by which at least one of the first cannula and the second cannula can be moved between the retracted position and the extended position.

187. The endodontic device of claim 186, wherein the extension control system is operatively coupled to the second cannula whereby operation of the extension control system moves the second cannula to the extended position.

188. The endodontic device of claim 186, wherein the extension control system includes a seal such that when the second cannula is in the extended position, the seal is configured to produce evacuation through the second cannula.

189. The endodontic device of claim 186, wherein the extension control system includes a slider that is operatively secured to one of the first cannula and the second cannula whereby movement of the slider moves one of the first cannula and the second cannula relative to the other.

190. The endodontic device of claim 186, wherein the extension control system further includes a plurality of tick marks that correlate a length of the second cannula that is extended into the tooth.

191. The endodontic device of claim 186, further including a locking system that is operatively coupled to the extension control system and that secures the extension control system at one of a plurality of user selectable or predetermined locations.

192. The endodontic device of claim 191, wherein the locking system includes a projection that engages at least one tick mark that correlates a length of the second cannula that is extended into the tooth.

193. The endodontic device of claim 170, wherein the canal evacuation system is incorporated into a tip and the endodontic device further comprises a handpiece to which the tip is releasably coupled at a joint.

194. The endodontic device of claim 193, wherein the handpiece includes a manifold having at least one valve in a flow of fluid that is dispensed from the tip, the valve substantially preventing backflow of fluid through the handpiece.

195. An endodontic treatment system comprising:
the endodontic device of claim 194 wherein the handpiece houses a plurality of tubes for fluidly coupling the tip to a fluid delivery system and a source of vacuum, and
a fluid delivery system fluidly coupled to the endodontic device by the plurality of tubes.

196. The endodontic treatment system of claim 195, wherein the fluid delivery system includes at least two irrigant supply systems and each irrigant supply system includes a fluid level sensing mechanism operatively coupled to indicator lights, the fluid level sensing mechanism being capable of sensing a level of fluid in the corresponding reservoir and the indicator lights being operative to visually indicate the level of fluid in the corresponding reservoir as determined by the fluid level sensing mechanism.

197. The endodontic device of claim 170, further including a sonic or ultrasonic transducer operatively coupled to at least one of the first cannula and the second cannula.

198. A tip for use with a handpiece through which fluid and vacuum are supplied during endodontic therapy, the tip comprising:
at least one body through which vacuum is supplied;
a cannula that extends from the body proximate at one end and is capable of evacuating at least a portion of a root canal;
a fluid delivery tube supported by the body for dispensing a fluid into a tooth; and
a vacuum port proximate the fluid delivery tube for evacuating fluid.

199. The tip of claim 198, wherein the cannula is sized to fit into a root canal to a location at or near an apex of the tooth.

200. The tip of claim 198, further including an extension control system that is accessible on the body and operatively coupled to the cannula by which a user can move the cannula.

201. The tip of claim 200, wherein the extension control system includes a slider that is operatively secured to the cannula whereby movement of the slider moves the cannula.

202. The tip of claim 200, wherein the extension control system further includes tick marks that correlate a length of the cannula that is extended from the tip.

203. The tip of claim 200, further including a locking system that is operatively coupled to the extension control system and that secures the extension control system at one of a plurality of user selectable or predetermined locations.

204. The tip of claim 203, wherein the locking system includes a projection that engages at least one tick mark that secures the cannula in the user selectable or predetermined location.

205. The tip of claim 200, wherein the extension control system includes a slider that is operatively secured to the cannula, the tick marks are located on the body, and a projection is located on the slider so that as the slider is moved relative to the body, the projection engages one of the tick marks.

206. The tip of claim 198, further comprising a hood portion that terminates in a rim and is configured to cover at least a portion of a crown of a tooth.

207. The tip of claim 206, wherein the hood has a conical configuration.

208. The tip of claim 206, wherein the hood has a uniform tubular configuration.

209. The tip of claim 198, wherein the tip is releasably coupled to the handpiece at a joint.

210. The tip of claim 198 further including a sonic transducer or an ultrasonic transducer operatively coupled to the cannula.

211. A cannula for use during endodontic therapy comprising:
a sidewall that defines a bore and is closed at one end, the sidewall is sized to fit within a root canal and includes at least one opening proximate the closed end and a mid-exit hole remote from the closed end.

212. The cannula of claim 211, further including a plurality of openings proximate the closed end.

213. The cannula of claim 211, further including a seal at an end opposite the closed end.

214. The cannula of claim 211, wherein the mid-exit hole has a greater open area than the at least one opening.
